(19) United States
(12) Patent Application Publication
(10) Pub. No.: US 2021/0354140 A1
(43) Pub. Date: Nov. 18, 2021

(54) MICROFLUIDIC DEVICE AND USES THEREOF

(71) Applicant: Bar Ilan University, Ramat Gan (IL)

(72) Inventor: Doron GERBER, Hod Hasharon (IL)

(21) Appl. No.: 17/321,142

(22) Filed: May 14, 2021

Related U.S. Application Data
(60) Provisional application No. 63/026,436, filed on May 18, 2020.

(51) Int. Cl. B01L 3/00; G02B 21/26; G02B 21/00

(52) U.S. Cl. CPC B01L 3/502738; B01L 3/502715; G02B 21/26; G02B 21/0076; B01L 2400/06; B01L 2300/18; B01L 2300/0627; B01L 2300/0819; B01L 2300/10; B01L 2300/14; B01L 2300/047

(57) ABSTRACT

The present disclosure provides microfluidic test platforms, systems, and methods for manufacturing the disclosed test platforms. The present disclosure further provides uses of the disclosed microfluidic test platforms in personalized medicine. Specifically, in providing prognostic and therapeutic methods for determining drug sensitivity and optimizing treatment regimen for subjects suffering from a pathologic disorder, specifically, cancer.

### FIELD OF THE INVENTION

The present disclosure relates to personalized medicine. More specifically, the present disclosure provides microfluidic devices or microfluidic test platforms and systems, and their uses in personalized medicine for treating pathological disorders, e.g., cancer.

### BACKGROUND ART

References considered to be relevant as background to the presently disclosed subject matter are listed below:
[1] Ludwig, J. A. & Weinstein, J. N. Nature Reviews Cancer 5, 845-856 (2005).
[2] Massuti, B., Sanchez, J. M., Hernando-Trancho, F., Karachaliou, N. & Rosell, R. Transl. lung cancer Res. 2, 208-21 (2013).
[3] Morgan, M. M. et al. Pharmacol. Ther. 165, 79-92 (2016).
[4] Hidalgo, M. & Bruckheimer, E. Mol. Cancer Ther. 10, 1311-6 (2011).
[5] Tannock, I. F. & Hickman, J. A. N. Engl. J. Med. 375, 1289-1294 (2016).
[6] Ellsworth, R. E., Blackburn, H. L., Shriver, C. D., Soon-Shiong, P. & Ellsworth, D. L. Semin. Cell Dev. Biol. 64, 65-72 (2017).
[7] Tosoian, J. J. & Antonarakis, S. Transl. Cancer Res. Vol 6, Suppl. 1 Transl. Cancer Res. (2017).
[8] Wong, A. H.-H. et al. Sci. Rep. 7, 9109 (2017).
[9] Sugiura, S., Hattori, K. & Kanamori, T. Anal. Chem. 82, 8278-8282 (2010).
[10] Bartlett, R. et al. Transl. Oncol. 7, 657-664 (2014).
[11] Samson, D. J., Seidenfeld, J., Ziegler, K. & Aronson, N. Journal of Clinical Oncology 22, 3618-3630 (2004).
[12] Lloyd, K. L., Cree, I. A. & Savage, R. S. BMC Cancer 15, 117 (2015).
[13] Burstein, H. J. et al. J. Clin. Oncol. 29, 3328-30 (2011).
[14] Wilmes, A. et al. J. Proteomics 79, 180-194 (2013).
[15] Gerlinger, M. et al. N. Engl. J. Med. 366, 883-92 (2012).
[16] Pak, C. et al. Integr, Biol. (Camb), 7, 643-54 (2015).
[17] Pradhan, S. et al. Sci. Rep. 8, (2018).

Acknowledgement of the above references herein is not to be inferred as meaning that these are in any way relevant to the patentability of the presently disclosed subject matter.

### BACKGROUND OF THE INVENTION

Cancer is the second leading cause of death worldwide. Timely treatment with the proper drug and dose is crucial. However, a given drug affects only a fraction of the patients with the same tumor type. Personalized medicine addresses the problem of partial response by optimizing therapy for each individual patient. The personalized approach to cancer therapy showed a clear advantage versus traditional therapies.

Careful diagnosis is a critical component of a successful personalized cancer therapy. Today diagnosis is done by profiling of tumor's DNA, RNA or proteins, and by integration of tumor cells into chemosensitivity and resistance assays (CSRA). Diagnosis by molecular profiling of DNA, RNA or proteins is used to identify molecular biomarkers that are predictive of patient response to a drug [1,2]. Diagnosis by CSRA is used to determine tumor cells ex vivo response to a drug [3]. Although these diagnoses methods improve clinical outcome, cancer mortality remains high [4]. Importantly, scientific literature shows that gaps in tumor cellular and molecular heterogeneity characterization⁵ is a major limitation of the personalized medicine approach in cancer [6].

The significant genomic evolution that often occurs during cancer progression, creates variability within primary tumors as well as between the primary tumors and metastases. Although new high-resolution sequencing and bioinformatics methods improved the molecular characterization of tumors, these technologies remain limited by tissue sampling and analysis methods. Recent studies show that during analysis stages, a positive result based on, both successful biopsy, and molecular characterization, is a reliable indication of the presence of the high-risk disease, although a negative result does not reliably exclude the presence of high-risk disease⁷. Thus, new approaches for characterization of tumor heterogeneity and heterogeneity impact on drug resistance are needed.

Microfluidic approaches could provide a more detailed picture of heterogeneous cancer cell population response to drugs than traditional culture methods [8-9]. Therefore, such a device could provide a new direction for CSRA models development. The potential of CSRA models has long been recognized by the scientific community. However, classic tools for CSRA models faced multiple challenges that hindered their success. Some examples of current challenges include; poor and unrepeatable in vitro culture conditions [10-12], the limited information provided by traditional in vitro techniques to clinicians [13,14], and tumor heterogeneity [15]. These challenges could potentially explain the observed discordance between in vivo and in vitro therapeutic responses.

Microfluidics is already used in multiple molecular biology techniques, such as polymerase chain reaction, electrophoresis on a chip, DNA niicroarrays, and diagnostic devices that can probe raw and complex samples such as serum, blood, and urine. However, microfluidics is rarely used with patient-derived tissue samples. For example, Pak et al., used a microfluidic platform to study drug resistance of cancer cells in bone marrow extracts, which were isolated from myeloma patients [16]. In addition, Pradhan et al. tried to recapture tumor structure, and tested their response to drugs in vitro using a microfluidic device [17]. Determining the dose-response of cells by live/dead staining, could provide an important tool for CSRA models. Such a tool may be useful for basic biology studies on issues such as cancer heterogeneity in response drugs.

### SUMMARY OF THE INVENTION

According to a first aspect of the presently disclosed subject matter there is provided a microfluidic test platform, comprising a block defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; wherein the reaction units are provided with desired said active agents in situ during manufacture of the microfluidic test platform.

For example, the microfluidic test platform comprises a plurality of microfluidic valves, each microfluidic valve being configured for selectively allowing or preventing flow therethrough under the control of the control system. Additionally or alternatively, for example, the microfluidic test platform includes at least one of the following; wherein at least one said reaction unit comprises a different said active agent as compared with at least one other said reaction unit;
wherein at least one said reaction unit comprises a different composition of said active agent as compared with at least one other said reaction unit;
wherein at least one said reaction unit comprises a different concentration of said active agent as compared with at least one other said reaction unit.

Additionally or alternatively, for example, said active agent is any one of: a candidate active agent; a therapeutic active agent; a labeling active agent; a characterizing active agent.

Additionally or alternatively, for example, said active agent comprises any one of: an inorganic or organic molecule, a small molecule, a nucleic acid-based molecule, an aptamer, a polypeptide, or any combinations thereof.

Additionally or alternatively, for example, said block comprises a block member in overlying fixed relationship with a base member, and wherein said block member comprises an outer-facing first block surface and an outer-facing second block surface, wherein the second block surface is spaced from the first block surface by a block member thickness dimension. For example, said block member comprises a material transparent to electromagnetic radiation at least in the visible spectrum. For example, said material is or comprises polydimethylsiloxane.

Additionally or alternatively, for example, said block member comprises a first block layer in overlying abutting relationship with a second block layer, wherein the second block layer comprises said control system, and said first block layer comprises said first plurality of reaction units, said first network and said second network.

Additionally or alternatively, for example, said plurality of said reaction units are arranged in an array with respect to the block of substrate material.

Additionally or alternatively, for example, said first plurality is an integer greater than 100. Additionally or alternatively, for example, at least prior to use, each said active agent chamber is provided with a quantity of the respective said active agent.

Additionally or alternatively, for example, for each said reaction unit, the respective said active agent is accommodated therein via a printing process.

Additionally or alternatively, for example, said first network is configured for selectively delivering to at least a portion of the reaction units, under the action of the second network, a fluid including at least cell samples. For examples, second network is configured for selectively enabling pockets of said fluids trapped in feeding channel segments of the first network to be urged into the respective reaction units under predefined conditions. For example, the first network comprises a plurality of feeding channels, each feeding channel being in selective fluid communication with a portion of said reaction chambers via respective said microfluidic valves in the form of respective first microfluidic valves, wherein each said feeding channel further comprises a plurality of said microfluidic valves in the form of blocking valves, wherein each pair of adjacent blocking valves is configured for selectively isolating a respective said feeding channel segment therebetween from a remainder of the first network. Alternatively, for example, each said reaction unit comprises a cell chamber configured for accommodating therein a cell sample, and at least one active agent chamber, wherein the respective said active agent of the respective reaction unit is accommodated in the respective said at least one active agent chamber during manufacture of the microfluidic test platform. For example, each said reaction unit comprises:
a first said microfluidic valve configured for providing selective fluid communication between the respective said reaction unit and the first network;
a second said microfluidic valve configured for providing selective fluid communication between the respective said reaction chamber and the respective said active agent chamber.

Additionally or alternatively, for example, each said reaction chamber comprises a plurality of seeding ports configured for providing free fluid communication between the respective reaction chamber and a respective group of feeding channels of the second network, wherein said seeding ports are configured for preventing flow therethrough of cells of a cell sample.

Additionally or alternatively, for example, said control system comprises a plurality of microfluidic control lines, each said microfluidic control line configured for controlling operation of one or more said microfluidic valves associated with the respective said microfluidic control line.

It should be noted that in some embodiments of the disclosed microfluidic test platform, the cells form aggregates and/or clusters in the cell chamber. In yet some further embodiments, cells are clustered prior to exposure to the active agent.

According to a second aspect of the presently disclosed subject matter, there is provided a system, comprising:
a housing configured for accommodating therein a microfluidic test platform as defined herein according to the first aspect of the presently disclosed subject matter;
an imaging system;
an environment control system;
a pressurization system; and
a supply system.

For example, said housing defines an internal microenvironment chamber configured for accommodating the platform therein.

Additionally or alternatively, for example, said imaging system comprises a suitable imaging camera, configured for enabling imaging of individual reaction units of the platform, at least during the active agent exposure operation in operation of the system. For example, the imaging camera comprises a four-channel fluorescence microscope camera.

Additionally or alternatively, for example, said environmental control system comprises a humidity control, a temperature control, and a carbon dioxide control, respectively configured for providing control of humidity, temperature and level of carbon dioxide, in the microenvironment chamber.

Additionally or alternatively, for example, said pressurization system is configured for selectively operating the control system of the platform in operation of the system.

Additionally or alternatively, for example, said supply system comprises a plurality of input lines, each said input line being coupled to the first network of the platform in operation of the system.

Additionally or alternatively, for example, said supply system comprises one or more output lines for channeling waste out of the platform in operation of the system.

Additionally or alternatively, for example, the system further comprises said platform accommodated in said housing.

It should be noted that in some embodiments of the disclosed system, the cells form aggregates and/or clusters in the cell chamber of the microfluidic test platform disclosed herein. In yet some further embodiments, cells are clustered prior to exposure to the active agent.

According to a third aspect of the presently disclosed subject matter there is provided a method for manufacturing a microfluidic test platform, comprising;

(a) providing a block member having a first block face and defining a plurality of reaction units, a first network of feeding channels, a second network of seeding channels, and a control system for enabling control of fluid flows with respect to the first network of feeding channels and with respect to the second network of seeding channels, wherein at least the reaction units are formed as recesses from the first block face;

(b) providing a base member having a first base face configured for being affixed in overlying relationship with respect to the first block face;

(c) depositing a plurality of desired active agents, corresponding to said plurality of reaction units, in at least one of block member or said base member in predefined alignment therewith such as to ensure that in step (d) each said active agent is accommodated in a respective said reaction chamber;

(d) following step (c), affixing said base member with respect to said block member such that first base face is affixed in overlying relationship with respect to the first block face. For example, in step (c), the plurality of desired active agents, are deposited on said base member in said predefined alignment therewith.

Additionally or alternatively, for example, said active agents are printed as respective deposits on said first base face of the base member in the form of an array corresponding to an array of said reaction units in said block member. For example, each said deposit has a respective size and location on the first base face corresponding to a size and relative location of a respective active agent chambers of a respective said reaction unit on the block member.

Additionally or alternatively, for example, step (d) comprises first aligning the base member and the block member with respect to one another, such that each said reaction unit, in particular each active agent chamber thereof, accommodates a respective said active agent, and subsequently affixing the aligned said base member and said block member with respect to one another. For example, the method comprises providing a layer of chemically active moieties to the first base face prior to step (c).

Additionally or alternatively, for example, in step (d) the base member and the block member affixed with respect to one another using a plasma bonding process.

Additionally or alternatively, for example, step (c) includes any one of a suitable piezo printing process and a suitable contact printing process for depositing said active agents.

Additionally or alternatively, for example, in step (c) said active agents are deposited directly to the respective reaction units.

Additionally or alternatively, for example, in step (a) said block member is provided by first providing a first block layer and a second block layer, said first block layer comprising said plurality of reaction units, said first network of feeding channels, and said second network of seeding channels, said second block layer comprising said control system, aligning said first block layer and said second block with respect to one another, and affixing said aligned first block layer and said second block layer with respect to one another.

It should be noted that in some embodiments of the disclosed method, the cells form aggregates and/or clusters in the cell chamber of the microfluidic test platform disclosed herein. In yet some further embodiments, cells are clustered prior to exposure to the active agent.

According to a fourth aspect of the presently disclosed subject matter there is provided a method for operating a microfluidic test platform, comprising:

(A) providing a system as defined herein according to the second aspect of the presently disclosed subject matter;

(B) providing a microfluidic test platform as defined herein according to the first aspect of the presently disclosed subject matter, comprising a desired variety of said active agents in the respective said reaction units thereof;

(C) accommodating the microfluidic test platform in the housing of the system;

(D) operating the system to cause a cell sample to interact with each of said active agents in the respective said reaction units.

It should be noted that in some embodiments of the disclosed method, the cells form aggregates and/or clusters in the cell chamber of the microfluidic test platform disclosed herein. In yet some further embodiments, cells are clustered prior to exposure to the active agent.

According to a fifth aspect of the presently disclosed subject matter there is provided a kit for providing a microfluidic test platform, comprising

(a) a block member having a first block face and defining a plurality of reaction units, a first network of feeding channels, a second network of seeding channels, and a control system for enabling control of fluid flows with respect to the first network of feeding channels and with respect to the second network of seeding channels, wherein at least the reaction units are formed as recesses from the first block face;

(b) a base member having a first base face configured for being affixed in overlying relationship with respect to the first block face;

(c) a plurality of desired active agents, corresponding to said plurality of reaction units, wherein said base member is configured for facilitating deposition of said desired active agents thereon in predefined alignment therewith such as to ensure that each said active agent can be accommodated in a respective the reaction chamber when said base member is affixed with respect to said block member such that first base face is affixed in overlying relationship with respect to the first block face.

For example, said base member comprises a layer of chemically active moieties on the first base face thereof. For example, the chemically active moieties comprises epoxy.

It should be noted that in some embodiments of the disclosed kit, the cells form aggregates and/or clusters in the cell chamber of the microfluidic test platform disclosed herein. In yet some further embodiments, cells are clustered prior to exposure to the active agent.

A further aspect of the present disclosure relates to a screening method for an active agent that affects cell viability and/or at least one cell phenotype, specifically, morphology, activity, invasiveness, expression of various markers, functional response, and post-translational modifications. In some embodiments, the method comprising the following steps. In a first step (a), exposing and contacting cells grown in at least one cell chamber of at least one reaction unit of a microfluidic test platform, to at least one candidate active agent accommodated in at least one respective active-agent chamber of at least one reaction unit of the test platform. The next step (b), involves determining for the exposed cells of (a), cell viability and/or at least one cell phenotype, for at least one time interval. In the next step (c), determining that the candidate is an agent that affects cell viability and/or phenotype if at least one of cell viability and/or at least one cell phenotype is modulated as compared with the cell viability and/or at least one cell phenotype in the absence of said candidate active agent. In some embodiments, the microfluidic test platform used herein comprises a block of substrate material defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; while the reaction units are provided with desired active agents in situ during manufacture of the microfluidic test platform.

A further aspect of the present disclosure provides a prognostic method for predicting/determining and assessing responsiveness of a subject suffering from a pathologic disorder to a treatment regimen comprising at least one therapeutic active agent. In some embodiments, the prognostic method disclosed herein may further optionally provides means for monitoring disease progression. In more specific embodiments, the prognostic methods disclosed herein may comprise the following steps.

In the first step (a), exposing cells of the subject grown in at least one cell chamber of a microfluidic test platform, to the therapeutic active agent accommodated in at least one respective active-agent chamber of the test platform provided by the present disclosure. The next step (b) involves determining for the exposed cells of (a), cell viability and/or at least one cell phenotype, for at least one time interval.

The next step (c), involves classifying the subject as:

The subject may be classified as (i), a responsive subject to the treatment regimen, if at least one of, cell viability and/or at least one cell phenotype is modulated as compared with at least one of the cell viability and/or at least one cell phenotype in the absence of the therapeutic active agent. Alternatively, or additionally, the subject may be classified as (ii), a drug-resistant subject if at least one of, cell viability and/or at least one cell phenotype is not modulated as compared with at least one of the cell viability and/or at least one cell phenotype, in the absence of the active agent. The disclosed method thereby provides predicting, assessing and monitoring responsiveness of a mammalian subject to the treatment regimen. In some embodiments, the microfluidic test platform used in the prognostic methods is as defined by the invention. More specifically, the microfluidic test platform used herein comprises a block of substrate material defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; while the reaction units are provided with desired active agents in situ during manufacture of the microfluidic test platform.

A further aspect of the present disclosure provides a method for determining a personalized treatment regimen for a subject suffering from a pathologic disorder. In some specific embodiments, the method comprising the following steps. First in step (a), exposing cells of the subject grown in at least one cell chamber of at least one reaction unit of a microfluidic test platform, to at least one therapeutic active agent accommodated in at least one respective active-agent chamber of at least one reaction unit of the test platform. The next step (b), involves determining for the exposed cells of (a), cell viability and/or at least one cell phenotype, for at least one time interval. In the next step (c), classifying the subject as: either (i), a responsive subject to the treatment regimen, if at least one of, cell viability and/or at least one cell phenotype is modulated as compared with at least one of the cell viability and/or at least one cell phenotype in the absence of the candidate active agent; or alternatively as (ii), a drug-resistant subject if at least one of, cell viability and/or at least one cell phenotype is not modulated as compared with at least one of the cell viability and/or at least one cell phenotype in the absence of the therapeutic active agent.

The next step that follows classification of the subjects involves administering to a subject classified as a responder, an effective amount of the therapeutic active agent, or any compositions thereof. In some embodiments, the microfluidic test platform used herein, is as defined by the invention and comprises a block of substrate material defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; while the reaction units are provided with desired active agents in situ during manufacture of the microfluidic test platform.

### BRIEF DESCRIPTION OF THE DRAWINGS

The patent or application file contains at least one drawing executed in color. Copies of this patent or patent application publication with color drawings will be provided by the Office upon request and payment of the necessary fee.

In order to better understand the subject matter that is disclosed herein and to exemplify how it may be carried out in practice, embodiments will now be described, by way of non-limiting example only, with reference to the accompanying drawings, in which:

FIG. 1A-1C: CSRA device imaging setup.

FIG. 1A: Schematic presentation of the device and experimental setup. This includes the microfluidic device, the optical setup and the microenvironment chamber. Below images of the device (left), cells cultivated within a representative chamber (×20 magnification) (middle) and the drug chambers with printed drug inside (right).

FIG. 1B: Schematic presentation of the reaction unit. Each reaction units consists of two chambers (C—cell chamber, D—drug chamber) and three types of micromechanical valves; 1—Neck, 2—sandwich and 3—drug valve. Valves configuration within each step of the experiment is different. During cells seeding—the sandwich and neck valves are open, and horizontal flow is activated, allowing cells to enter into the cell chamber. During cells feeding, the neck valve (1) is closed, thus nutrients diffuse via the horizontal filter tubes (F) into the cell chamber (C), The drug valve (3) is closed during these processes. It is opened at the drug exposure phase, allowing the drug to dissolve in the medium. Thus, exposing the cells to the specific printed drug.

FIG. 1C: Cell seeding density. Cells distribution inside the cultivation chamber for a sample of 15×10⁶ cells ml⁻¹. Data presents the number of chambers with the various cells densities normalized to the total number of chambers within the device.

FIG. 2A-2C: Live/dead assay within the microfluidic device.

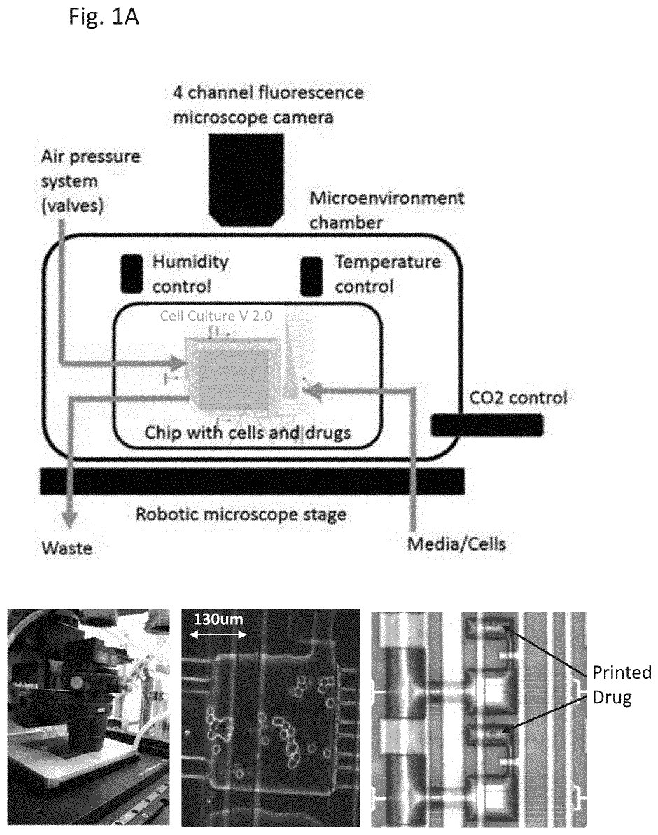

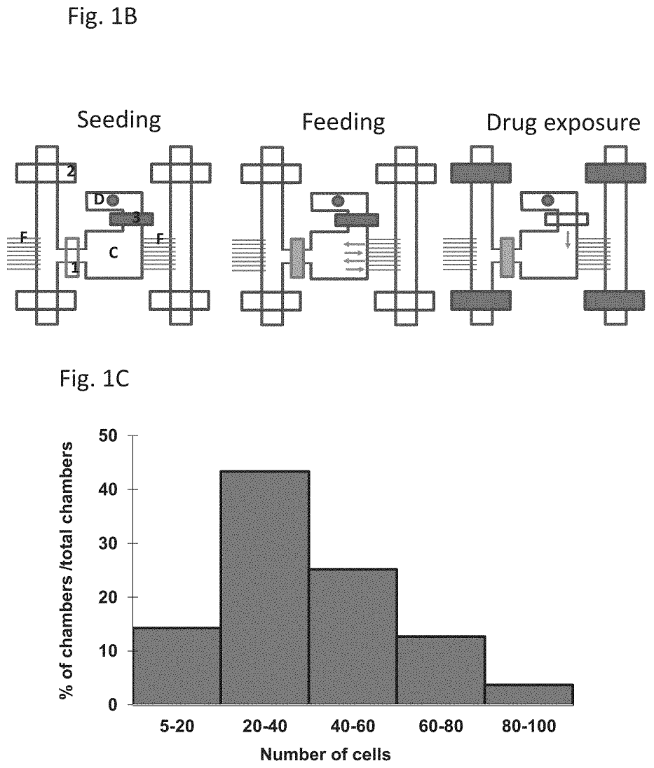

FIG. 1A: Microscope images of a single chamber 24 hours post MCF-7 cells seeding. The blue image (Hoechst 33342 nucleus stain) shows nucleus of all cells, the pink (Propidium Iodide stain) presents only nucleus of dead cells and the green (Calcein) image presents the cytoplasm of living cells. Magnification 40×.

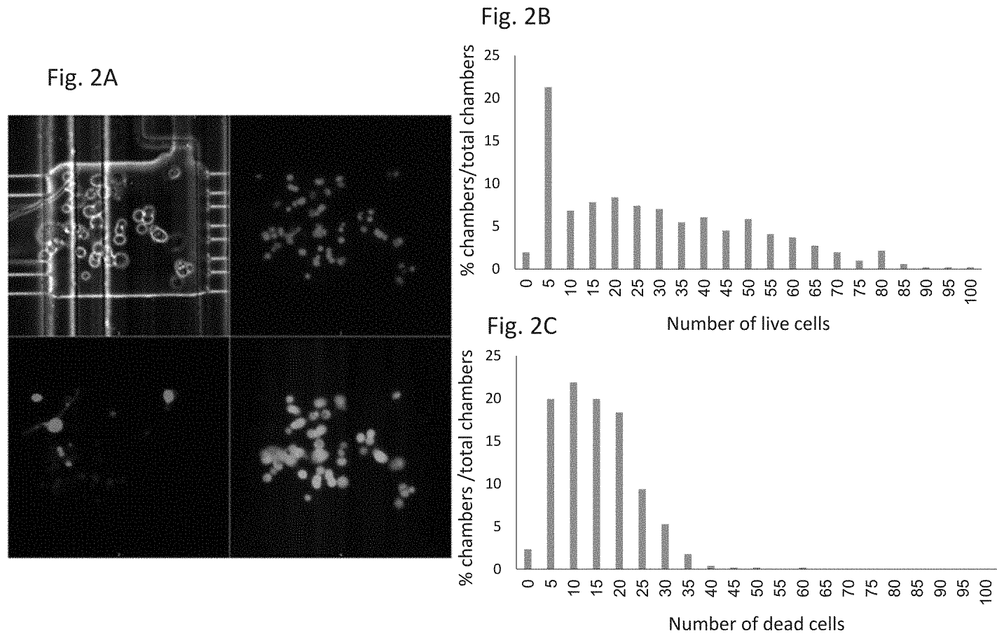

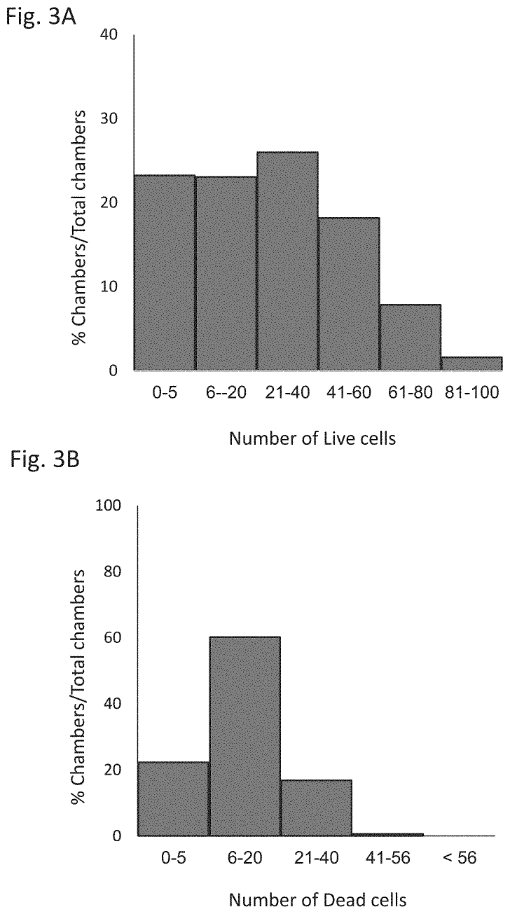

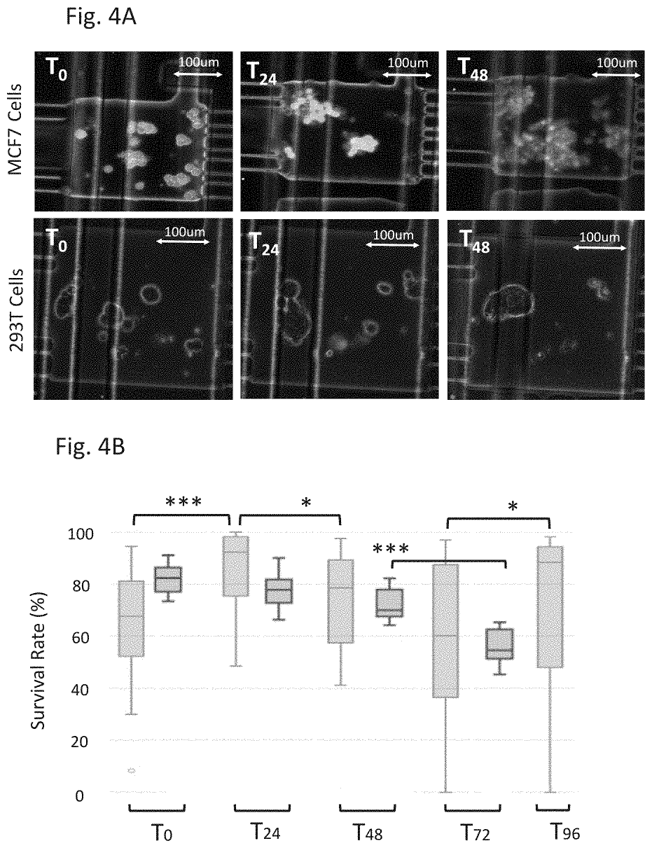

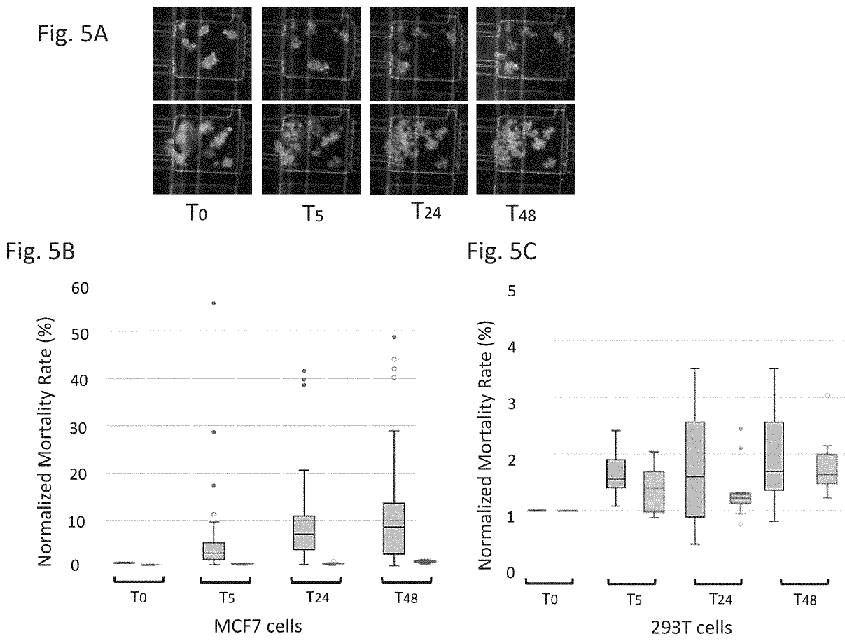

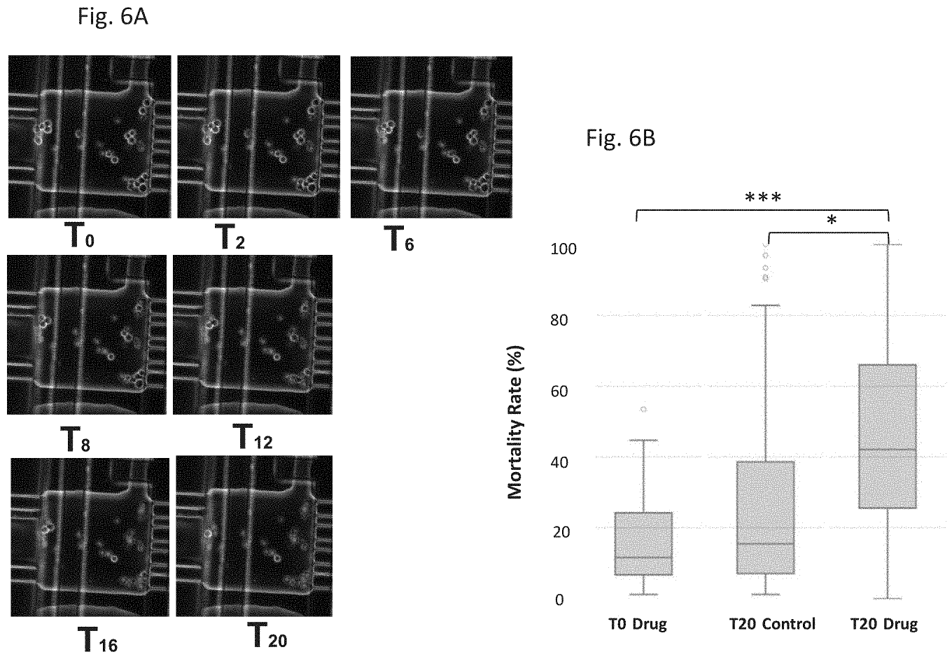

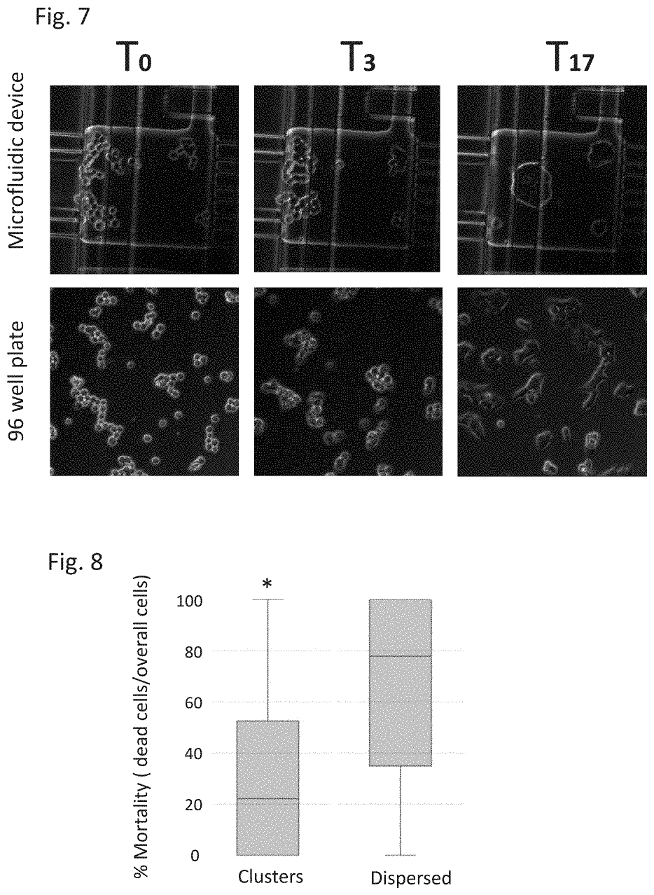

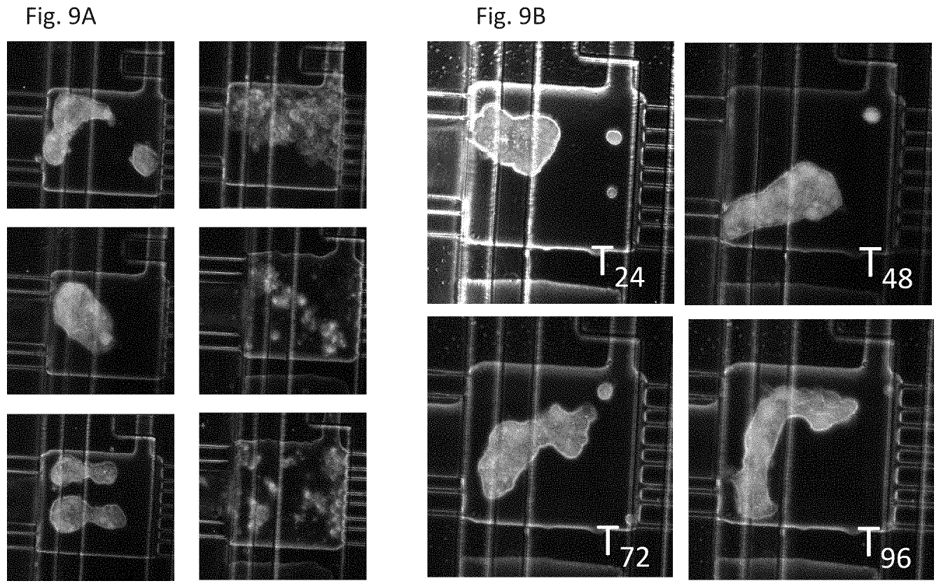

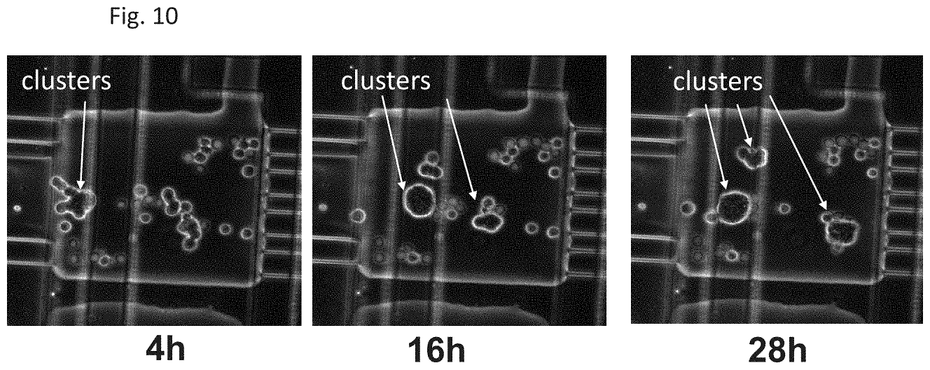

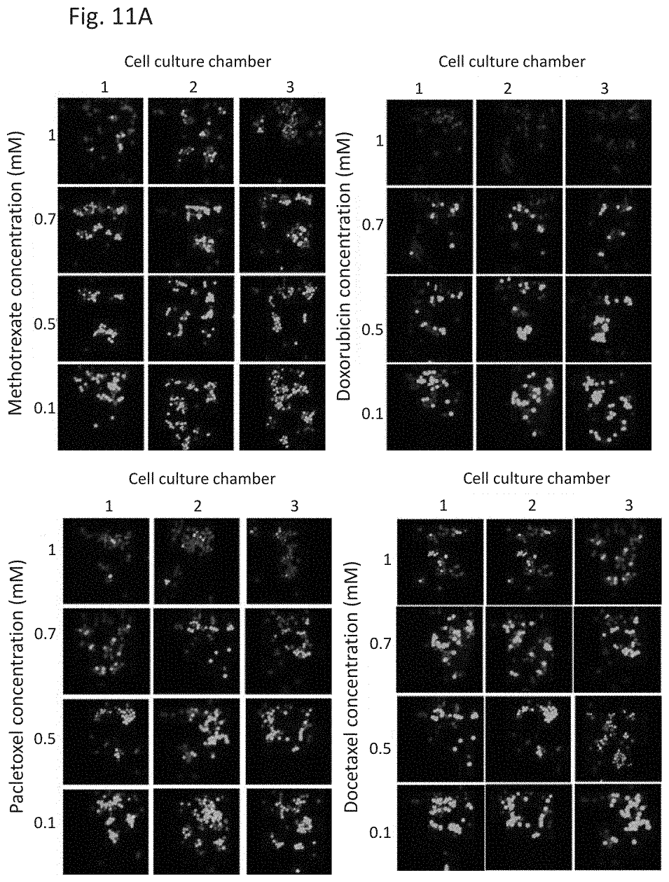

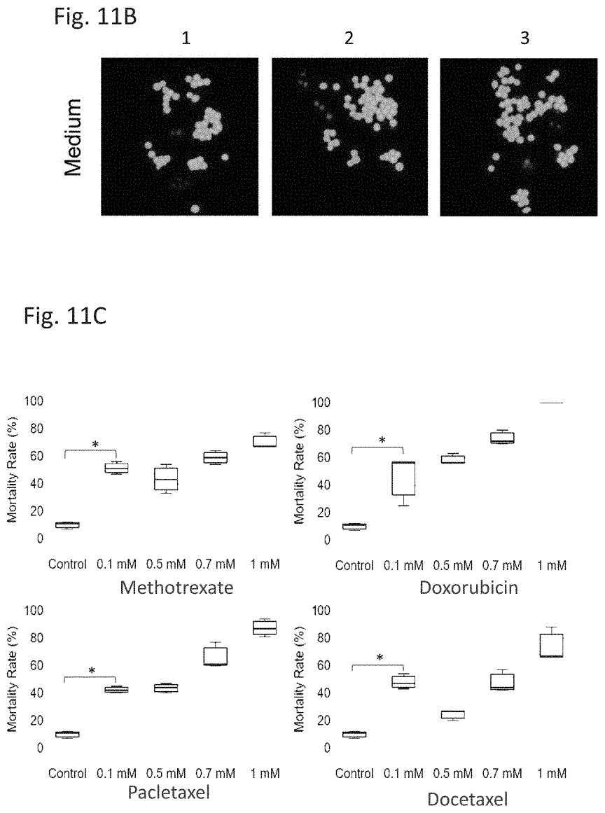

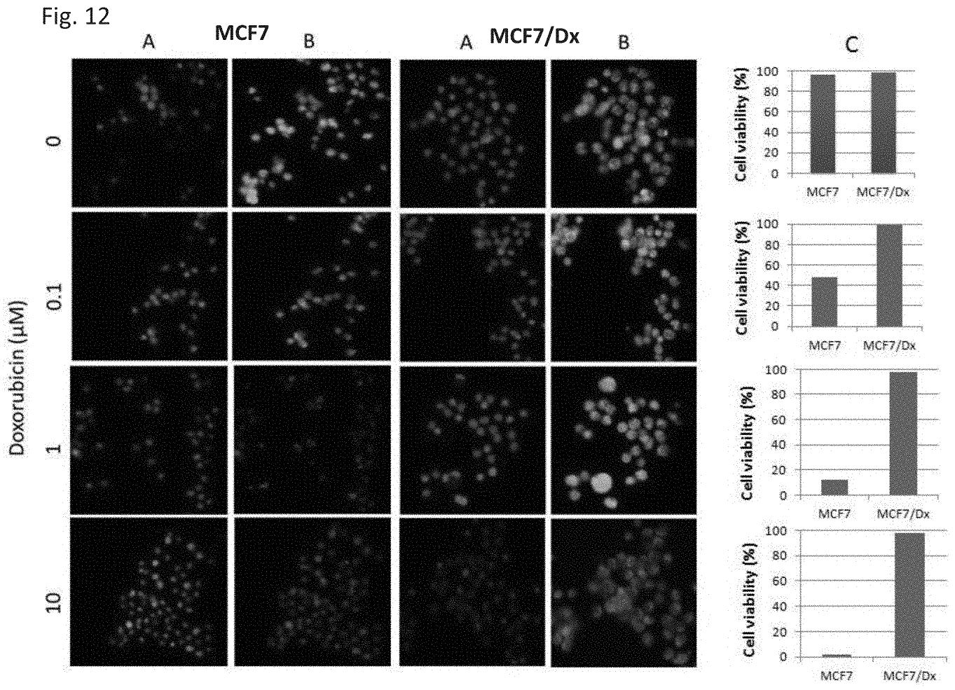

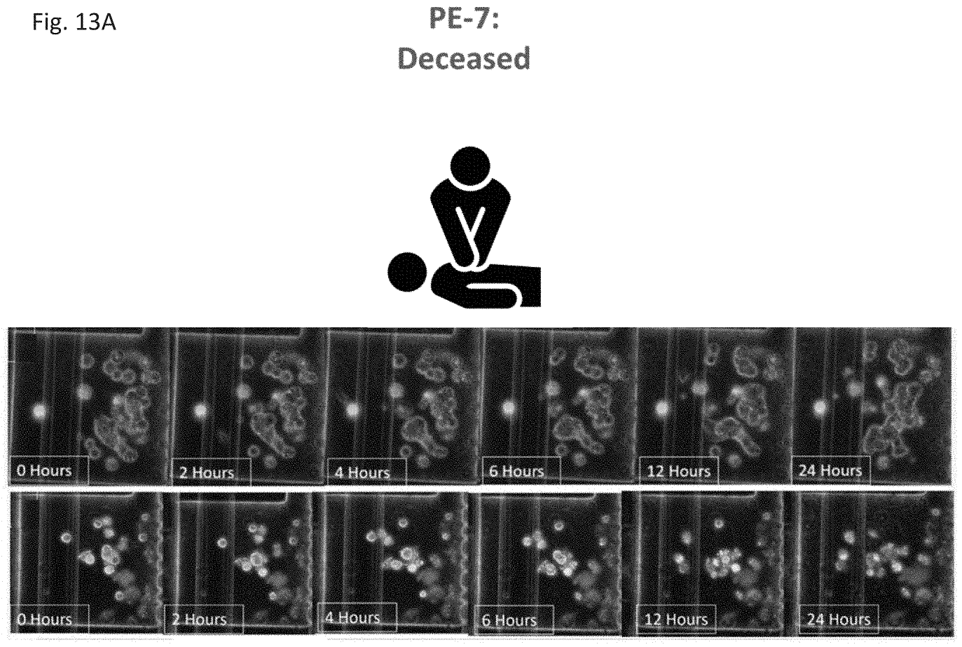

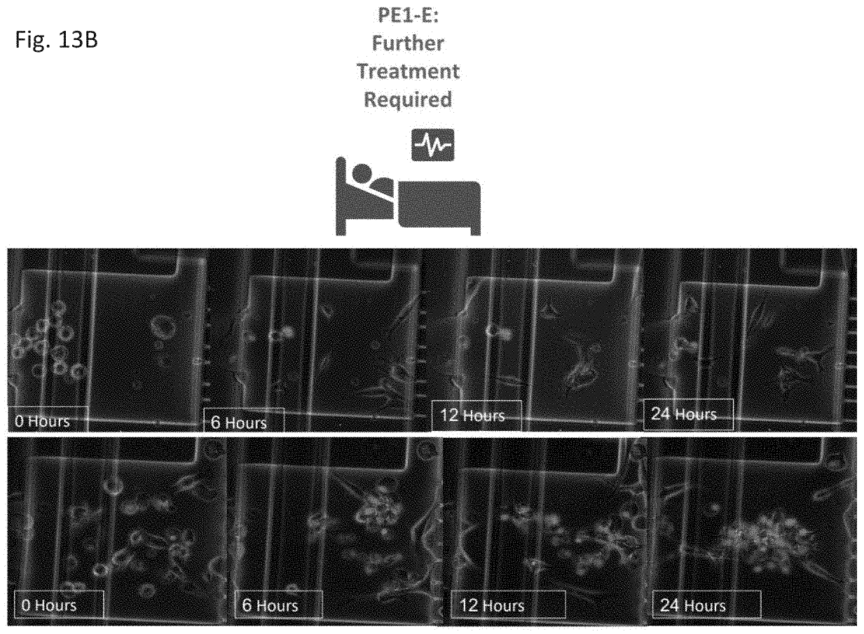

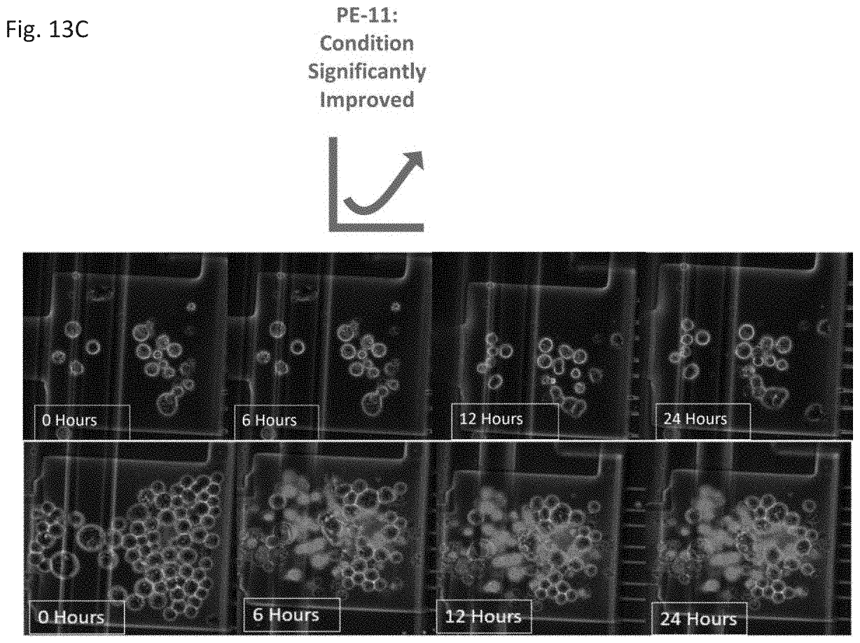

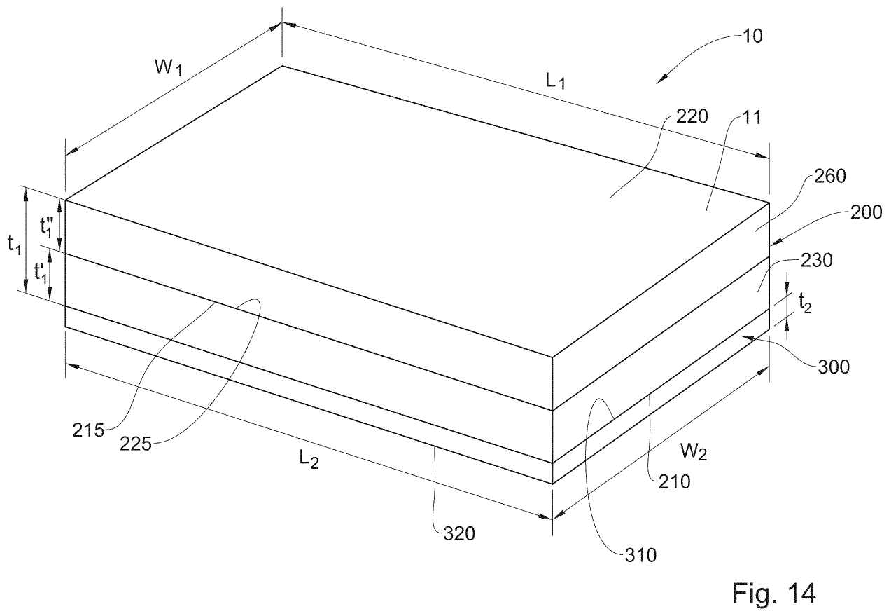

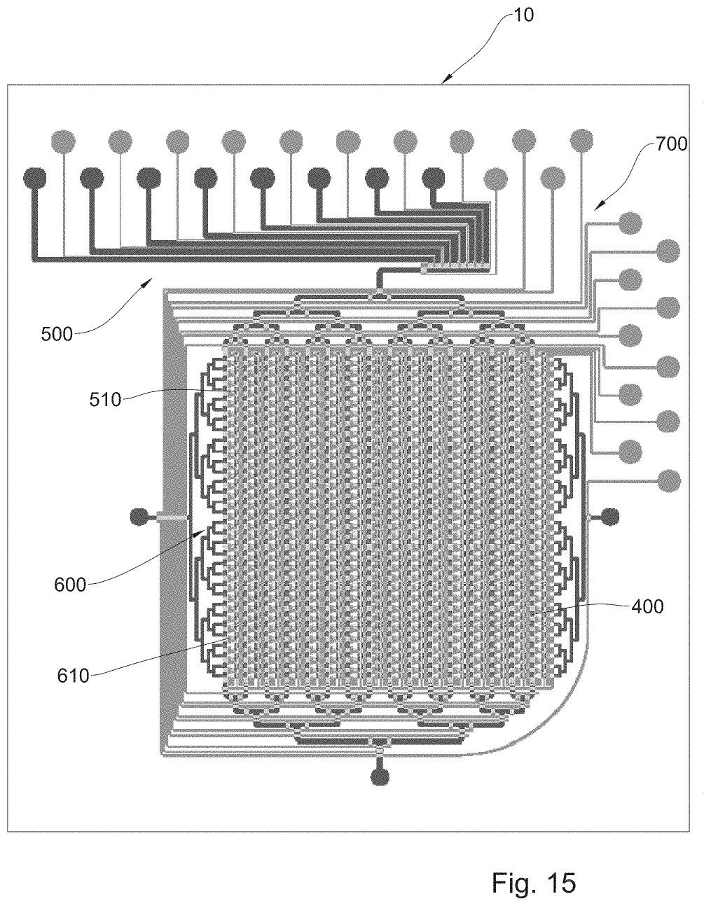

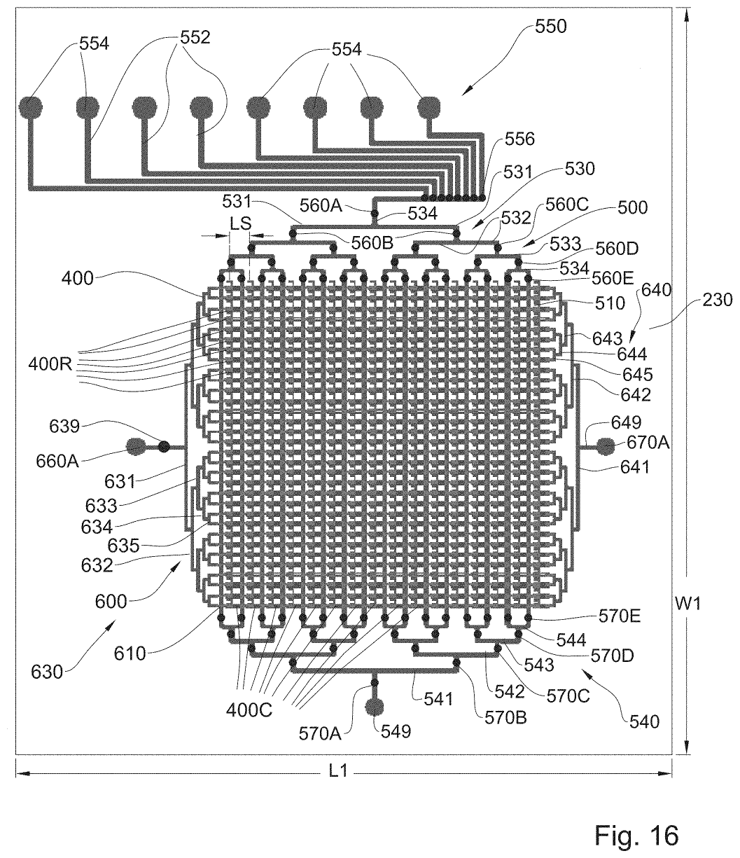

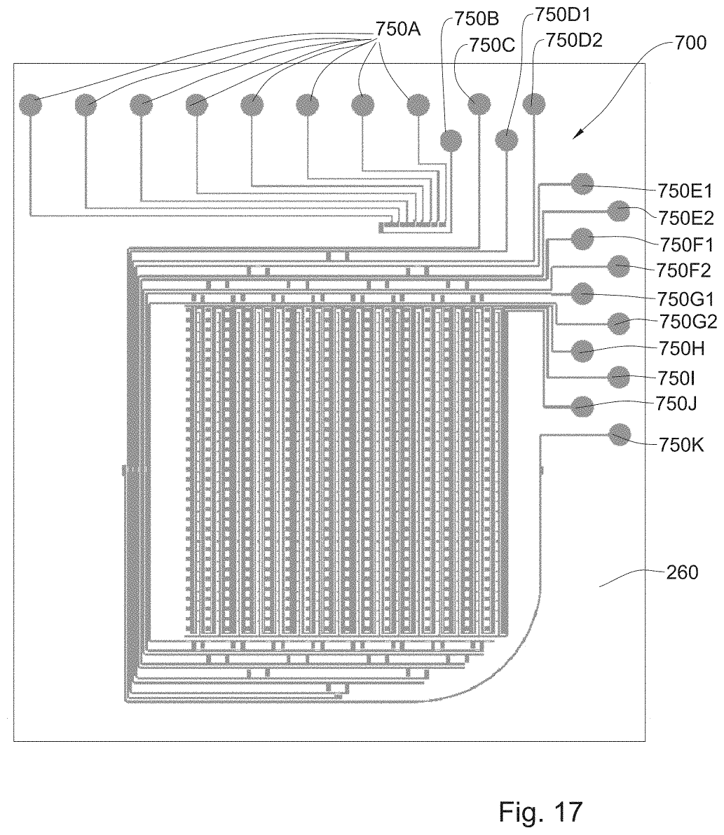

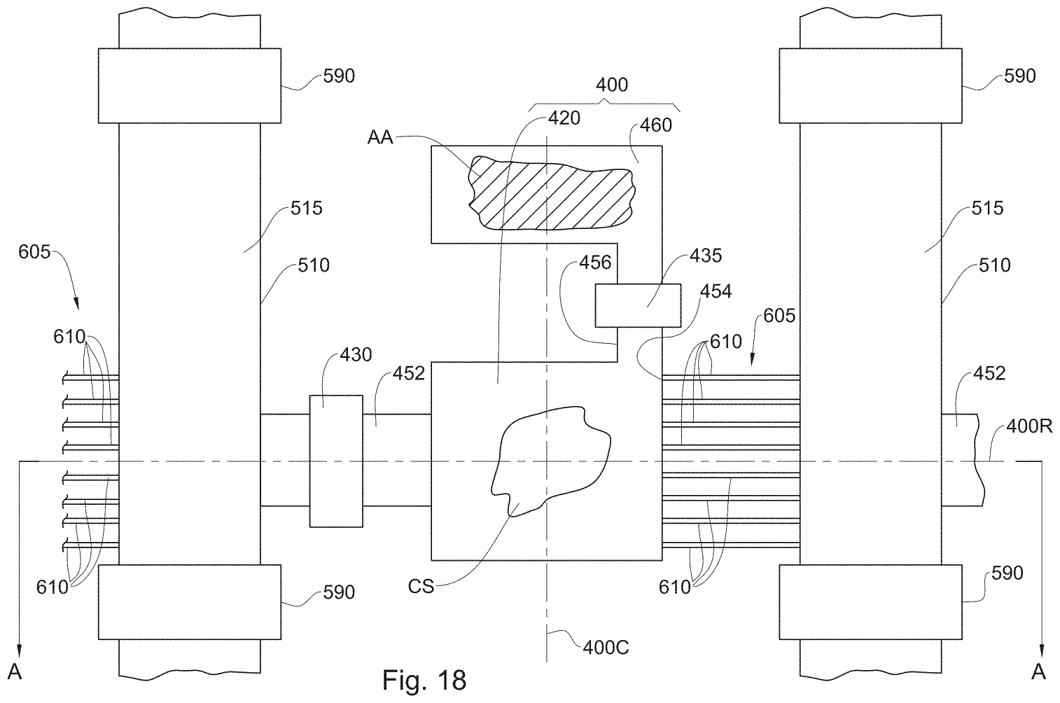

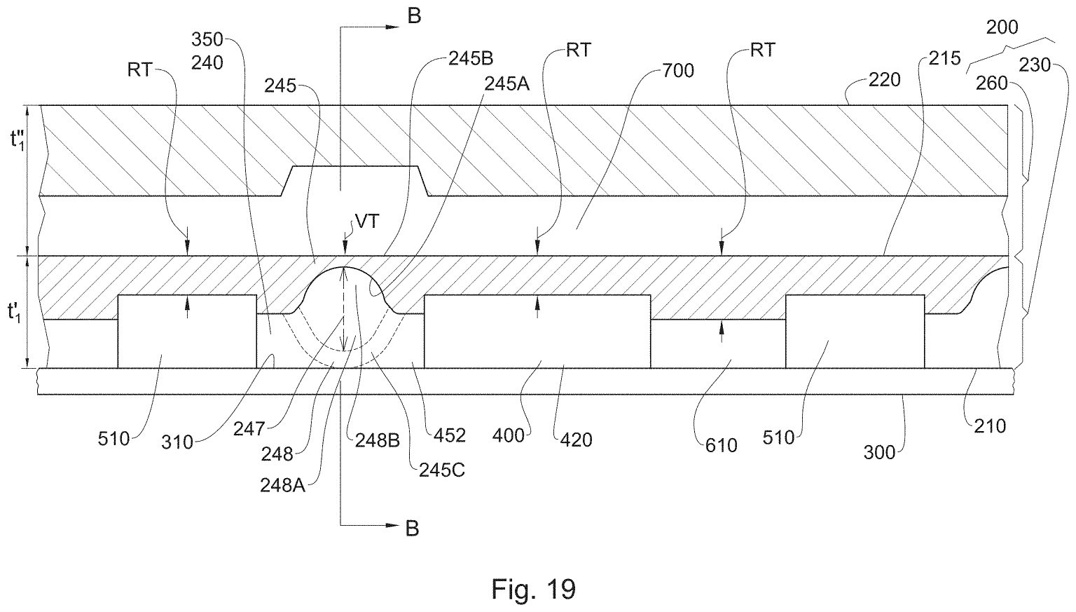

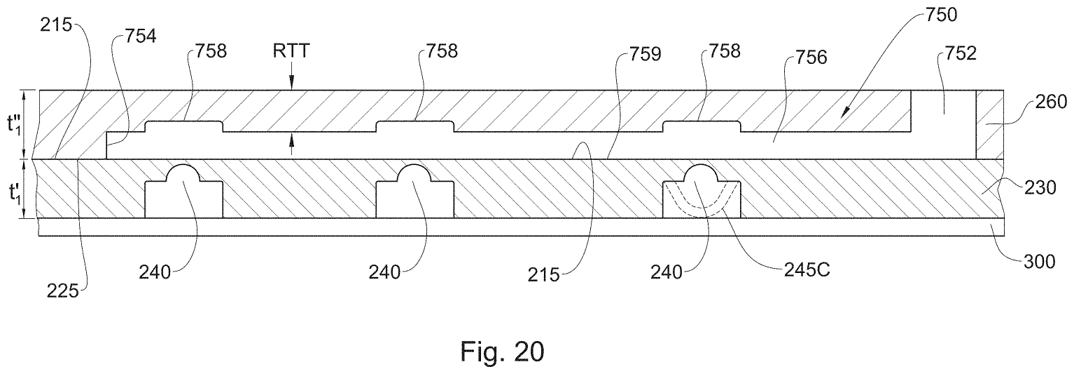

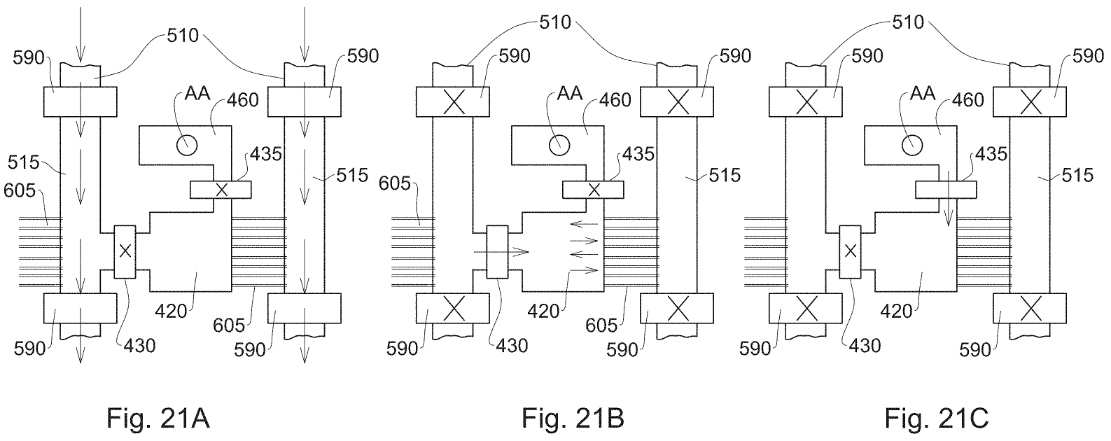

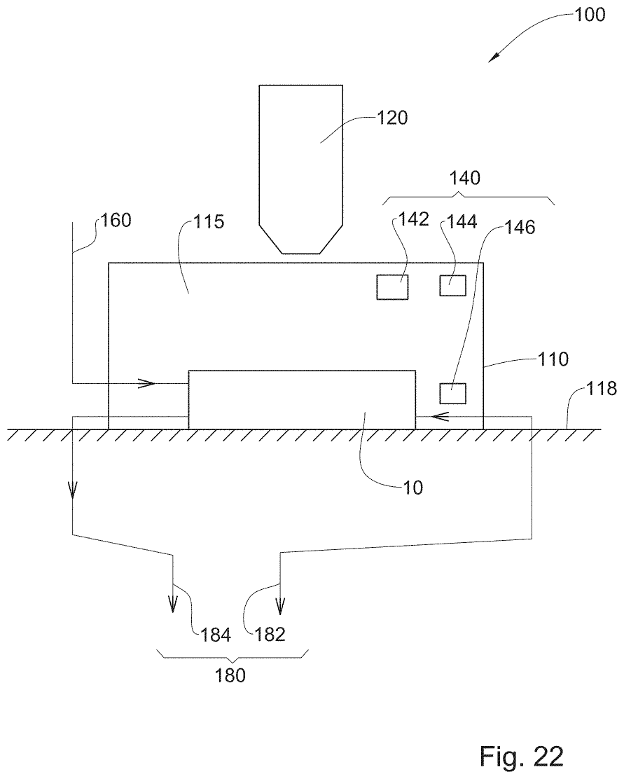

FIG. 2B: Frequency histograms of live cells, inside the cultivation chambers 24 hours after seeding a cell sample with 15·10⁶ cells mL⁻¹.

FIG. 2C: Frequency histograms of dead cells, inside the cultivation chambers 24 hours after seeding a cell sample with 15·10⁶ cells mL^{-1.}

FIG. 3: Frequency histograms alive/dead cells.

FIG. 3A: Data presents the various live cells densities normalized to the total number of chambers within the device. Live cells were counted within 512 chambers following an accommodation period (24 hours post seeding). A volume of 50-100 ul cells sample (15×10⁶ cells/ml) was flown into the device.

FIG. 3B: Data presents the various dead cells densities normalized to the total number of chambers within the device. Dead cells were counted within 512 chambers following an accommodation period (24 hours post seeding). A volume of 50-100 ul cells sample (15×10⁶ cells/ml) was flown into the device.

FIG. 4A-4B: Survival rate of MCF-7 cells within the microfluidic device.

FIG. 4A: Data presents Live/dead staining assay of two cell types, MCF7 cells (Blue) and 293T cells (Red), which were cultivated within the chambers. Survival rate (%) was analyzed at 4 time points post accommodation (T24-T96). T0—24 hours post seeding—the accommodation phase, T24-T96, 24-96 hours post the accommodation period.

FIG. 4B: Traditional boxplot analysis presents the survival rate of these two types of cells. For the MCF7 cells six different experiments were evaluated in which the number of analyzed chambers was n=23 per time point. For the 293T cells one experiment was conducted in which 13 cells chambers were analyzed per time point. For all experiments a volume of 50-100 ul cells sample (15·10⁶ cells/ml) was loaded on the device. P value was determined using two-tail unpaired T-test. (*) p<0.05, (***) p<0.001.

FIG. 5A-5B: Cell response to Docetaxel.

FIG. 5A: Representative live/dead staining assay of MCF7 cells exposed to 100 uM Docetaxel (Grey) Vs. control cells (Red). Cells were seeded 48 hours before drug exposure. At T₀ the cells were exposed to the drug (2 hr incubation) and followed for another 48 hours post drug exposure.

FIG. 5B: Box plot presentation of the mortality rate for MCF7 cells following drug-Docetaxel 100 uM (Grey) and without drug—Control (Red). Mortality rates were normalized to the initial mortality rate at time T₀ for each chamber. The number of chambers analyzed for each time point was n=47.

FIG. 5C: The response of 293T cells after exposure to Docetaxel 10 uM (Grey) and the response of the control cells (Red). 10 chambers for each group were analyzed per time point.

FIG. 6A-6B: Dynamics of cell death following Docetaxel treatment.

FIG. 6A: Live images of a representative cell chamber before (T0) and after (up to 20 hours) exposure to Docetaxel (10 uM). Dead cells were stained with Red (PI).

FIG. 6B: Box plot analysis of the mortality rate (%) of cells following 2 hours of exposure to Docetaxel (10 uM)—T0. Nearly 100 cells chambers were analyzed, 50 following drug exposure and 50 control—no drug exposure. Immediately after 2 hrs of drug exposure there were no differences in cells vitality (T0 drug). Twenty hours post cultivation an increase in cells mortality was detected, however, following drug exposure a further significant increase was observed (p<0.05). Two tail paired T-test analysis were conducted.

FIG. 7: MCF7 cells cultivated in the microfluidic device Vs. standard cell culture.

Live image of cultivated cells within the microfluidic cell chamber and in a standard cell culture dish. Pictures were taken immediately after seeding (T₀), 3 hours (T₃) and 17 hours (T₁₇) post seeding.

FIG. 8: Docetaxel effects on dispersed cells Vs. clusters.

Cells were exposed twice to Docetaxel once at a concentration of 1 μM and 24 hours later re-exposed to 10 μM Docetaxel for a period of 2 hrs. Mortality rate (mean±S.E) of cells within the clusters, was significantly lower versus the mortality rate of dispersed cells, (*) p=0.00013. P value was determined using two-tail T-test (n=43).

FIG. 9A-9B: Live/dead staining assay of cells following exposure to two sessions of Docetaxel.

FIG. 9A: Cells were exposed twice to Docetaxel once at a concentration of 1 μM and 48 hours later a second exposure to 10 μM. Images were taken 24 hours after the second drug exposure T24 (which is 120 hours post seeding).

FIG. 9B: Following the same experimental protocol (a), cells were photographed at different intervals post seeding. Cluster format contains nearly no dead cells whereas nearly all dispersed cells died.

FIG. 10: Docetaxel effect on cells vitality within the microfluidic cell chamber.

Cells were exposed to 10 μM Docetaxel for 2 hours. The dynamic of cell death was detected using PI staining. Results showed cell death only at the dispersed cells format with no death in the cluster. Monitoring proceeded up to 28 hours.

FIG. 11A-11C: MCF7 cells response to an array of drugs.

MCF7 cells response to 4 different drugs (Doxorubicin, Docetaxel, Pacletoxel, Methotrexate) at 4 different concentrations (0.1-1 mM). The drugs were printed on the slide and aligned into drug chamber inside the device. Live/dead assay was performed by double staining dead cells (Red) and live cells (Green).

FIG. 11A: Qualitative presentation of cells response to the various drugs at an increased dosage (0.1-1 uM).

FIG. 11B: Qualitative presentation of cells response to medium (control).

FIG. 11C: Box plots analysis for each drug at the different dosages (n=3). Significance was evaluated via two tail paired T-test, (*) p<0.05.

FIG. 12A-12C: Doxorubicin effect on MCF7 and MCF7/Dx cells.

Selected fluorescent images of MCF7 and MCF7/Dx cells taken at (×20) following treatment with Doxorubicin. Cells were exposed to four concentration (0, 0.1, 1 and 10 μM) of Doxorubicin (Red fluorescence) for 24 hours and vitality staining assay was applied using Calcein AM fluorescent dye (Green-live cells) in the microfluidic device.

FIG. 12A: Columns A, Doxorubicin intracellular distribution in the cells. The overlay of Doxorubicin inherent fluorescence (Red) with Hoechst 33342 nuclear dye (Blue).

FIG. 12B: Columns B, The vitality test with Calcein AM (green).

FIG. 12C: Histogram presentation of the vitality analysis for MCF7 and MCF7/Dx cells. Vitality was normalized to total cell per chamber.

FIG. 13A-13C: Patient history demonstrate full correlation with CSRA results.

Samples from 8 patients were tested. All samples were resistant to Alectinib but showed varying sensitivity to Crizotinib. The above panels show very low sensitivity (FIG. 13A), medium sensitivity (FIG. 13B) and high sensitivity (FIG. 13C). Dead cells were labeled in pink with Propidium Iodide. Left panel was also labeled in green to verify that all cells are alive since no sensitivity was observed.

FIG. 14 is an isometric view of a microfluidic test platform according to an example of the presently disclosed subject matter.

FIG. 15 is a schematic plan view of the first network, second network and reaction units, and control system of the example of FIG. 1.

FIG. 16 is a schematic plan view of the first network, second network and reaction units of the example of FIG. 1.

FIG. 17 is a schematic plan view of the control system of the example of FIG. 1.

FIG. 18 is a plan view of a reaction unit and part of the surrounding first network and second network of the example of FIG. 1.

FIG. 19 is a transverse side view of the example of FIG. 18, taken along A-A.

FIG. 20 is a lateral side view of the example of FIG. 19, taken along B-B.

FIGS. 21A-21C. FIGS. 21A, FIG. 21B and FIG. 21C schematically illustrate feeding operation, seeding operation and active agent exposure operation, respectively, of the example of FIG. 18.

FIG. 22 schematically illustrates a system for operating a microfluidic test platform according to a first example of the presently disclosed subject matter.

### DETAILED DESCRIPTION OF THE INVENTION

Herein, an example of a Poly-Di-Methyl-Siloxane (PDMS) integrated microfluidic device with pneumatic microvalves combined with microarray drug spotting and cell culturing is presented. The device allows testing chemosensitivity and resistance of multiple cell types to multiple drugs and doses in parallel. For example Docetaxel, Doxorubicin. Paditaxel, and Methotrexate which are common chemotherapies as well as Crizotinib and Alectinib which represent targeted therapies ((ALK inhibitors—antibodies) were exemplified in this study. MCF-7 and 293T cells were cultured in the device for 24 hours and then exposed to various concentrations of the drugs. Then the probability of cell death was determined as a function of drug concentration and time. In a proof of concept experiment, a drug array was created, by contact printing four anticancer drugs at 4 different concentrations and the microfluidic platform was used to test their effect on cell vitality. The examples shown in the present disclosure demonstrate that this microfluidic platform is suitable for the evaluation of cancer cells response to drug arrays. The platform could be further used for CSA models with primary cancer cells obtained from patient tumors. Using high-throughput microfluidic devices could allow for rapid characterization of cell population response to drugs, e.g. tumor cells. This approach may significantly decrease the wasting of time and patient energies on non-beneficial treatments and could improve patient outcome.

Therefore, in a first aspect of the presently disclosed subject matter there is provided a microfluidic test platform, comprising a block defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; wherein the reaction units are provided with desired said active agents in situ dud ng manufacture of the microfluidic test platform. According to an aspect of the presently disclosed subject matter, and referring to FIG. 14, a first example of a microfluidic test platform, generally designated with reference numeral 10, is in the form of a block 11 comprising a block member 200 affixed in overlying relationship with a base member 300. Herein, “microfluidic test platform” is used interchangeably with any one of “platform”, “microfluidic platform”, “test platform”, “device”, “microfluidic CSRA device”, “CSRA device”. The block member 200 has a generally planar first block face 210 facing and in contact with a complementary first base face 310 of the base member 300. The block member 200 in at least this example is generally parallelopiped in form, and has a length dimension L1, width dimension W1, and thickness dimension t1. For example, the length dimension L1 is about 5 cm to 6 cm, the width dimension W1 is about 4 cm to 5 cm, and the thickness dimension t1 is about 0.5 cm to 0.7 cm. It is to be noted that in alternative variations of this examples, and in some other examples, the block member can have any other suitable shape, regular or irregular, and any suitable size. The block member 200 can be made from any suitable bio-compatible material. In at least this example, the block member 200 is made from a material that is transparent to electromagnetic radiation, particularly in the visible spectrum and/or in the spectrum corresponding to fluorescence imaging.

Furthermore, in at least this example, the block member 200 is made from a material that is gas-permeable, in particular permeable to gaseous carbon dioxide. For example, the block member 200 is made from polydimethylsiloxane (PDMS).

In at least this example, the base member 300 has a length dimension L2, width dimension W2, and thickness dimension t2. For example, the length dimension L2 is about 5 cm to 6 cm, the width dimension W2 is about 4 cm to 5 cm, and the thickness dimension t2 is about 0.1 cm.

The base member 300 can be made from any suitable bio-compatible material, for example glass, silicon or any other suitable material. In at least this example, the base member 300 is made from a material that is transparent to electromagnetic radiation, particularly in the visible spectrum.

The block member 200 has a second block face 220, facing a direction generally opposed to that of the first block face 210, and is spaced by the block thickness dimension t1 from the second block face 220.

The base member 300 has a second base face 320, facing a direction generally opposed to that of the first base face 310, and is spaced by the base thickness dimension t2 from the second base face 320.

Referring also to FIGS. 15, 16 and 17, the block member 200 is configured with a first plurality of reaction units 400, a first network 500 of feeding channels 510, a second network 600 of seeding channels 610, and a control system 700.

In at least this example, the block member 200 comprises two block layers: a first block layer 230 and a second block layer 260, which are affixed to one another is overlying relationship.

As best seen in FIG. 16 and FIG. 14, the first block layer 230 is configured with the first plurality of reaction units 400, the first network 500 of feeding channels 510, the second network 600 of seeding channels 610, and further comprises the first block face 210, and a first inter-layer face 215 spaced from the first block face 210 by a first layer thickness t1′.

As best seen in FIG. 17 and FIG. 14, the second block layer 260 is configured with the control system 700, and further comprises the second block face 220, and first inter-layer face 215 spaced from the second block face 220 by a second layer thickness t1″.

In at least this example, the reaction units 400 are arranged in a rectangular two-dimensional array, having two or more array rows 400R and two or more array columns 400C. In at least this example the first plurality consists of M*N reaction units 400, arranged in M array rows 400R and N array columns 400C. Thus, each array column comprises M reaction units 400, and each array row comprises N reaction units 600. In at least this example, the array rows 400R are arranged parallel to the length dimension L1, and the array columns 400C are arranged parallel to the width dimension W1.

It is to be noted that in alternative variations of this example, any suitable number of reaction units 400 can be provided, in any desired arrangement.

In at least this example, N is 32, M is 16, and the number of reaction units 400 is 512. However, in alternative variations of this example, N and M can each have different values. For example, the number of reaction units can be any one of or greater than any one of the following: 50, 60, 70, 80, 90, 100, 200, 300, 400, 500, 600.

Referring in particular to FIG. 18, in at least this example, each reaction unit 400 comprises a respective reaction chamber 420 (also interchangeably referred to herein as “cell chamber”, “C—cell chamber”). in selective fluid communication with one respective active agent chamber 460 (also interchangeably referred to herein as “drug chamber”, “D—drug chamber”).

As will be disclosed in greater detail herein, each respective active agent chamber 460 is configured for accommodating therein an active agent AA, for example a candidate active agent or a therapeutic active agent, for example drug, or for example a labeling active agent or characterizing active agent, and the active agent can be provided in situ from factory, enabling immediate use of the platform 10.

According to an aspect of the presently disclosed subject matter, each reaction unit 400 can comprise a different candidate active agent AA, or a different composition or concentration of one or more candidate active agent AA, thereby enabling a plurality of different candidate active agents AA, and/or of different compositions of candidate active agents AA, and/or different concentration of candidate active agent AA to be tested concurrently with similar cell samples IS in the same platform 10.

Alternatively, each reaction unit 400 can comprise a different therapeutic active agent AA, or a different composition or concentration of one or more therapeutic active agent AA, thereby enabling a plurality of different therapeutic active agents AA, and/or of different compositions of therapeutic active agents AA, and/or different concentration of therapeutic active agent AA to be tested concurrently with similar cell samples IS in the same platform 10.

Examples of such candidate active agents, therapeutic active agents, and cells for such cell samples are disclosed herein.

Furthermore, and will be disclosed in greater detail herein, each respective reaction chamber 420 is configured for accommodating therein a cell sample CS, and examples thereof are discussed herein. The cell sample CS is delivered to the reaction chamber 420 via the first network 500 of feeding channels 510 and seeding channels 610, and each respective reaction chamber 420 is further configured for selectively enabling interaction of the cell sample CS with at least one active agent provided by the respective active agent chamber 460.

Each reaction chamber 420 has at least one seeding port 452 comprising a microfluidic valve 240 in the form of a respective first valve 430 configured for selectively allowing or preventing fluid communication between the reaction chamber 420 and at least one feeding channel 510 of the first network 500.

Each reaction chamber 420 further comprises a plurality of seeding ports 454 configured for providing free fluid communication between the reaction chamber 420 and a respective group 605 of feeding channels 610 of the second network 600.

Each reaction chamber 420 further comprises at least one inlet port 456 comprising a microfluidic valve 240 in the form of a respective second valve 435 (also interchangeably referred to herein as “drug valve”, “3-drug valve”) configured for selectively allowing Or preventing fluid communication between the reaction chamber 420 and the at least one respective active agent chamber 460.

The first network 500 is configured for selectively delivering to some or all of the reaction units 400, under the action of the second network 600 typically the following: cell samples CS in suitable media from an external source; one or more source agents, for example nutrients for cell growth; culture medium; dyes. Furthermore, and as will be disclosed in greater detail herein, operation of the first network 500 and of the second network 600 is controllable via the control system 700.

Referring again to FIG. 16, the first network 500 comprises a plurality of feeding channels 510, an inlet manifold arrangement 530, an outlet manifold arrangement 540, and a delivery manifold arrangement 550. In FIGS. 15 and 16, the first network 500 is depicted in color red.

The feeding channels 510 are, at least in this example, generally rectilinear, and run parallel to the width direction W1. The feeding channels 510 are laterally spaced from one another by a lateral spacing LS parallel to the length dimension L1. Furthermore, each feeding channel 510 is juxtaposed and laterally spaced from a respective array column 400C, operating essentially as a bus.

Each feeding channel 510 is configured for selectively delivering cell samples CS in suitable media, one or more source agents, for example nutrients for cell growth, culture medium, and/or dyes to the respective said reaction units 400 of the respective array column 400C, under the action of the second network 600. Thus, in at least this example, the number of feeding channels 510 matches the number M of array columns, for example 16.

Furthermore, each feeding channel 510 is in selective fluid communication with the respective N reaction units 400 of the respective array column 400C, via the respective seeding ports 452 and respective first valves 430.

The inlet manifold arrangement 530 is configured for distributing and controlling fluid flow from a main feeding inlet 534 to each of the feeding channels 510, via a plurality of a microfluidic valves 240, each in the form of a feeding valve, under the control of control system 700.

The main feeding inlet 534 comprises a feeding valve in the form of primary feeding valve 560A configured for selectively allowing or preventing fluid flow therethrough from the delivery manifold arrangement 550.

The main feeding inlet 534 bifurcates, downstream of the primary feeding valve 560A, into two first branches 531, each said first branch 531 comprising a feeding valve in the form of respective secondary feeding valve 560B configured for selectively allowing or preventing fluid flow therethrough from just downstream of the primary feeding valve 560A of the main feeding inlet 534.

Each said first branch 531 bifurcates, downstream thereof into two second branches 532, each said second branch 532 comprising a feeding valve in the form of respective tertiary feeding valve 560C configured for selectively allowing or preventing fluid flow therethrough from just downstream of the respective secondary feeding valve 560B of the respective said first branch 531.

Each said second branch 532 bifurcates, downstream thereof into two third branches 533, each said third branch 533 comprising a feeding valve in the form of respective quaternary feeding valve 560D configured for selectively allowing or preventing fluid flow therethrough from just downstream of the respective tertiary feeding valve 560C of the respective said second branch 532.

Each said third branch 533 bifurcates, downstream thereof into two fourth branches 534, each said fourth branch 534 comprising a feeding valve in the form of respective quinary feeding valve 560E configured for selectively allowing or preventing fluid flow therethrough from just downstream of the respective quaternary feeding valve 560D of the respective said third branch 533.

Thus, in at least this example, there are 16 fourth branches 534.

Each said fourth branch 534 is connected to, and in selective fluid communication with a respective feeding channel 510 via the respective quinary feeding valve 560E.

The outlet manifold arrangement 540 is configured for enabling and controlling fluid flow from each of the feeding channels 510 to a feeding drain port 549, via a plurality of feeding valves, under the control of control system 700.

The feeding drain port 549 comprises a feeding valve in the form of respective primary drain valve 570A configured for selectively allowing or preventing fluid flow therethrough from the outlet manifold arrangement 540.

The seeding drain port 549 bifurcates, upstream of primary drain valve 570A, into two first branches 541, each said first branch 541 comprising a feeding valve in the form of respective secondary feeding valve 570B configured for selectively allowing or preventing fluid flow therethrough from just upstream of the primary drain valve 570A of the feeding drain port 549.

Each said first branch 541 bifurcates, upstream thereof into two second branches 542, each said second branch 542 comprising a feeding valve in the form of respective tertiary feeding valve 570C configured for selectively allowing or preventing fluid flow therethrough from just upstream of the respective secondary feeding valve 570B of the respective said first branch 541.

Each said second branch 542 bifurcates, upstream thereof into two third branches 543, each said third branch 543 comprising a feeding valve in the form of respective quaternary feeding valve 570D configured for selectively allowing or preventing fluid flow therethrough from just upstream of the respective tertiary feeding valve 570C of the respective said second branch 542.

Each said third branch 543 bifurcates, upstream thereof into two fourth branches 544, each said fourth branch 544 comprising a feeding valve in the form of respective quinary feeding valve 570E configured for selectively allowing or preventing fluid flow therethrough from just upstream of the respective quaternary feeding valve 570D of the respective said third branch 543.

Thus, in at least this example, there are 16 fourth branches 544.

Each said fourth branch 544 is connected to, and in selective fluid communication with a respective feeding channel 510 via the respective qui nary seeding valve 570E.

It is to be noted that in alternative variations of this example, some of the feeding valves of the inlet manifold arrangement 530 can be omitted while retaining other feeding valves, to thereby alter the level of control of flow through the various branches of the inlet manifold arrangement 530. Similarly, some of the feeding valves of the outlet manifold arrangement 540 can be omitted while retaining other feeding valves, to thereby alter the level of control of flow through the various branches of the outlet manifold arrangement 540.

It is to be noted that in alternative variations of this example, all the microfluidic valves of the inlet manifold arrangement 530 can be omitted while retaining the microfluidic valves of the outlet manifold arrangement 540, or, all the microfluidic valves of the outlet manifold arrangement 540 can be omitted while retaining the microfluidic valves of the inlet manifold arrangement 530.

The delivery manifold arrangement 550 is configured for selectively delivering each one of a plurality of fluids to the main seeding inlet 534 from a corresponding plurality of sources, under the control of control system 700. For example, such fluids can each include any one or more of: cell samples CS in suitable media; one or more source agents, for example nutrients for cell growth; culture medium; dyes.

Referring in particular to FIG. 18, each respective feeding channel 510 comprises a plurality of microfluidic valves, each in the form of blocking valves 590 (also interchangeably referred to herein as “sandwich”, “2-sandwich”, “sandwich valve”), serially arranged along the length of the respective feeding channel 510. Each adjacent pair of blocking valves is spaced by a transverse spacing parallel to the width dimension W1, generally corresponding to the spacing between array rows 400R, and defining therebetween a respective feeding channel segment 515.

The blocking valves 590 are configured for selectively allowing or preventing fluid flow therethrough from the inlet manifold arrangement 530, or to the outlet manifold arrangement 540, under the control of the control system 700.

In particular, each pair of adjacent blocking valves 590 is configured for selectively isolating a respective feeding channel segment therebetween from the remainder of the first network.

Each such feeding channel segment 515 is thus in free fluid communication with a respective group 605 of seeding channels 610 on one transverse side thereof, and in selective fluid communication with a respective seeding port 452 of the respective reaction unit 400 via a respective first valve 430 (also interchangeably referred to herein as “neck”, “1-neck”, “neck valve”) thereof, on another transverse side thereof.

The delivery manifold arrangement 550 comprises a plurality of delivery branches 552, for example 8 delivery branches 552. Each delivery branch 552 has a respective delivery branch inlet port 554, and a microfluidic valve 240 in the form of a respective delivery valve 556 configured for selectively allowing or preventing fluid flow therethrough from the respective branch inlet port 554 to just upstream of the primary seeding valve 560A.

Each delivery valve 556 can be individually controlled via the control system 700 to enable respective fluids provided at the respective delivery branch inlet port 554 to be provided to the inlet manifold arrangement 530, when the primary feeding valve 560A is also open.

Referring again to FIG. 16, the second network 600 comprises a plurality of groups 605 of seeding channels 610, an inlet manifold arrangement 630, and an outlet manifold arrangement 640. In FIGS. 15 and 16, the inlet manifold arrangement 630 and the outlet manifold arrangement 640 of the second network 600 are depicted in color red, while the groups 605 of seeding channels 610 are depicted in blue.

The second network 600 is configured for selectively enabling pockets of fluids trapped in the respective feeding channels 510, in particular comprising cell samples CS in suitable media, one or more source agents, for example nutrients for cell growth, culture medium, and/or dyes, to be urged into the respective reaction units 400 under predefined conditions.

As mentioned above, each reaction chamber 420 has a plurality of feeding ports 454 configured for providing free fluid communication between the reaction chamber 420 and one group 605 of seeding channels 610 of the second network 600.

Thus, for the array M*N of reaction units 400, there is a corresponding number M*N of groups 605 of seeding channels 610.

Each group 605 comprises a plurality of seeding channels 610, for example 7 to 12 seeding channels.

It is to be noted that the aggregate cross-sectional flow area provided by the plurality of seeding channels 610 in each group 605 is similar or identical to the cross-sectional flow area provided by the respective seeding port 452 of the respective reaction unit 400. However, each seeding channel 610 has a respective cross-sectional area, in particular a cross-sectional profile, such as to allow flow of liquids therethrough, but not of cells of the cell sample. For example, each seeding channel 610 can have a width of about 5 micron, while respective seeding port 452 can have a width of about 20 micron. In this manner, each group 605 of seeding channels 610 operates as a filter and blocks passage of cells (of the cell sample) therethrough.

The seeding channels 610 of each group 605 are, at least in this example, generally rectilinear, and run parallel to the length direction L1. Each group 605 of feeding channels 610 is transversely spaced from one another by a transverse spacing parallel to the width dimension W1, generally corresponding to the spacing between array rows 400R. Additionally, each group 605 of feeding channels 610 is laterally spaced from one another by a lateral spacing which includes the lateral width of the respective feeding channel 510 and respective reaction chamber 420 along the length direction, an generally corresponds to the spacing between array columns 400C.

Furthermore, the seeding channels 610 of each group 605 is aligned with, or at least parallel to, a respective array row 400R, and is open fluid communication on one side thereof with a reaction chamber 420, and is open fluid communication on the other side thereof with a feeding channel 520, as best seen in FIG. 18.

Thus, each group 605 of seeding channels 610 is configured for providing free fluid interchange with respect to the respective reaction unit 400 of one array column 400C via the respective feeding ports 454, while preventing at least cell samples CS that may be accommodated in the respective said reaction units 400 (in particular, in the respective reaction chamber 420) to exit the same. Concurrently, each group 605 of seeding channels 610 is configured for providing free fluid interchange with respect to the feeding channel of the next array column 400C.

The inlet manifold arrangement 630 is configured for distributing and controlling fluid flow from a main feeding inlet 639 to each group 605 of feeding channels 610 of a first array column 400C of reaction units 400, via a microfluidic valve 240 in the form of a seeding valve, under the control of control system 700.

The main feeding inlet 639 comprises a microfluidic valve 240 in the form of a seeding valve in the form of primary seeding valve 660A configured for selectively allowing or preventing fluid flow therethrough from the main feeding inlet 639.

The main feeding inlet 639 bifurcates, downstream thereof into two first branches 631. Each said first branch 631 bifurcates, downstream thereof into two second branches 632. Each said second branch 632 bifurcates, downstream thereof into two third branches 633. Each said third branch 633 bifurcates, downstream thereof into two fourth branches 634. Each said fourth branch 634 bifurcates, downstream thereof into two fifth branches 635. Thus, in at least this example, there are 32 fifth branches 635.

Each said fifth branch 635 is in open communication with a respective group 605 of seeding channels 610, which are in turn in open fluid communication with the respective reaction unit 400 of the first array column 400C of reaction units 400.

The outlet manifold arrangement 640 is configured for channeling fluid flow into an outlet drain port 649 from each group 605 of feeding channels 610 of the last feeding channel 510 (i.e., of the feeding channel 510 that is fluidly coupled to the last array column 400C of reaction units 400), via a microfluidic valve 240 in the form of a seeding valve, under the control of control system 700.

The outlet drain port 649 comprises a seeding valve in the form of primary drain valve 670A configured for selectively allowing or preventing fluid flow therethrough from the outlet drain port 649.

The outlet drain port 649 bifurcates, downstream thereof into two first branches 641. Each said first branch 641 bifurcates, downstream thereof into two second branches 642. Each said second branch 642 bifurcates, downstream thereof into two third branches 643. Each said third branch 643 bifurcates, downstream thereof into two fourth branches 644. Each said fourth branch 644 bifurcates, downstream thereof into two fifth branches 645. Thus, in at least this example, there are 32 fifth branches 645.

Each said fifth branch 535 is in open communication with a respective group 605 of seeding channels 610, which are in turn in open fluid communication with the respective reaction unit 400 of the first array column 400C.

In the second network 600, the inlet manifold arrangement 630 and the outlet manifold arrangement 640 are in selective fluid communication with the feeding conduits 510 and the groups 605 of seeding conduits 610 via the respective cell chambers 420 on the one hand, and via the respective seeding ports 452 and the respective first valves 430 on the other hand.

In at least this example, and as mentioned above, the first block layer 230 is configured with the first plurality of reaction units 400, the first network 500 of feeding channels 510, the second network 600 of seeding channels 610, and further comprises the first block face 210.

Referring also to FIG. 19, the first plurality of reaction units 400, the first network 500 of feeding channels 510, the second network 600 of seeding channels 610, including all the respective microlluidic valves, can be provided by forming suitably shaped and sized recesses projecting inwards from the first block face 210 to a suitable respective depth, relative to the thickness dimension t1′ of the first block layer 230.

For example, each reaction chamber 420 can be formed as a square-shaped recess, of sides 250 micron in each direction parallel to the length dimension and the width dimension. Such a square-shaped recess can have, for example, a depth of about 20 micron from the first block face 210. This arrangement leaves a residual thickness RT sufficient to maintain the mechanical integrity (and thus internal volume) of the reaction chamber 420 essentially unchanged when the control system 700 is being operated.

Similarly, for example, each active agent chamber 460 can be formed as a rectangular-shaped recess, of sides 250 micron in a direction parallel to the length dimension, and 125 micron in a direction parallel to the width dimension. Such a rectangular-shaped recess can have, for example, a depth of about 20 micron from the first block face 210. This arrangement leaves a residual thickness RT sufficient to maintain the mechanical integrity (and thus internal volume) of the active agent chamber 460 essentially unchanged when the control system 700 is being operated.

For example, each seeding channel 610 can be formed as a rectangular-shaped recess, of width 3 micron and depth 5 micron, and spanning the spacing between the respective reaction chamber 420 and the respective feeding channel 510. This arrangement leaves a residual thickness RT sufficient to maintain the mechanical integrity (and thus internal volume) of the active agent chamber 460 essentially unchanged when the control system 700 is being operated.

Similarly, for example, each feeding channel 510, and for example each branch of the inlet manifold arrangement 530, outlet manifold arrangement 540, and delivery manifold arrangement 550, can also be provided as a recess having a width of about 220 micron and depth of about 20 micron, running along the entire length of each part of the first network 500 except for at the location of the respective microtluidic valves thereof. This arrangement leaves a residual thickness RT sufficient to maintain the mechanical integrity (and thus internal volume) of the feeding channel 510 essentially unchanged when the control system 700 is being operated.

In at least this example, each of the microfluidic valves 240 of the platform 10, has a normally open configuration, and a closed configuration in response to selective actuation of the control system 700.

In particular, each such microtluidic valve 240 is caused to adopt the respective closed configuration responsive to a threshold pressure being applied thereto via the control system 700.

Referring for example to FIG. 19, one such microtluidic valve 240, in this case a respective first valve 430 comprises a respective valve channel 248 and a respective valve diaphragm 245. The respective valve channel 248 is contiguous in this example with the respective seeding port 452, and defines a respective valve flow area 247 that is normally open defining the respective open configuration of the respective microfluidic valve.

In at least this example, the respective valve channel 248 can be formed as a first recess 248A projecting inwardly from the first block face 210, and further comprising a second recess 248B extending further inwardly from the first recess 248A, the second recess 248B has a curved generally concave cross-section facing in a direction towards the first block face 210, and thereby defining the respective valve diaphragm 245.

The valve diaphragm 245 thus has an inner valve surface 245A facing towards the first block face 210, and an outer valve surface 24513 facing in a direction away from the first block face 210, The inner valve surface 245A and the outer valve surface 245B are spaced by a valve diaphragm thickness VT. The valve diaphragm thickness VT is significantly smaller than the residual thickness RT, and does not maintain its mechanical integrity when the control system 700 is being operated; rather, when the control system 700 is operated to selectively provide a threshold pressure on the outer valve surface 24513, the valve diaphragm 245 essentially deforms or otherwise displaces into abutting contact with the first base face 310 in a manner blocking fluid communication via the respective valve flow area, as illustrated by the phantom line 245C in FIG. 19.

Referring to FIG. 17 and FIG. 20, the control system 700 comprises a plurality of microfluidic control lines 750, each microfluidic control line 750 configured for controlling operation of one or more microfluidic valves 240 associated with the respective microfluidic control line 750. In at least this example, the plurality of microfluidic control lines 750 are provided in the second block layer 260.

Each microfluidic control line 750 has an open first end 752, a closed second end 754, and a lumen 756 extending between the first end 752 and the second end 754. The lumen 756 comprises one or more lumen stations 758, each of which is in overlying relationship with a respective microfluidic valve 240 associated with the respective microfluidic control line 750. In particular, in the block member 200, each lumen station 758 is in overlying relationship with the diaphragm member 245 of the respective microfluidic valve 240 associated with the respective microfluidic control line 750.

The control system 700, in particular the plurality of microfluidic control lines 750, can be provided by forming suitably shaped and sized recesses projecting inwards from the second interlayer face 225 to a suitable respective depth, relative to the thickness dimension t1″ of the second block. layer 260.

For example, at least a portion of the lumen 756, including all the respective lumen stations 758 of the respective microfluidic control line 750, is, in at least this example, can be formed as a rectangular-shaped recess, of suitable width and depth, and spanning the spacing between the respective first end 752, and the respective closed second end 754. This arrangement leaves a residual thickness RTT with respect to the second block face 220, sufficient to maintain the mechanical integrity of the respective lumen 756 essentially unchanged when the control system 700 is being operated.

Each such recess of the lumen 756, in particular of the respective lumen stations 758, has an open end 759 opposite to the respective residual thickness RTT. These open ends 759 are essentially closed by the first interlayer face 215 of the first block layer 230, when the first block layer 230 and the second block layer 260 are affixed to one another in overlying relationship to provide the block member 200.

Thus, the respective external valve surface 245B, of the respective diaphragm members 245 of the respective microfluidic valves 240 associated with the respective microfluidic control line 750, are exposed to the respective lumen 756 of the respective microfluidic control line 750, at the respective lumen station 758.

In operation of the control system 700, each microfluidic control line 750 is operatively and selectively coupled to a pressure source (nor shown), such that a threshold pressure can be selectively applied to the respective lumen 756 via the pressure source. When such a threshold pressure is applied to a particular microfluidic control line 750, the respective diaphragm members 245 of the respective microfluidic valves 240 associated with the respective microfluidic control line 750 are correspondingly exposed to the threshold pressure, and thus deform to the respective closed potion of the respective microtluidic valve 240. In this manner, all the microfluidic valves 240 associated with the respective microtluidic control line 750 are concurrently closed when the threshold pressure is applied to the microfluidic control line 750. Conversely, when threshold pressure is eliminated from the microfluidic control line 750, all the microfluidic valves 240 associated with the respective microtluidic control line 750 are concurrently opened to the respective open configurations.

For example, each microfluidic control line 750 can be connected to a pressure source, for example in the form of a pneumatic pressure source or in the form of a hydraulic pressure source, to selectively provide the required threshold pressure when desired.

Referring again to FIG. 17, the control system 700 comprises a first plurality of said microfluidic control lines 750, each such microfluidic control line being referred to specially as a first microfluidic control line and designated with mference numeral 350A. The first microfluidic control lines 750A are configured for controlling operation of the delivery manifold arrangement 550.

Each first microfluidic control line 750A is configured for controlling operation of a different one of the delivery branches 552.

Each first microfluidic control line 750A has a respective lumen station 758 overlying the respective delivery valve 556 of the respective delivery branch 552.

Thus, operation of the control system 700 such as to selectively provide the threshold pressure to one or more of the first microfluidic control lines 750A results in the respective delivery valve 556 to be allowed to remain open, or in the respective delivery valve 556 to be closed, to thereby allow or prevent respective fluids at the respective delivery branch inlet port 554 to flow to the inlet manifold arrangement 530 (when the primary feeding valve 560A is also open).

Referring again to FIG. 17, the control system 700 comprises a second said microfluidic control line, being designated with reference numeral 750B. The second microfluidic control line 750B, is configured for controlling operation of part of the inlet manifold arrangement 530, in particular for controlling operation through the main feeding inlet 534 to each of the feeding channels 510.

The second microfluidic control line 750B has a respective lumen station 758 overlying the primary feeding valve 560A.

Thus, operation of the control system 700 such as to selectively provide the threshold pressure to the second microfluidic control line 750B results in the primary feeding valve 560A to be allowed to remain open, or in the primary feeding valve 560A to be closed, to thereby enable respective fluids at the main feeding inlet 534 to be allowed to or prevented from, respectively, flowing to the remainder of inlet manifold arrangement 530. The control system 700 also comprises a third said microfluidic control line, being designated with reference numeral 750C. The third microfluidic control line 750C, is configured for controlling operation of part of the outlet manifold arrangement 540, in particular for controlling operation through the feeding drain port 549 from each of the feeding channels 510.

The third microfluidic control line 750C has a respective lumen station 758 overlying the primary drain valve 570A.

Thus, operation of the control system 700 such as to selectively provide the threshold pressure to the third microfluidic control line 750C results in the primary drain valve 570A to be allowed to remain open, or in the primary drain valve 570A to be closed, to thereby enable respective fluids upstream of feeding drain port 549 to be allowed to or prevented from, respectively, flowing to therethrough.

Thus, in order to enable fluid flow through the first network 500, at least the first microfluidic control line 750C, the second microfluidic control line 750C and the third microfluidic control line 750C have to be operated to allow the respective microfluidic valves 240 to be in open configuration.

Referring again to FIG. 17, the control system 700 further comprises a pair of fourth said microfluidic control lines, being designated with reference numeral 750D1 and 750D2. Each fourth microfluidic control line 750D1 and 750D2, is configured for controlling operation of part of the inlet manifold arrangement 530 and a corresponding part of the outlet manifold 540.

In particular, one fourth microfluidic control line 750D1 is configured for controlling flow through one of the two first branches 531 of the inlet manifold arrangement 530, and concurrently through a corresponding one of the two first branches 541 of the outlet manifold arrangement 540. The other fourth microfluidic control line 750D2 is configured for controlling flow through the other one of the two first branches 531 of the inlet manifold arrangement 530, and concurrently through the corresponding other one of the two first branches 541 of the outlet manifold arrangement 540.

One fourth microfluidic control line 750D1 has a respective lumen station 758 overlying one secondary feeding valve 560B and another lumen station 758 overlying one secondary feeding valve 570B, while the other microfluidic control line 750D2 has a respective lumen station 758 overlying the other secondary feeding valve 560B and another lumen station 758 overlying the other secondary feeding valve 570B.

Thus, operation of the control system 700 such as to selectively provide the threshold pressure to one fourth microfluidic control line 750D1 results in the respective secondary feeding valve 560B and in the respective secondary feeding valve 570B being closed thereby preventing fluid flow to the left half of the feeding channels 510 (as seen in FIG. 17), while operation of the control system 700 such as to selectively provide the threshold pressure to the other fourth microfluidic control line 750D2 results in the respective secondary feeding valve 560B and in the respective secondary feeding valve 570B being closed thereby preventing fluid flow to the right half of the feeding channels 510 (as seen in FIG. 17).

Referring again to FIG. 17, the control system 700 further comprises a pair of fifth said microfluidic control lines, being designated with reference numeral 750E1 and 750E2. Each fourth microfluidic control line 750E1 and 750E2, is configured for controlling operation of part of the inlet manifold arrangement 530 and a corresponding part of the outlet manifold 540.

In particular, one fifth microfluidic control line 750E1 is configured for controlling flow through the left one of each pair of second branches 532 of the inlet manifold arrangement 530, and concurrently through a left one of the corresponding pair of second branches 542 of the outlet manifold arrangement 540. The other fifth microfluidic control line 750E2 is configured for controlling flow through the right one of each pair of second branches 532 of the inlet manifold arrangement 530, and concurrently through the left one of each pair of second branches 542 of the outlet manifold arrangement 540.

One fifth microfluidic control line 750E1 has a respective lumen station 758 overlying each respective tertiary feeding valve 560C and another lumen station 758 overlying each tertiary feeding valve 570C, while the other microfluidic control line 750E2 has a respective lumen station 758 overlying each respective tertiary feeding valve 560C and another lumen station 758 overlying each respective tertiary feeding valve 570C.

Thus, operation of the control system 700 such as to selectively provide the threshold pressure to one fifth microfluidic control line 750E1 results in the respective tertiary feeding valves 560C and in the respective tertiary feeding valves 570C closed thereby preventing fluid flow to the first quarter and the third quarter of the feeding channels 510 (as seen in FIG. 17), while operation of the control system 700 such as to selectively provide the threshold pressure to the other fifth microfluidic control line 750E2 results in the respective tertiary feeding valves 560C and in the respective tertiary feeding valves 570C being closed thereby preventing fluid flow to the second quarter and to the fourth quarter of the feeding channels 510 (as seen in FIG. 17).

Referring again to FIG. 17, the control system 700 further comprises a pair of sixth said microfluidic control lines, being designated with reference numeral 750F1 and 750F2. Each sixth microfluidic control line 750F1 and 750F2, is configured for controlling operation of part of the inlet manifold arrangement 530 and a corresponding part of the outlet manifold 540.

In particular, one sixth microfluidic control line 750F1 is configured for controlling flow through the left one of each pair of third branches 533 of the inlet manifold arrangement 530, and concurrently through a left one of the corresponding pair of third branches 543 of the outlet manifold arrangement 540. The other sixth microfluidic control line 750F2 is configured for controlling flow through the right one of each pair of third branches 533 of the inlet manifold arrangement 530, and concurrently through the left one of each pair of third branches 543 of the outlet manifold arrangement 540.

One sixth microfluidic control line 750F1 has a respective lumen station 758 overlying each respective quaternary feeding valve 560D and another lumen station 758 overlying each quaternary feeding valve 570D, while the other microfluidic control line 750F2 has a respective lumen station 758 overlying each respective quaternary feeding valve 560D and another lumen station 758 overlying each respective quaternary feeding valve 570D. Thus, operation of the control system 700 such as to selectively provide the threshold pressure to one sixth microfluidic control line 750F1 results in the respective quaternary feeding valves 560D and in the respective quaternary feeding valves 570D closed thereby preventing fluid flow to the first, third, fifth and seventh eighths of the feeding channels 510 (as seen in FIG. 17), while operation of the control system 700 such as to selectively provide the threshold pressure to the other sixth microfluidic control line 750F2 results in the respective quaternary feeding valves 560D and in the respective quaternary feeding valves 570D being closed thereby preventing fluid flow to the second, fourth, sixth and eighth of the eight consecutive pairs of feeding channels 510 (as seen in FIG. 17).

Referring again to FIG. 17, the control system 700 further comprises a pair of seventh said microfluidic control lines, being designated with reference numeral 750G1 and 750G2. Each seventh microfluidic control line 750G1 and 750G2, is configured for controlling operation of part of the inlet manifold arrangement 530 and a corresponding part of the outlet manifold 540.

In particular, one seventh microfluidic control line 750G1 is configured for controlling flow through the left one of each pair of fourth branches 534 of the inlet manifold arrangement 530, and concurrently through a left one of the corresponding pair of fourth branches 544 of the outlet manifold arrangement 540. The other seventh microfluidic control line 750G2 is configured for controlling flow through the right one of each pair of fourth branches 534 of the inlet manifold arrangement 530, and concurrently through the left one of each pair of fourth branches 544 of the outlet manifold arrangement 540. One seventh microfluidic control line 750G1 has a respective lumen station 758 overlying each respective quinary feeding valve 560E and another lumen station 758 overlying each quinary feeding valve 570E, while the other microfluidic control line 750F2 has a respective lumen station 758 overlying each respective quinary feeding valve 560E and another lumen station 758 overlying each respective quinary feeding valve 570E.

Thus, operation of the control system 700 such as to selectively provide the threshold pressure to one seventh microfluidic control line 750G1 results in the respective quinary feeding valves 560E and in the respective quinary feeding valves 570E closed thereby preventing fluid flow to the first, third, fifth, seventh, ninth, eleventh, thirteenth, fifteenth and seventeenth of the sixteen feeding channels 510 (as seen in FIG. 17), while operation of the control system 700 such as to selectively provide the threshold pressure to the other seventh microfluidic control line 750G2 results in the respective quinary feeding valves 560E and in the respective quinary feeding valves 570E being closed thereby preventing fluid flow to the second, fourth, sixth, eighth, tenth, twelfth, fourteenth and sixteenth of the sixteen feeding channels 510 (as seen in FIG. 17).

Thus, by controlling the fourth microfluidic control lines 750D1, 750D2 to the seventh microfluidic control lines 750G1, 750G2, the user has a measure of control regarding to which feeding channels 510 fluids can be provided from the delivery manifold 550.

Referring again to FIG. 17, the control system 700 also comprises an eighth said microfluidic control line, being designated with reference numeral 750H. The eighth microfluidic control line 750H, is configured for controlling operation of the feeding channels 510, particularly for seeding operations.

The eighth microfluidic control line 750H has a respective lumen station 758 overlying each of the blocking valves 590 of all the feeding channels 510.

Thus, operation of the control system 700 such as to selectively provide the threshold pressure to the eighth microfluidic control line 750H results in all the blocking valves 590 to be allowed to remain open, or in all the blocking valves 590 to be closed, to thereby enable seeding operations via the second network 600 to be allowed or prevented, respectively, with respect to the plurality of reaction units 400.

Referring again to FIG. 17, the control system 700 also comprises a ninth said microfluidic control line, being designated with reference numeral 750I. The ninth microfluidic control line 750I, is configured for controlling operation of all the first valves 430, particularly for seeding operations.

The ninth microfluidic control line 750I has a respective lumen station 758 overlying each of the first valves 430 of all the reaction units 400.

Thus, operation of the control system 700 such as to selectively provide the threshold pressure to the ninth microfluidic control line 750I results in all the first valves 430 to be allowed to remain open, or in all the first valves 430 to be closed, to thereby enable seeding operations via the second network 600 to be allowed or prevented, respectively, with respect to the plurality of reaction units 400.

Referring again to FIG. 17, the control system 700 also comprises a tenth said microfluidic control line, being designated with reference numeral 750J. The tenth microfluidic control line 750J, is configured for controlling operation of all the second valves 435, particularly for reaction operations.

The tenth microfluidic control line 750J has a respective lumen station 758 overlying each of the second valves 435 of all the reaction units 400.

Thus, operation of the control system 700 such as to selectively provide the threshold pressure to the tenth microfluidic control line 750J results in all the second valves 435 to be allowed to remain open, or in all the second valves 435 to be closed, to thereby enable mixing of the contents of the active agent chamber 460 and of the reaction chamber 420 to be allowed or prevented, respectively, with respect to the plurality of reaction units 400.

Referring again to FIG. 17, the control system 700 also comprises an eleventh said microfluidic control line, being designated with reference numeral 750K. The eleventh microfluidic control line 750K, is configured for controlling operation of the second network 600 via the primary seeding valve 660A, particularly for seeding operations. The eleventh microfluidic control line 750K has a lumen station 758 overlying the primary seeding valve 660A.

Thus, operation of the control system 700 such as to selectively provide the threshold pressure to the eleventh microfluidic control line 750K results in primary seeding valve 660A to be allowed to remain open, or in primary seeding valve 660A to be closed, to thereby enable the contents of the respective feeding channel segments 515 to be allowed to or prevented from, respectively, flowing with respect to the plurality of reaction units 400.

The first layer 230 can be provided as a block of suitable material, for example PDMS, of suitable thickness t1′, length dimension L1 and width dimension W1. Depending on whether thickness t1′ is relatively thick or relatively thin, this layer can be manufactured by a suitable casting process or a suitable spin coater process, Thereafter, the reaction units 400, the first network 500 of feeding channels 510, the second network 600 of seeding channels 610, each in the form of suitable recesses of varying depths, can be formed in the first layer via a suitable soft-lithography process.

Similarly, the second layer 260 can be provided as a second block of suitable material, for example PDMS, of suitable thickness t1″, length dimension L1 and width dimension W1. Depending on whether thickness t1″ is relatively thick or relatively thin, this layer can be manufactured by a suitable casting process or a suitable spin coater process. Thereafter, the control system 70, in the form of suitable recesses, can be formed in the second layer via a suitable soft-lithography process.

Thereafter, the first layer 230 and the second layer 260 are aligned such that the lumen stations 758 of each control line 750 overlies the respective microfluidic valve 240 of the first layer 230, and the two layers 230, 260 are fixed to one another. For example the two layers 230, 260 are aligned with respect to one another via manually with the aid of a stereoscope, by aligning each of the microfluidic valves 240 at their correct locations with the respective lumen stations 758. Alternatively, alignment can be performed with any automated method, such as using Microfluidic Device Assembly System (μDAS) (Gerber D. et al., Lab Chip, 2017,17, 557-566).

Once aligned the two layers 230, 260, in overlying and abutting relationship, are placed in a suitable oven for bonding. Alternatively, bonding between the two layers 230, 260 can be performed by exposing the two layers to oxygen plasma prior to the alignment, in particular by exposing the first interlayer face 215 and second interlayer face 225 to oxygen plasma prior to the alignment. Once aligned and in abutment, the two layers 230, 260 become bonded to one another.

It is to be noted that in general the block layer having the greatest thickness dimension is held in a fixed manner, while the thinner layer is moved into alignment therewith. For example, the first block layer 230 is held in a fixed manner while the second block layer 260 is moved into alignment therewith.

According to an aspect of the presently disclosed subject matter, the active agent AA (for example the respective candidate active agent or the respective therapeutic active agent) is deposited in the platform 10 prior to the base member 300 being affixed to the block member 200.

The variety of active agents AA can be provided on the block member 200 and/ or on the base member 200 in predefined alignment therewith, such as to ensure that when the base member 300 and the block member 200 are subsequently affixed to one another in overlying relationship, each active agent AA is accommodated in a respective reaction chamber 400, in particular in a respective active agent chamber 460.

In one example, the variety of active agents AA are printed as deposits on the first base face 310 of the base member 300 in the form of an array. The size and locations of the deposits on the first base face correspond to size and relative locations of the plurality of active agents chambers 460 on the block member 200. Thereafter, the base member 300 and the block member 200 are aligned and affixed to one another, such that each reaction unit 400, in particular each active agent chamber 460, accommodates a respective active agent AA.

For example, the base member 300 and the block layer 200 can be aligned using a process as disclosed, tnulatis mutandis, in “Control and Automation of Multilayered Integrated Microfluidic Device Fabrication” (Kipper et al, Royal Society of Chemistry, Lab Chip, 2017, 17, 557-566), the contents of which are incorporated herein in their entirety.

For example, a thin layer of chemically active moieties, such as epoxy for example, epoxy can be first applied, for example as a coating, to the first base face 310 of the base member 300, and the variety of active agents AA are printed as deposits on the first base face 310, adhering thereto, The chemically active moieties, such as epoxy for example, then also aids in bonding of the base member 300 to the block member 200.

Alternatively, the layer of chemically active moieties, such as epoxy for example, can be omitted, and, after the variety of active agents AA are printed as deposits on the first base face 310, the base member 300 and the block member 200 are aligned and affixed with respect to one another using a plasma bonding process.

For example, a suitable piezo printing process or a suitable contact printing process can be used for depositing the variety of active agents.

Alternatively, the variety of active agents can be printed or otherwise deposited directly to the respective reaction units 400, in particular directly to the respective active agent chambers 460, and this can be followed by affixing of the base member 300 to the block member 200.

Thus, the platform 10 is provided ready-for-use with any desired cell samples, and avoids the time and complexity of having to manually insert each active agent AA in each reaction unit 400.

In other words, the reaction chambers 400, in particular the active agent chambers 460, are provided with the desired active agents AA in situ.

In alternative variations of this example, the reaction chamber and the active agent chamber of each reaction unit can he combined, and thus the second valve 435 can be omitted.

In yet other alternative variations of this example, each reaction unit can include two or more active agent chambers, and respective second valves, so that a variety of different (pre-deposited) active agents can be provided to the reaction chambers at predefined time intervals.

Referring to FIGS. 21A, 21B and 21C, the following operations can be performed on the platform 10 in sequence: feeding operation; seeding operation; active agent exposure operation.

For example, and referring to FIG. 21A, feeding operation of the platform 10 can be performed as follows.

The control system 700 is operated so as to maintain all microfluidic valves 240 of the first network 500 open, while the microfluidic valve of the second network 600 is closed. The control system 700 is concurrently operated so as to ensure that all the blocking valves 590 and all the first valves 430 are in open configuration, and that all the second valves 435 are in closed configuration.

Cell samples CS, as well as nutrients, culture medium, dyes etc., are then provided to the feeding channels 510 via the first network 500, by applying a driving pressure upstream of the primary valve 560A, and until all the feeding channels 510 are primed.

For example, and referring to FIG. 21B, seeding operation of the platform 10 can be performed as follows.

Once the feeding operation is completed, the control system 700 is operated such as to provide the threshold pressure to the eighth microfluidic control line 750H, resulting in all the blocking valves 590 to be closed. This effectively traps a quantity of fluid (comprising cell samples CS in suitable media from an external source; one or more source agents, for example nutrients for cell growth; culture medium; dyes, etc.) in each respective feeding channel segment 515.

Concurrently, the control system 700 ensures that all the first valves 430 remain open, and that all the second valves 435 are in closed configuration.

Thereafter the control system 700 is operated such as to ensure that the pressure is well below the threshold pressure to the eleventh microfluidic control line 750K, so that the primary seeding valve 660A is open.

Thereafter, fluid pressure can be applied to the second network 600 via the main feeding inlet 639, which thereby urges the fluid trapped in each of the respective feeding channel segment 515 to be urged into the respective reaction chambers 400, in particular into the respective reaction chambers 460. The groups 605 allow free fluid flow along each array row 400R, but prevent exit of the cell samples already in the respective reaction chambers 460.

During seeding operations, media, nutrients, dye etc. can flow between reaction units 400 in one direction along each array row 400R, while waste products can flow from the reaction cells 400 to the feed channels 510 in the other direction.

It is to be noted that after the seeding operation of FIG. 21B, and until the active agent operation of FIG. 21C commences, a supplementary feeding operation can be implemented, corresponding to the “Feeding” illustration of FIG. 1B. In other words, the cell sample is contained in the respective reaction chamber 420, and the respective the first valves 430 and the respective the second valves 435 are maintained in the closed position. Nutrients are then allowed to diffuse from the respective feeding channel 510 on the right of the respective reaction unit 520 (as seen in FIG. 18) via the respective group 605, and the blocking valves 590 can remain open during such a supplementary feeding operation. Concurrently, waste products can also flow from the reaction chambers 420 to the feeding channels 510 via the respective groups 605.

For example, and referring to FIG. 21C, active agent exposure operation of the platform 10 can be performed as follows.

Once the reaction chambers 460 have been seeded with cell samples CS, etc., the control system 700 can be operated such as to selectively lower the pressure in the tenth microfluidic control line 750J to significantly below the threshold pressure. This results in all the second valves 435 being allowed to open, thereby enabling mixing of the contents of the active agent chamber 460 and of the reaction chamber 420 in each of reaction units 400.

However, it is to be noted that if instead of using all the reaction units 400, it is desired to test only alternating feeding channels, or alternating groups or 2,4 or 8 feeding channels, the corresponding fourth microfluidic control lines 750D1, 750D2 to the seventh microfluidic control lines 750G1, 750G2, can be correspondingly controlled to allow flow into the desired feeding channels, while preventing fluid flows into the other non-desired feeding channels 510.

The platform 10 can be configured as a single use device, to be disposed of after use with a particular cell sample.

Alternatively, the platform 10 can be configured for multiple uses, in which after each use the first network 500, the second network 600 and the reaction units 400 are cleaned and decontaminated, for example by passing steam or other suitable cleaning fluids therethrough under the control of control system 700.

According to another aspect of the presently disclosed subject matter, and referring to FIG. 22, there is provided a system 100 for operating a platform 10.

The system 100 comprises a housing 110, an imaging system 120, an environment control system 140, a pressurization system 160 and a supply system 180.

The housing 110 defines an internal microenvironment chamber 115 configured for accommodating the platform 10 therein. The housing 110 is supported on a robotic microscope stage 118.

The imaging system 120 comprises a suitable imaging camera, configured for enabling imaging of the individual reaction units 400, in particular of the individual reaction chambers 420, of the platform, at least during the active agent exposure operation. For example, the imaging camera comprises a four-channel fluorescence microscope camera. The environmental control system 140 comprises a humidity control 142, a temperature control 144, and a carbon dioxide control 146, respectively configured for providing control of humidity, temperature and level of carbon dioxide, in the microenvironment chamber 115.

The pressurization system 160 is configured for selectively operating the control system 700 of the platform 10. In particular, the pressurization system is configured for selectively providing the required threshold pressure in each of the control lines 750 of the platform 10, For example, the pressurization system comprises a compressed air source or a pressurized liquid source. The supply system 180 comprises a plurality of input lines 182 coupled to the first network 500 of the platform in operation of the system. For example, the input lines 182 are configured for providing cell samples, culture medium, nutrients, dyes etc. to the platform 10, and each input line 182 is coupled to a different delivery branch inlet port 554 of the delivery manifold 550 of the platform 10. The supply system 180 also comprises one or more output lines 184 for channeling waste out of the platform 10.

The system 100 can be configured as a two-dimensional or as a three-dimensional live imaging platform. Imaging of the microfluidic platform 10 in the system 100 can be based, for example, on fluorescence imaging, for example including any one of regular fluorescence, TIRF, two-photon, confocal, spin disc, and so on.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

A further aspect of the present disclosure relates to a screening method for an active agent that affects cell viability and/or at least one cell phenotype, specifically, morphology, activity, invasiveness, expression of various markers, functional response, and post-translational modifications. In some embodiments, the method comprising the following steps:

In a first step (a), exposing and contacting cells grown in at least one cell chamber of at least one reaction unit of a microfluidic test platform, to at least one candidate active agent accommodated in at least one respective active-agent chamber of at least one reaction unit of the test platform.

The next step (b), involves determining for the exposed cells of (a), cell viability and/or at least one cell phenotype, for at least one time interval. In some embodiments, time intervals include but is not limited to every 5 minutes, 10 minutes, 30 minutes, 1 hour, 2. 3, 4, 5, 6, 7, 8, 9, 10, 11, 12, 13, 14, 15, 16, 17, 18, 9, 0, 21, 22, 23, 24 , 48, 72, 96 hours or more, 2 days, 3, 4, 5, 6, 7, 8, 9, 10, 11, 12, 13 14 days or more.

In the next step (c), determining that the candidate is an agent that affects cell viability and/or phenotype if at least one of cell viability and/or at least one cell phenotype is modulated as compared with the cell viability and/or at least one cell phenotype in the absence of said candidate active agent. In some embodiments, the microfluidic test platform used herein comprises a block of substrate material defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; while the reaction units are provided with desired active agents in situ during manufacture of the microfluidic test platform.

In some embodiments, the microfluidic test platform used in the screening method disclosed herein comprising a block defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; wherein the reaction units are provided with desired said active agents in situ during manufacture of the microfluidic test platform. In some embodiments, cells were cultured within the microfluidic test platform for a suitable time period before being exposed and/or contacted with the test active agent. In some embodiments, cells may be cultured for 1 hr-48 hr, specifically, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48 hrs, and more, 72, 96 hours and more.

In some embodiments, the cells may be exposed several times to be candidate active agent specifically 1, 2, 3, 4, 5, 6, 7, 8, 9 or 10 times.

In some embodiments the additional time of exposure to the candidate active agent may be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48 hrs, and more. 72, 96 hours and more.

In some embodiments, the concentration of the cells grown in the microfluidic test platform may vary between 10⁴ cells mL⁻¹ to 10¹⁰ cells mL⁻¹, specifically 10⁵ cells mL⁻¹ or 10⁶ cells mL⁻¹ or 2·10⁶ cells mL⁻¹ or 3·10⁶ cells mL⁻¹ or 4·10⁶ cells mL⁻¹ or 5·10⁶ cells mL⁻¹ or 6·10⁶ cells mL⁻¹ or 7·10⁶ cells mL⁻¹ or 8·10⁶ cells mL⁻¹ or 10⁷ cells mL⁻¹ or 15·10⁶ cells mL⁻¹ or 10⁸ cells mL⁻¹ or 10⁹ cells mL⁻¹ or 10¹⁰ cells mL⁻¹.

Still further, the average number of cells per chamber may vary between 0 to 1000 cells per chamber, specifically about 1, 5, 10, 15, 16, 17, 18, 19, 20, 25, 30, 31, 32, 33, 34, 35, 36, 38, 39, 40, 45, 50, 55, 60, 65, 70, 75, 80, 85, 90, 95, 100, 150, 200, 250, 300, 350, 400, 450, 500, 550, 600, 650, 700, 750, 800, 850, 900, 950 or 1000 cells.

As used herein, a cellular phenotype may be any detectable characteristic or property of a cell. In some embodiments, cell phenotype may refer to at least one of: cell activity, cell morphology, expression profile, functional response, enzymatic activity of enzymes secreted by the cells (metaloproteases), post translational modification profile, expression profile, of cell surface markers (e.g., TAA's), metastatic properties (invasiveness, cell motility, cell migration and cell adhesion), accumulation of metabolites (e.g., metabolite is any one of a nucleobase, nucleoside, nucleotide, amino acid residue/s, carbohydrate/s, fatty acid and ketone, sterols, calcium accumulation, porphyrin and haem, lipid, sphingolipid, phospholipid, and lipoprotein, neurotransmitters, vitamins and (non-protein) cofactors, pterin, trace elements, metals, metabolites associated with energy metabolism, metabolites associated with peroxisome functions, or any intermediate product, derivative or metabolite there). Thus, cell phenotype also refers to expression of different markers and receptors that characterize the cells.

Thus, in some embodiments, a cellular phenotype may be cell toxicity. More specifically, toxicity or cell toxicity as used herein may be reflected by viability of the cells, shape or morphology, cell growth, cell function, invasiveness, expression of various markers and post-translational modifications.

In yet some further embodiments, cell toxicity, may be reflected by induction of any one of oxidative stressors, nitrosative stressors, proteasome inhibitors, inhibitors of mitochondrial function, ionophores, inhibitors of vacuolar ATPases, inducers of endoplasmic reticulum (ER) stress, and inhibitors of endoplasmic reticulum associated degradation (ERAD). Thus, according to some embodiments, the methods of the invention may further comprise at least one reagent and/or means for measuring and/or detecting cell toxicity.

In some specific embodiments, toxicity, or cell toxicity, may be determined by the methods of the invention by any means for quantification or measuring at least one of cell viability, cell proliferation, cell apoptosis, and any toxic phenotype on the organism or cell.

In some embodiments, the candidate active agent used in the screening methods disclosed herein is placed prior to exposure to said cells, in a predetermined amount, within the respective active-agent chamber.

In some specific embodiments, the candidate active agent is immobilized prior to exposure to said cells, in a predetermined amount, within the respective active-agent chamber.

In some specific embodiments, the amount of candidate active agent may vary between 0 to 1000 μM, specifically 0.1 μM, 0.5 μM, 1 μM, 5 μM, 10 μM, 20 μM, 30 μM, 40 82 M, 50 μM, 60 μM, 70 μM, 80 μM., 90 μM, 100 μM, 200 μM, 300 μM, 400 μM, 500 μM, 600 μM, 700 μM, 800 μM, 900 μM, 1000 μM.

In some other embodiments, the amount of candidate active agent may vary between 0 to 10 mM, specifically 0.1 mM, 0.2 mM, 0.3 mM, 0.4 mM, 0.5 mM, 0.6 mM , 0.7 mM, 0.8 mM, 0.9 mM, 1 mM, 5 mM, 10 mM.

In yet some further embodiments, the candidate active agent used for the screening method disclosed herein, is at least one of: an inorganic or organic molecule, a small molecule, a nucleic acid-based molecule, an aptamer, a peptide or polypeptide or protein (L-as well as D-aa residues) or any combinations thereof.

A compound to be tested may be referred to as a test compound or a candidate compound.

A “Compound”, or a “candidate compound”, or “active agent” or “candidate active agent” is used herein to refer to any substance, agent (e.g., molecule), supramolecular complex, material, or combination or mixture thereof. A compound may be any agent that can be represented by a chemical formula, chemical structure, or sequence. Example of compounds applicable for the present disclosure, include, e.g., small molecules, nucleic acid molecules (e.g., RNAi agents, antisense oligonucleotide, gRNAs, aptamers), amino acid based molecules, for example, polypeptides, peptides, antibodies, lipids, polysaccharides, etc.

It should be understood that any compound described in connection to the present aspect is also applicable in all aspects of the invention. It should be further understood that the invention encompasses the use of any of the described compounds or any combinations or mixtures thereof. In general, candidate compounds may be obtained using any suitable method known in the art. The ordinary skilled artisan will select an appropriate method based, e.g., on the nature of the compound. A compound may be at least partly purified. In some embodiments a compound may be provided as part of a composition, which may contain, e.g., a counter-ion, aqueous or non-aqueous diluent or carrier, buffer, preservative, or other ingredient, in addition to the compound, in various embodiments. In some embodiments a compound may be provided as a salt, ester, hydrate, or solvate. In some embodiments a compound is cell-permeable, e.g., within the range of typical compounds that are taken up by cells and acts intracellularly, e.g., within mammalian cells, to produce a biological effect. Certain compounds may exist in particular geometric or stereoisomeric forms. Such compounds, including cis- and trans-isomers, E- and Z-isomers, R- and S-enantiomers, diastereomers, (D)-isomers, (L)-isomers, (−)- and (+)-isomers, racemic mixtures thereof, and other mixtures thereof are encompassed by this disclosure in various embodiments unless otherwise indicated. Certain compounds may exist in a variety or protonation states, may have a variety of configurations, may exist as solvates (e.g., with water (i.e. hydrates) or common solvents) and/or may have different crystalline forms polymorphs) or different tautomeric forms. Embodiments exhibiting such alternative protonation states, configurations, solvates, and forms are encompassed by the present disclosure where applicable.

Any compound may be used as a test or a candidate compound in various embodiments. In some embodiments a library of FDA approved compounds appropriate for human may be used. Compound libraries are commercially available from a number of companies including but not limited to Maybridge Chemical Co. (Trevillet, Cornwall, UK), Comgenex (Princeton, N.J.), Microsource (New Milford, Conn.), Aldrich (Milwaukee, Wis.), Kos Consulting and Solutions GmbH (Basel, Switzerland), Ambinter (Paris, France), Asinex (Moscow, Russia), Aurora (Graz, Austria), BioFocus DPI, Switzerland, Bionet (Camelford, UK), ChemBridge, (San Diego, Calif.), ChemDiv, (San Diego, Calif.), Chemical Block Lt, (Moscow, Russia), ChemStar (Moscow, Russia), Exclusive Chemistry, Ltd (Obninsk, Russia), Enamine (Kiev, Ukraine), Evotec (Hamburg, Germany), Indofine (Hillsborough, Interbio screen (Moscow, Russia), Interchim (Montlucon, France), Life Chemicals, Inc. (Orange, Conn.), Microchemistry Ltd. (Moscow, Russia), Otava, (Toronto, ON), PharmEx Ltd.(Moscow, Russia), Princeton Bimolecular (Monmouth Junction, N.J.), Scientific Exchange (Center Ossipee, N.H.), Specs (Delft, Netherlands), TimTec (Newark, Del.), Toronto Research Corp. (North York ON), UkrOrgSvnthesis (Kiev, Ukraine), Vitas-M, (Moscow, Russia), Zelinsky Institute, (Moscow, Russia), and Bicoli (Shanghai, China), Combinatorial libraries are available and can be prepared. Libraries of natural compounds in the form of bacterial, fungal, plant and animal extracts are commercially available or can be readily prepared by methods well known in the art. Compounds isolated from natural sources, such as animals, bacteria, fungi, plant sources, and marine samples may be tested for the presence of potentially useful pharmaceutical compounds, specifically, selective modulators of proteasome translocation. It will be understood that the agents to be screened could also be derived or synthesized from chemical compositions or man-made compounds. In some embodiments a library useful in the present invention may comprise at least 10,000 compounds, at least 50,000 compounds, at least 100,000 compounds, at least 250,000 compounds, or more.

In some specific embodiments, a candidate agent screened by the screening methods of the present disclosure or evaluated by any of the methods disclosed in the present disclosure, may be a small molecule. A “small molecule” as used herein, is an organic molecule that is less than about 2 kilodaltons (kDa) in mass. In some embodiments, the small molecule is less than about 1.5 kDa, or less than about 1 kDa. In some embodiments, the small molecule is less than about 800 daltons (Da), 600 Da, 500 Da, 400 Da, 300 Da, 200 Da, or 100 Da. Often, a small molecule has a mass of at least 50 Da. In some embodiments, a small molecule is non-polymeric. In some embodiments, a small molecule is not an amino acid. In some embodiments, a small molecule is not a nucleotide. In some embodiments, a small molecule is not a saccharide. In some embodiments, a small molecule contains multiple carbon-carbon bonds and can comprise one or more heteroatoms and/ or one or more functional groups important for structural interaction with proteins (e.g., hydrogen bonding), e.g., an amine, carbonyl, hydroxyl, or carboxyl group, and in some embodiments at least two functional groups. Small molecules often comprise one or more cyclic carbon or heterocyclic structures and/or aromatic or poi yarom atic structures, optionally substituted with one or more of the above functional groups.

In some specific embodiments, a candidate agent screened by the screening methods of the present disclosure or evaluated by any of the methods disclosed in the present disclosure, may be an aptamer. As used herein the term “aptamer”or “specific aptamers” denotes single-stranded nucleic acid (DNA or RNA) molecules which specifically recognizes and binds to a target molecule. The aptamers according to the invention may fold into a defined tertiary structure and can bind a specific target molecule with high specificities and affinities. Aptamers may be usually obtained by selection from a large random sequence library, using methods well known in the art, such as SELEX and/or Molinex. In various embodiments, aptamers may include single-stranded, partially single-stranded, partially double-stranded or double-stranded nucleic acid sequences; sequences comprising nucleotides, ribonucleotides, deoxyribonucleotides, nucleotide analogs, modified nucleotides and nucleotides comprising backbone modifications, branch points and non-nucleotide residues, groups or bridges; synthetic RNA, DNA and chimeric nucleotides, hybrids, duplexes, heteroduplexes; and any ribonucleotide, deoxyribonucleotide or chimeric counterpart thereof and/or corresponding complementary sequence. In certain specific embodiments, aptamers used by the invention are composed of deoxyribonucleotides.

Still further, candidate compound that may be screened according to the methods of the invention include e.g., any proteins or polypeptides, for example, antibodies or an antigen-binding fragments thereof, receptors, enzymes, ligands, regulatory factors, aptamers, structural proteins, and any nucleic acid sequences encoding the same. Candidate substances also include nuclear proteins, cytoplasmic proteins, mitochondrial proteins, secreted proteins, plasmalemma-associated proteins, serum proteins, viral antigens, bacterial antigens, protozoal antigens and parasitic antigens. Candidate compounds additionally comprise proteins, lipoproteins, glycoproteins, phosphoproteins and nucleic acids (for example, RNAs such as ribozymes or antisense nucleic acids). Proteins or polypeptides which can be screened using the methods of the present invention include chaperone proteins, hormones, growth factors, neurotransmitters, enzymes, clotting factors, apolipoproteins, receptors, drugs, oncogenes, tumor antigens, tumor suppressors, structural proteins, viral antigens, parasitic antigens and bacterial antigens.

In some specific embodiments, a candidate agent screened by the screening methods of the present disclosure or evaluated by any of the methods disclosed in the present disclosure, may be an antibody. The term “antibody” as used herein, means any antigen-binding molecule or molecular complex that specifically binds to or interacts with a particular antigen. The term “antibody” includes immunoglobulin molecules comprising four polypeptide chains, two heavy (H) chains and two light (L) chains inter-connected by disulfide bonds, as well as multimers thereof (e.g., IgM). Each heavy chain comprises a heavy chain variable region (abbreviated herein as HCVR or V_{H}) and a heavy chain constant region (CH). The heavy chain constant region comprises three domains, CH1, CH2 and CH3. Each light chain comprises a light chain variable region (abbreviated herein as LCVR or V_{L}) and a light chain constant region. The light chain constant region comprises one domain (CL1). The V_{H} and V_{L} regions can be further subdivided into regions of hypervadability, termed complementarity determining regions (CDRs), interspersed with regions that are more conserved, termed framework regions (FR). Each V_{H} and V_{L} is composed of three CDRs and four FRs, arranged from amino-terminus to carboxy-terminus in the following order: FR1, CDR1, FR2, CDR2, FR3, CDR3, FR4.

Typically, an antibody is composed of two immunoglobulin (Ig) heavy chains and two Ig light chains. In humans, antibodies are encoded by three independent gene loci, namely kappa (κ) chain (Igκ) and lambda (λ) chain (Igλ) genes for the Light chains and IgH genes for the Heavy chains, which are located on chromosome 2, chromosome 22, and chromosome 14, respectively.

The antibody used by the method of the invention may be any one of a polyclonal, a monoclonal or humanized antibody or any antigen-binding fragment thereof. The term “an antigen-binding fragment” refers to any portion of an antibody that retains binding to the antigen. Examples of antibody functional fragments include, but are not limited to, complete antibody molecules, antibody fragments, such as Fv, single chain Fv (scFv), complementarity determini ng regions (CDRs), V (light chain variable region), V_{H} (heavy chain variable region), Fab, F(ab)₂′ and any combination of those or any other functional portion of an immunoglobulin peptide capable of binding to target antigen.

As appreciated by one of skill in the art, various antibody fragments can be obtained by a variety of methods, for example, digestion of an intact antibody with an enzyme, such as pepsin, or de novo synthesis. Antibody fragments are often synthesized de novo either chemically or by using recombinant DNA methodology. Thus, the term antibody, as used herein, includes antibody fragments either produced by the modification of whole antibodies, or those synthesized de novo using recombinant DNA methodologies (e.g., single chain Fv) or those identified using phage display libraries. The term antibody also includes bivalent molecules, diabodies, triabodies, and tetrabodies.

References to “V_{H}” or a “VH” refer to the variable region of an immunoglobulin heavy chain, including an Fv, scFv, a disulfilde-stabilized Fv (dsFv) or Fab. References to “V_{L}” or a “VL” refer to the variable region of an immunoglobulin light chain, including of an Fv, scFv, dsFv or Fab.

More specifically, the phrase “single chain Fv” or “scFv” refers to an antibody in which the variable domains of the heavy chain and of the light chain of a traditional two chain antibody have been joined to form one chain. Typically, a linker peptide is inserted between the two chains to allow for the stabilization of the variable domains without interfering with the proper folding and creation of an active binding site. A single chain antibody applicable for the invention, e.g., may bind as a monomer. Other exemplary single chain antibodies may form diabodies, triabodies, and tetrabodies.

Antibodies may be used according to the methods of the invention to target an epitope of interest. The term “epitope” is meant to refer to that portion of any molecule capable of being bound by an antibody which can also be recognized by that antibody. Epitopes or “antigenic determinants” usually consist of chemically active surface groupings of molecules such as amino acids or sugar side chains and have specific three dimensional structural characteristics as well as specific charge characteristics.

In yet some further embodiments, the cells used for the screening method disclosed herein, that are placed in the cell chamber, form aggregates and/or clusters in the cell chamber. In some embodiments, formation of the cell clusters occurs prior to exposure of the cells to the test candidate active agent.

As used herein an aggregate or cluster of cells refers to a group of cells in close proximity within a chamber and may comprise a number of cells that vary between 10 to 1000 cells, specifically 10, 15, 20, 25, 30, 35, 40, 45, 50, 55, 60, 65, 70, 75, 80, 85, 90, 95, 100, 150, 200, 250, 300, 350, 400, 450, 500, 550 600, 650, 700, 750, 800, 850, 900, 950 or 1000 cells.

A cluster of cells may comprise cells having different phenotype for example living versus dying cells. In some embodiments, cluster of cells comprise more living cells than dying cells. In some further embodiments, a cluster of cells comprise only living cells.

As shown in the Examples, the cell phenotype may be modulated differently between cells forming a cluster or “cluster cells” or cells that do not form a cluster or “dispersed cells”.

In some other embodiment, the cell phenotype is different within the cluster specifically between the center and the periphery of the cluster. In some specific embodiment, more living cells may be found in the center of the cluster while more dying cells may be at the periphery of the cluster.

Different types of cells may be suitable for the methods of the invention. Specifically in some embodiments, cells suitable for the methods of the invention are eukaryotic cells.

An eukaryote cell or eukaryotic cells as herein defined refer to cells within an organism that contain complex structures enclosed within membranes. All large complex organisms are eukaryotes, including animals, plants and fungi. Thus eukaryotic cells as herein defined may be derived from animals, plants and fungi, for example, but not limited to, insect cells, yeast cells or mammalian cells.

There are several types of eukaryotic cells that may be used by the methods of the invention. By way of example, eukaryotic cells may be, but are not limited to, stern cells, e.g. embryonic stern cells, totipotent stem cells, pluripotent stern cells or induced pluripotent stem cells, multipotent progenitor cells and plant cells.

Stem cells are generally known for their three unique characteristics: (i) they have the unique ability to renew themselves continuously; (ii) they have the ability to differentiate into somatic cell types; and (iii) they have the ability to limit their own population into a small number. In mammals, there are two broad types of stem cells, namely embryonic stem cells (ESCs), and adult stem cells. Stem cells may be autologous or heterologous to the subject. In order to avoid rejection of the cells by the subject's immune system, autologous stem cells are usually preferred.

Thus, in some embodiments, the eukaryotic cells according to the invention may be embryonic stem cells, or human embryonic stem cells (hESCs), that were obtained from self-umbilical cord blood just after birth. Embryonic stem cells are pluripotent stern cells derived from the early embryo that are characterized by the ability to proliferate over prolonged periods of culture while remaining undifferentiated and maintaining a stable karyotype, with the potential to differentiate into derivatives of all three germ layers. hESCs may be also derived from the inner cell mass (ICM) of the blastocyst stage (100-200 cells) of embryos generated by in vitro fertilization. However, methods have been developed to derive hESCs from the late morula stage (30-40 cells) and, recently, from arrested embryos (16-24 cells incapable of further development) and single blastomeres isolated from 8-cell embryos.

In further embodiments, the eukaryotic cells according to the invention are totipotent stern cells. Totipotent stem cells are versatile stem cells, and have the potential to give rise to any and all human cells, such as brain, liver, blood or heart cells or to an entire functional organism (e.g. the cell resulting from a fertilized egg). The first few cell divisions in embryonic development produce more totipotent cells. Mier four days of embryonic cell division, the cells begin to specialize into pluripotent stem cells. Embryonic stem cells may also be referred to as totipotent stem cells.

In further embodiments, the eukaryotic cells according to the invention are pluripotent stem cells. Similar to totipotent stem cells, a pluripotent stem cell refer to a stem cell that has the potential to differentiate into any of the three germ layers: endoderm (interior stomach lining, gastrointestinal tract, the lungs), mesoderm (muscle, bone, blood, urogenital), or ectoderm (epidermal tissues and nervous system). Pluripotent stem cells can give rise to any fetal or adult cell type. However, unlike totipotent stem cells, they cannot give rise to an entire organism. On the fourth day of development, the embryo forms into two layers, an outer layer which will become the placenta, and an inner mass which will form the tissues of the developing human body. These inner cells are referred to as pluripotent cells.

In still further embodiments, the eukaryotic cells according to the invention are multipotent progenitor cells. Multipotent progenitor cells have the potential to give rise to a limited number of lineages. As a non-limiting example, a multipotent progenitor stem cell may be a hematopoietic cell, which is a blood stem cell that can develop into several types of blood cells, but cannot into other types of cells. Another example is the mesenchymal stem cell, which can differentiate into osteoblasts, chondrocytes, and adipocytes. Multipotent progenitor cells may be obtained by any method known to a person skilled in the art.

In yet further embodiments, the eukaryotic cells according to the invention are induced pluripotent stem cells. Induced pluripotent stem cells, commonly abbreviated as iPS cells are a type of pluripotent stem cell artificially derived from a non-pluripotent cell, typically an adult somatic cell, even a patient's own. Such cells can be induced to become pluripotent stem cells with apparently all the properties of hESCs. Induction requires only the delivery of four transcription factors found in embryos to reverse years of life as an adult cell back to an embryo-like cell. For example, iPS cells could be used for autologous transplantation in a patient with a rare disease. The mutation or mutations responsible for the patient's disease state could be corrected ex vivo in the iPS cells obtained from the patient as performed by the methods of the invention and the cells may be then implanted back into the patient (i.e. autologous transplantation).

In some further embodiments, cells suitable for the methods of the invention may be cells from a cell line e.g, cells from MCF7 cell lines or MCF7/Dx cell line, or 293T cell line and others.

In some embodiments, cells suitable for the methods of the invention may originate from a biological sample. Biological sample is any sample obtained from the subject that comprise at least one cell or any fraction thereof. In some specific embodiments, sample applicable in the methods of the invention may include bone marrow, lymph fluid, blood cells, blood, serum, plasma, semen, spinal fluid or CSF, the external secretions of the skin, respiratory, intestinal, and genitourinary tracts, any sample obtained from any organ or tissue, any sample obtained by lavage, optionally of the breast ductal system, or of the uterus, plural effusion, samples of in vitro or ex vivo cell culture and cell culture constituents.

In some specific embodiments, the biological sample may result from a biopsy. A biopsy is a medical test commonly performed by a surgeon. The process involves extraction of sample cells or tissues from the patient. The tissue obtained is generally examined under a microscope by a pathologist for initial assessment and may also be analyzed for cell phenotype as discussed by the present disclosure. When an entire lump or suspicious area is removed, the procedure is called an excisional biopsy. An incisional biopsy or core biopsy samples a portion of the abnormal tissue without attempting to remove the entire lesion or tumor. When a sample of tissue or fluid is removed with a needle in such a way that cells are removed without preserving the histological architecture of the tissue cells, the procedure is called a needle aspiration biopsy. Still further, the sample/s may be obtained from the described tissues ectomized from a patient (e.g., in case of therapeutic ectomy).

In certain embodiments, the cells used in the screening method of the present disclosure are cells of a subject suffering from a pathologic disorder.

In some further embodiments, the cells used in the screening method are of a subject suffering from pathologic disorder that may be any one of a malignant proliferative disorder, an inflammatory condition a metabolic condition, an infectious disease, an autoimmune disease, protein misfolding disorder or deposition disorder.

In more specific embodiments, the pathologic disorder is a malignant proliferative disorder. In yet some further particular embodiments, the cells are primary cancer cells of the diseased subject. In some embodiments, the cells may be a mixture of different primary cells.

Still further, in some embodiments, the malignant proliferative disorder is any one of carcinoma, melanoma, lymphoma, leukemia, myeloma and sarcoma.

In other embodiments, the cells suitable for the methods of the invention originate from diseased subject with further malignancies that may comprise but are not limited to hematological malignancies (including lymphoma, leukemia, myeloproliferative disorders, Acute lymphoblastic leukemia; Acute myeloid leukemia), hypoplastic and aplastic anemia (both virally induced and idiopathic), myelodysplastic syndromes, all types of paraneoplastic syndromes (both immune mediated and idiopathic) and solid tumors (including GI tract, colon, lung, liver, breast, prostate, pancreas and Kaposi's sarcoma, The invention may be applicable as well for the treatment or inhibition of solid tumors such as tumors in lip and oral cavity, pharynx, larynx, paranasal sinuses, major salivary glands, thyroid gland, esophagus, stomach, small intestine, colon, colorectum, anal canal, liver, gallbladder, extraliepatic bile ducts, ampulla of vater, exocrine pancreas, lung, pleural mesothelioma, bone, soft tissue sarcoma, carcinoma and malignant melanoma of the skin, breast, vulva, vagina, cervix uteri, corpus uteri, ovary, fallopian tube, gestational trophoblastic tumors, penis, prostate, testis, kidney, renal pelvis, ureter, urinary bladder, urethra, carcinoma of the eyelid, carcinoma of the conjunctiva, malignant melanoma of the conjunctiva, malignant melanoma of the uvea, retinoblastoma, carcinoma of the lacrimal gland, sarcoma of the orbit, brain, spinal cord, vascular system, hemangiosarcoma, Adrenocortical carcinoma; AIDS-related cancers; AIDS-related lymphoma; Anal cancer; Appendix cancer; Astrocytoma, childhood cerebellar or cerebral; Basal cell carcinoma; Bile duct cancer, extrahepatic; Bladder cancer; Bone cancer, Osteosarcoma/Malignant fibrous histiocytoma; Brainstem glioma; Brain tumor; Brain tumor, cerebellar astrocytoma; Brain tumor, cerebral astrocytoma/malignant glioma; Brain tumor, ependymoma; Brain tumor, medulloblastoma, Brain tumor, supratentorial primitive neuroectodermal tumors; Brain tumor, visual pathway and hypothalamic glioma; Breast cancer; Bronchial adenomas/carcinoids; Burkitt lymphoma; Carcinoid tumor, childhood; Carcinoid tumor, gastrointestinal; Carcinoma of unknown primary; Central nervous system lymphoma, primary; Cerebellar astrocytoma, childhood; Cerebral astrocytoma/Malignant glioma, childhood; Cervical cancer; Childhood cancers; Chronic lymphocytic leukemia; Chronic myelogenous leukemia; Chronic myeloproliferative disorders; Colon Cancer; Cutaneous T-cell lymphoma; Desmoplastic small round cell tumor; Endometrial cancer; Ependymoma; Esophageal cancer; Ewing's sarcoma in the Ewing family of tumors; Extracranial germ cell tumor, Childhood; Extragonadal Germ cell tumor; Extrahepatic bile duct cancer; Eye Cancer, Intraocular melanoma; Eye Cancer, Retinoblastoma; Gallbladder cancer; Gastric (Stomach) cancer; Gastrointestinal Carcinoid Tumor; Gastrointestinal stromal tumor (GIST); Germ cell tumor: extracranial, extragonadal, or ovarian; Gestational trophoblastic tumor; Glioblastoma; Glioma of the brain stem; Glioma, Childhood Cerebral Astrocytoma; Glioma, Childhood Visual Pathway and Hypothalamic; Gastric carcinoid; Hairy cell leukemia; Head and neck cancer; Heart cancer; Hepatocellular (liver) cancer; Hodgkin lymphoma; Hypopharyngeal cancer; Hypothalamic and visual pathway glioma, childhood; Intraocular Melanoma; Islet Cell Carcinoma (Endocrine Pancreas); Kaposi sarcoma; Kidney cancer (renal cell cancer); Laryngeal Cancer; Leukemias; Leukemia, acute lymphoblastic (also called acute lymphocytic leukemia); Leukemia, acute myeloid (also called acute myelogenous leukemia); Leukemia, chronic lymphocytic (also called chronic lymphocytic leukemia); Leukemia, chronic myelogenous (also called chronic myeloid leukemia); Leukemia, hairy cell; Lip and Oral Cavity Cancer; Liver Cancer (Primary); Lung Cancer, Non-Small Cell Lung Cancer, Small Cell; Lymphomas; Lymphoma, AIDS-related; Lymphoma, Burkitt; Lymphoma, cutaneous T-Cell; Lymphoma, Hodgkin; Lymphomas, Non-Hodgkin (an old classification of all lymphomas except Hodgkin's); Lymphoma, Primary. Central Nervous System; Marcus Whittle, Deadly Disease; Macroglobulinemia, Waldenstrom; Malignant Fibrous Histiocytoma of Bone/Osteosarcoma; Medulloblastoma, Childhood; Melanoma; Melanoma, Intraocular (Eye); Merkel Cell Carcinoma; Mesothelioma, Adult Malignant; Mesothelioma, Childhood; Metastatic Squamous Neck Cancer with Occult Pdmary; Mouth Cancer; Multiple Endocrine Neoplasia Syndrome, Childhood; Multiple Myeloma/Plasma Cell Neoplasm; Mycosis Fungoides; Myelodysplastic Syndromes; Myelodysplastic/Myeloproliferative Diseases; Myelogenous Leukemia, Chronic; Myeloid Leukemia, Adult Acute; Myeloid Leukemia, Childhood Acute; Myeloma, Multiple (Cancer of the Bone-Marrow); Myeloproliferative Disorders, Chronic; Nasal cavity and paranasal sinus cancer; Nasopharyngeal carcinoma; Neuroblastoma; Non-Hodgkin lymphoma; Non-small cell lung cancer; Oral Cancer; Oropharyngeal cancer; Osteosarcoma/malignant fibrous histiocytoma of bone; Ovarian cancer; Ovarian epithelial cancer (Surface epithelial-stromal tumor); Ovarian germ cell tumor; Ovarian low malignant potential tumor; Pancreatic cancer; Pancreatic cancer, islet cell; Paranasal sinus and nasal cavity cancer; Parathyroid cancer; Penile cancer; Pharyngeal cancer; Pheochromocytoma; Pineal astrocytoma; Pineal germinoma; Pineoblastoma and supratentorial primitive neuroectodermal tumors, childhood; Pituitary adenoma; Plasma cell neoplasia/Multiple myeloma; Pleuropulmonary blastoma; Primary central nervous system lymphoma; Prostate cancer; Rectal cancer; Renal cell carcinoma (kidney cancer); Renal pelvis and ureter, transitional cell cancer; Retinoblastoma; Rhabdomyosarcoma, childhood; Salivary gland cancer; Sarcoma, Ewing family of tumors; Sarcoma, Kaposi; Sarcoma, soft tissue; Sarcoma, uterine; Sezary syndrome; Skin cancer (nonmelanoma); Skin cancer (melanoma); Skin carcinoma; Merkel cell; Small cell lung cancer; Small intestine cancer; Soil tissue sarcoma; Squamous cell carcinoma—see Skin cancer (nonmelanoma); Squamous neck cancer with occult primary, metastatic; Stomach cancer; Supratentorial primitive neuroectodermal tumor, childhood; T-Cell lymphoma, cutaneous (Mycosis Fungoides and Sezary syndrome); Testicular cancer; Throat cancer; Thymoma, childhood; Thymoma and Thymic carcinoma; Thyroid cancer; Thyroid cancer, childhood; Transitional cell cancer of the renal pelvis and ureter; Trophoblastic tumor, gestational; Unknown primary site, carcinoma of, adult; Unknown primary site, cancer of, childhood; Ureter and renal pelvis, transitional cell cancer; Urethral cancer; Uterine cancer, endometrial; Uterine sarcoma; Vaginal cancer; Visual pathway and hypothalamic glioma, childhood; Vulvar cancer; Waldenstrom macroglobulinemia and Wilms tumor (kidney cancer).

In some specific embodiments, the cells suitable for the methods of the invention originate from diseased subject with non-small cell lung cancer. In some other embodiments the cells suitable for the methods of the invention originate from diseased. subject with glioblastoma.

In some embodiments, the cell phenotype may be determined according to th invention using different types of labelling methods, specifically by marker labeling.

Labels generally provide signals detectable by fluorescence, chemiluminescence, radioactivity, colorimetry, mass spectrometry, X-ray diffraction or absorption, magnetism, enzymatic activity, or the like. Examples of labels include haptens, enzymes, enzyme substrates, coenzymes, enzyme inhibitors, fluorophores, quenchers, chromophores, magnetic particles or beads, redox sensitive moieties (e.g., electrochemically active moieties), luminescent markers, radioisotopes (including radionucleotides), and members of binding pairs.

More specific examples include fluorescein, phycobiliprotein, tetraethyl rhodamine, and beta-galactosidase. Binding pairs may include biotin/Strepavidin, biotin/avidin, biotin/neutravidin, biotin/captavidin, GST/glutathione, maltose binding protein/maltose, calmodulin binding protein/calm odulin, enzyme-enzyme substrate, receptor-ligand binding pairs, and analogs and mutants of the binding pairs.

Thus in some embodiments, specific markers of the cells may be labeled or tagged. in some embodiments, the term “labeled” or “tagged” may refer to direct labeling of a protein via, e.g., coupling (i.e., physically linking) or incorporating of a detectable substance, or a “separation substance”, to the protein. Useful labels in the present invention may include but are not limited to include isotopes (e.g. 13C, 15N), or any other radiolabels (e.g., 3H, 125I, 35S, 14C, or 32P), magnetic beads (e.g. DYNABEADS), fluorescent dyes (e.g., fluorescein isothiocyanate, Texas red, rhodamine, green fluorescent protein, and the like), enzymes (e.g., horseradish peroxidase, alkaline phosphatase and colorimetric labels such as colloidal gold or colored glass or plastic (e.g. polystyrene, polypropylene, latex, etc.) beads.

Furthermore, the cell phenotype may be determined by tagging of specific proteins, such as surface receptors with antibodies.

More specifically, methods applicable in the present invention for determining the cell phenotype may include but are not limited to Live cell imaging, Immunofluorescence microscopy, Plasmon-enhanced fluorescence, Raman spectroscopy or Surface-enhanced Raman spectroscopy (SERS).

Immunofluorescence microscopy enables visualization of the phenotype of the cells. In some embodiments, cells are incubated with relevant first and secondary antibodies. The cells are then visualized using a confocal microscope (such as for example Zeiss LSM 700).

Live cell imaging of the cell phenotype consists in tagging the living cells with a fluorescent probe, thereby allowing in vivo detection via confocal fluorescence microscopy. For example, the cells may be tagged with any tag such as GFP, e.g. the β4, Rpn2, Rpn6.

Plasmon-enhanced fluorescence (PEF) that is also referred to as metal-enhanced fluorescence (MEF) represents an attractive method for shortening detection times and increasing sensitivity of various fluorescence-based analytical technologies. In PEF, fluorophore labels are coupled with the tightly confined field of surface plasmons—collective oscillation of charge density and associated electromagnetic field on a surface of metallic films and nanostructures. This interaction can be engineered to dramatically enhance emitted fluorescence light intensity which is desired for detecting minute amounts of analytes with improved limit of detection and shorten analysis time.

Raman spectroscopy is a spectroscopic technique that relies upon inelastic scattering of photons, known as Raman scattering. A source of monochromatic light, usually from a laser in the visible, near infrared, or near ultraviolet range is used, although X-rays can also be used. The laser light interacts with molecular vibrations, phonons or other excitations in the system, resulting in the energy of the laser photons being shifted up or down. The shift in energy gives information about the vibrational modes in the system. Infrared spectroscopy typically yields similar yet complementary information.

Surface-enhanced Raman spectroscopy (SERS) is a surface-sensitive technique that enhances Raman scattering by molecules adsorbed on rough metal surfaces or by nanostructures such as plasmonic-magnetic silica nanotubes. The enhancement factor can be as much as 10¹⁰ to 10¹¹, which means the technique may detect single molecules.

In yet another embodiment, the cell phenotype may be determined by examining different metabolites of the cells, e.g. by examining metabolite aggregation or by performing metabolic profiling.

In yet some further embodiments, metabolite aggregation may be measured using at least one of Dye-binding specificity (for example, using thioflavin T (ThT) and congo red, or staining with Proteostat) microscopy, circular dichroism (CD) spectrometry, vibrational CD, Raman Spectroscopy, density functional theory (DFT) quantum mechanics methods, Fourier-transformed infrared spectroscopy dynamic light scattering (DLS), liquid chromatography and NMR. Microscopy, such as TEM (transmission electron microscope), confocal fluorescence microscopy, confocal Raman microscopy, indirect immunofluorescence.

More specifically, Transmission electron microscopy (TEM, also sometimes conventional transmission electron microscopy or CTEM) is a microscopy technique in which a beam of electrons is transmitted through a specimen to form an image. The specimen is most often an ultrathin section less than 100 nm thick or a suspension on a grid. An image is formed from the interaction of the electrons with the sample as the beam is transmitted through the specimen. The image is then magnified and focused onto an imaging device, such as a fluorescent screen, a layer of photographic film, or a sensor such as a charge-coupled device. Transmission electron microscopes are capable of imaging at a significantly higher resolution than light microscopes, owing to the smaller de Broglie wavelength of electrons. This enables the instrument to capture fine detail, as small as a single column of atoms, which is thousands of times smaller than a resolvable object seen in a light microscope.

A scanning electron microscope (SEM) is a type of electron microscope that produces images of a sample by scanning the surface with a focused beam of electrons. The electrons interact with atoms in the sample, producing various signals that contain information about the surface topography and composition of the sample. The electron beam is scanned in a raster scan pattern, and the position of the beam is combined with the detected signal to produce an image. SEM can achieve resolution better than 1 nanometer.

Circular dichroism (CD) is dichroism involving circularly polarized light, i.e., the differential absorption of left- and right-handed light. Left-hand circular (LHC) and right-hand circular (RHC) polarized light represent two possible spin angular momentum states for a photon, and so circular dichroism is also referred to as dichroism for spin angular momentum. it is exhibited in the absorption bands of optically active chiral molecules. CD spectroscopy has a wide range of applications in many different fields. Most notably, UV CD is used to investigate the secondary structure of proteins.

Density functional theory (DFT) is a computational quantum mechanical modelling method used in physics, chemistry and materials science to investigate the electronic structure (principally the ground state) of many-body systems, in particular atoms, molecules, and the condensed phases. Using this theory, the properties of a many-electron system can be determined by using functionals, i.e. functions of another function, which in this case is the spatially dependent electron density. DFT is among the most popular and versatile methods available in condensed-matter physics, computational physics, and computational chemistry.

Dynamic light scattering (DLS) is a technique used to determine the size distribution profile of small particles in suspension or polymers in solution. In the scope of DLS, temporal fluctuations are usually analyzed by means of the intensity or photon auto-correlation function (also known as photon correlation spectroscopy or quasi-elastic light scattering). In the time domain analysis, the autocorrelation function (ACF) usually decays starting from zero delay time, and faster dynamics due to smaller particles lead to faster decorrelation of scattered intensity trace.

Ion-mobility spectrometry-mass spectrometry (IMS-MS), also known as ion-mobility separation-mass spectrometry, is an analytical chemistry method that separates gas phase ions on a millisecond timescale using ion-mobility spectrometry and uses mass spectrometry on a microsecond timescale to identify components in a sample. It should be noted that this method may be used for evaluating and measuring the levels of the metabolite and thereby for determining metabolite accumulation.

Metabolic profiling or metabonomics or metabolomics is a study of chemical processes that are associated to and involve metabolites. It is a study of chemical fingerprints that are very unique and that any specific physiological processes in a cell always leave behind. Metabolic profiling can also be defined as the use of analytical methods in measurement and interpretation of various endogenous low molecular weight and. intermediates from their samples. This study makes use of metabolome and it provides a critical view of the physiological characteristic of a cell, tissue or the whole organism as compared to proteomic analysis and mRNA analysis.

In some embodiments, the screening method of the present disclosure involves determination of cell viability. In yet some further embodiments, the cell viability can be determined by using at least one cell-impermeant DNA-binding dyes (propidium iodide (PI, measuring dead cells), nuclear staining (Hoechst 33342) and XTT.

In another embodiments, living cells may also be stained with Calcein-AM.

More specifically, in some embodiments, Cell viability is a measure of the proportion of live, healthy cells within a population. As used herein, a cell viability assay refers to is an assay for determining the ability of cells to maintain or recover a state of survival.

In some specific embodiments, cell viability may be determined using Propidium iodide, which dyes the nuclei of dead cells (magenta).

In some embodiments, assays for cell viability applicable in the present disclosure include but are not limited to fluorescent resazurin assay, MTT (tetrazolium dye MTT 3-(4,5-dimethylthiazol-2-yl)-2,5-diphenyltetrazolium bromide) assay, MTS (3-(4,5-dimethylthiazol-2-yl)-5-(3-carboxymethoxyphenyl)-2-(4-sulfophenyl)-2H-tetrazolium) assay, WST (water-soluble tetrazolium salts) assay, ATP uptake assay and glucose uptake assay.

In some further embodiments, cell viability may be further determined by 2,3-bis-(2-methhoxy-4-nitro-5-sulphophenyl)-2H-tetrazolium-5-carboxanilide (XTT) viability assay, PrestoBlue viability reagent, the fluorescent intercalator 7-aminoactinomycin D (7-AAD), LIVE/DEAD Viability Kits, cell growth by turbidity, for example at OD600, or by any means for cell counting.

In yet some further embodiments, cell viability may be determined by evaluating cell toxicity e.g. by measuring apoptosis of the cells. In some embodiments, apoptosis may be determined by at least one of DNA fragmentation (TUNNEL, terminal deoxynucleotidyl transferase dUTP nick end labeling), caspase and/or PARP1 phosphorylation, annexin V and propidium iodide (PI) assay.

It should be noted that in some embodiments, other toxic phenotype that may be determined on the organism/cell may include, activation of cell stress pathways (e.g., heat shock response), poor fertility, destruction of organs and tissue damages, DNA mutagenesis, ER stress, cell energy status and ATP content, oxidative stress, mitochondrial dysfunction, mitochondrial damage, activation of autophagy and activation of necrosis.

In some further embodiments, the candidate active agent screened in the methods disclosed herein may be at least one of a chemotherapeutic agent, a biological therapy agent, an immuno therapeutic agent, an hormonal therapy gent or any combination thereof.

In some specific and non-limiting embodiments, the candidate active agent is at least one of Alectinib, Crizotinib, doxorubicin, docetaxel, paclitaxel, methotrexate, and any combinations thereof.

Thus, in some specific embodiments, the present disclosure provides screening methods that are particularly useful in screening for an anti-cancerous drug. In some particular embodiments, the method may comprise the following steps:

First in step (a), exposing cancer cells grown in at least one cell chamber of a microfluidic test platform, to at least one candidate active compound accommodated in at least one respective drug chamber of the test platform. The second step (b), involves determining for the exposed cells of step (a), cell viability, for at least one time interval. The third step (c) involves determining that the candidate drug is an ani-cancerous drug if cell viability is reduced as compared with the cell viability in the absence of the candidate active agent. In some embodiments, the microfluidic test platform applied herein is as defined by the present disclosure.

A further aspect of the present disclosure provides a prognostic method for predicting/determining and assessing responsiveness of a subject suffering from a pathologic disorder to a treatment regimen comprising at least one therapeutic active agent. In some embodiments, the prognostic method disclosed herein may further optionally provides means for monitoring disease progression. In more specific embodiments, the prognostic methods disclosed herein may comprise the following steps: In the first step (a), exposing cells of the subject grown in at least one cell chamber of at least one reaction unit of a microfluidic test platform, to the therapeutic active agent accommodated in at least one respective active-agent chamber of at least one reaction unit of the test platform provided by the present disclosure. The next step (b) involves determining for the exposed cells of (a), cell viability and/or at least one cell phenotype, for at least one time interval.

The next step (c), involves classifying the subject as:

The subject may be classified as (i), a responsive subject to the treatment regimen, if at least one of, cell viability and/or at least one cell phenotype is modulated as compared with at least one of the cell viability and/or at least one cell phenotype in the absence of the therapeutic active agent.

Alternatively, the subject may be classified as (ii), a drug-resistant subject if at least one cell viability and/or at least one cell phenotype is not modulated as compared with at least one of the cell viability and/or at least one cell phenotype, in the absence of the active agent.

The disclosed method thereby provides predicting, assessing and monitoring responsiveness of a mammalian subject to the treatment regimen. In some embodiments, the microfluidic test platform used in the prognostic methods is as defined by the invention. More specifically, the microfluidic test platform used herein comprises a block of substrate material defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; while the reaction units are provided with desired active agents in situ during manufacture of the microfluidic test platform.

In some embodiments, the microfluidic test platform used in the prognostic method disclosed herein comprising a block defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; wherein the reaction units are provided with desired said active agents in situ during manufacture of the microfluidic test platform. In some embodiments of the prognostic methods disclosed herein, for monitoring disease progression, the methods may further comprise the following additional steps of:

Step (d), involves repeating steps (a) and (b), to determine at least one of, cell viability and/or at least one cell phenotype for at least one cell of at least one more temporally-separated sample of said subject. The next step (e), involves predicting and/or determining (secondary/developed) drug-resistance and/or reduction in drug effectiveness in the subject, if at least one cell of the at least one temporally separated. sample, displays loss of the modulatory effect of the therapeutic active compound on at least one of, cell viability and/or at least one cell phenotype.

In some embodiments, for monitoring purpose, at least one more temporally-separated sample is obtained after the initiation of at least one treatment regimen comprising the therapeutic active agent.

The invention provides prognostic methods for assessing responsiveness of a subject for a specific treatment regimen, for monitoring a disease progression and for predicting relapse of the disease in a subject. It should be noted that “Prognosis”, is defined as a forecast of the future course of a disease or disorder, based on medical knowledge. This highlights the major advantage of the invention, namely, the ability to assess responsiveness or drug-resistance and thereby predict progression of the disease, based on the cell phenotype of the prognosed subject.

The term “response” or “responsiveness” to a certain treatment, specifically, treatment regimen that comprise at least one active agent, refers to an improvement in at least one relevant clinical parameter as compared to an untreated subject diagnosed with the same pathology (e.g., the same type, stage, degree and/or classification of the pathology), or as compared to the clinical parameters of the same subject prior to treatment with said medicament.

The term “non responder” or “drug resistance” to treatment with a specific medicament, specifically, treatment regimen that comprise at least one candidate active agent, refers to a patient not experiencing an improvement in at least one of the clinical parameter and is diagnosed with the same condition as an untreated subject diagnosed with the same pathology (e.g., the same type, stage, degree and/or classification of the pathology), or experiencing the clinical parameters of the same subject prior to treatment with the specific medicament.

In some embodiments, the methods of the invention may be particularly useful for monitoring disease progression. In some embodiments, monitoring disease progression by the methods of the invention may comprise at least one of predicting and determining disease relapse, and assessing a remission interval. The term “relapse”, as used herein, relates to the re-occurrence of a condition, disease or disorder that affected a person in the past. Specifically, the term relates to the re-occurrence of a disease being treated with an active agent.

In some embodiments, the at least one more temporally-separated sample may be obtained after the initiation of at least one treatment regimen comprising at least one active agent.

It should be understood that in some particular embodiments, at least one sample may be obtained prior to initiation of the treatment. However, in some embodiments, the methods disclosed herein may be applied to subjects already treated by a treatment regimen comprising at least one therapeutic active agent. Such monitoring may therefore provide a powerful therapeutic tool used for improving and personalizing the treatment regimen offered to the treated subject.

As indicated above, in accordance with some embodiments of the invention, in order to assess the patient condition, or monitor the disease progression, as well as responsiveness to a certain treatment, at least two “temporally-separated” test samples must be collected from the examined patient and compared thereafter, in order to determine if there is any change or difference in the values between the samples. Such change may reflect a change in the responsiveness of the subject. In practice, to detect a change having more accurate predictive value, at least two “temporally-separated” test samples and preferably more, must be collected from the patient.

The cellular phenotype value is determined using the method disclosed herein, applied for each sample. As detailed above, the change in cellular phenotype is calculated by determining the change in cellular phenotype between at least two samples obtained from the same patient in different time-points or time intervals. This period of time, also referred to as “time interval”, or the difference between time points (wherein each time point is the time when a specific sample was collected) may be any period deemed appropriate by medical staff and modified as needed according to the specific requirements of the patient and the clinical state he or she may be in. For example, this interval may be at least one day, at least three days, at least one week, at least two weeks, at least three weeks, at least one month, at least two months, at least three months, at least four months, at least five months, at least six months, at least one year, or even more.

The number of samples collected and used for evaluation and classification of the subject either as a responder or alternatively, as a drug resistant or as a subject that may experience relapse of the disease, may change according to the frequency with which they are collected. For example, the samples may be collected at least every day, every two days, every four days, every week, every two weeks, every three weeks, every month, every two months, every three months every four months. every 5 months, every 6 months, every 7 months, every 8 months, every 9 months, every 10 months, every 11 months, every year or even more. Furthermore, to assess the disease progression according to the present disclosure, it is understood that the change in cellular phenotype value, may be calculated as an average change over at least three samples taken in different time points, or the change may be calculated for every two samples collected at adjacent time points. It should be appreciated that the sample may be obtained from the monitored patient in the indicated time intervals for a period of several months or several years. More specifically, for a period of 1 year, for a period of 2 years, for a period of 3 years, for a period of 4 years, for a period of 5 years, for a period of 6 years, for a period of 7 years, for a period of 8 years, for a period of 9 years, for a period of 10 years, for a period of 11 years, for a period of 12 years, for a period of 13 years, for a period of 14 years, for a period of 15 years or more.

As described hereinabove, the methods of the invention refer to determining the modulation of cell viability and/or at least one cell phenotype. In some further embodiments, the modulation of cell viability and/or at least one cell phenotype may be determined as a numeric value, thereby enabling assessment of a cut-off value.

Still further, an equivalent cellular phenotype in the presence or absence of a therapeutic active agent reflects non-responsiveness, or drug resistance. For example, in the case of assessing cell viability, an equal proportion of living cells versus dead cells (namely, 50% or more) indicates non-responsiveness. As such, a value of about 40% to 60%, specifically, 40%, 45%, 50%, 55%, 60% may be used as a cutoff value. In yet some further embodiments, a value of about 50% of the proportion of living cells versus dead cells may be considered as a cutoff value.

It should be noted that a “cutoff value”, sometimes referred to simply as “cutoff” herein, is a value that in some embodiments of the present disclosure, meets the requirements for both high prognostic sensitivity (true positive rate) and high prognostic specificity (true negative rate). Simply put, “sensitivity” relates to the rate of identification of the responder patients (samples) as such, out of a group of samples, whereas “specificity” relates to the rate of correct identification of responder samples as such, out of a group of samples. It should be noted that cutoff values may be also provided as control sample/s or alternatively and/or additionally, as standard curves that display predetermined standard values for responders, non-responders, and for subjects that display responsiveness to a certain extent (level of responsiveness, e.g., low, moderate and high). More specifically, the cutoff values reflect the result of a statistical analysis of cell phenotype value/s differences in pre-established populations of responder or non-responder. Pre-established populations as used herein refer to population of patients known to be responsive to a treatment of interest, or alternatively, population of patients known to be non-responsive or drug-resistant to a treatment of interest.

It should be emphasized that the nature of the invention is such that the accumulation of further patient data may improve the accuracy of the presently provided cutoff values, which are usually based on an ROC (Receiver Operating Characteristic) curves generated according to the patient data using analytical software program.

It should be appreciated that “Standard” or a “predetermined standard” as used herein, denotes either a single standard value or a plurality of standards with which the value determined for the tested sample is compared. The standards may be provided, for example, in the form of discrete numeric values or in the form of a chart for different values, or alternatively, in the form of a comparative curve prepared on the basis of such standards (standard curve).

Thus, in certain embodiments, the prognostic methods of the present disclosure may optionally further involve the use of a calibration curve created by detecting and quantitating the cellular phenotype in cells of known populations of responders and non-responders to the indicated treatment. Obtaining such a calibration curve may be indicative to provide standard values.

As noted above, in some embodiments of the present disclosure, at least one control sample may be provided and/or used by the methods discussed herein. A “control sample” as used herein, may reflect a sample of at least one subject (a subject that is known to he a non-responder, or alternatively, known to be a responder, or sample displaying known cell phenotype at a certain predetermined degree), and preferably, a mixture at least two, at least three, at least four, at least five, at least six, at least seven, at least eight, at least nine, at least ten or more patients, specifically, 15, 20, 25, 30, 35, 40, 45, 50, 55, 60, 65, 70, 75, 80, 85, 90, 95, 100 or more patients. A control sample may alternatively, or additionally comprise known cellular phenotype that can be used as a reference.

In some embodiments, the candidate active agent used in the prognostic methods discussed herein, is placed prior to exposure to said cells, in a predetermined amount, within the respective active-agent chamber of the microfluidic test platform.

In some embodiments, the prognostic methods disclosed herein may be useful for any therapeutic active agent. Such therapeutic agents may be for example, at least one of: an inorganic Or organic molecule, a small molecule, a nucleic acid-based molecule, an aptamer, a polypeptide, or any combinations thereof.

In yet some embodiments of the prognostic methods of the present disclosure, the cells form aggregates/clusters in the cell chamber, prior to exposure to the therapeutic active agent. In yet some further embodiments, as shown in the present examples, such cluster formation provides a more accurate information with respect to the responsiveness of the cells to the examined cells.

In some embodiments, the cells used the prognostic methods are cells of a subject suffering from a pathologic disorder.

In yet some further embodiments, the prognosed subject is suffering of a pathologic disorder, that may be in some embodiments, any one of a malignant proliferative disorder, an inflammatory condition a metabolic condition, an infectious disease, an autoimmune disease, protein misfol ding disorder or deposition disorder.

In more particular embodiments, such pathologic disorder may be a malignant proliferative disorder. Thus, according to some further embodiments, the cells used in the prognostic method, are primary cancer cells of the subject. in some embodiments, the cells may be a mixture of different primary cells.

In more specific embodiments, the disclosed method is applicable for malignant proliferative disorder that may be any one of carcinoma, melanoma, lymphoma, leukemia, myeloma and sarcoma.

In yet some further embodiments, the prognostic methods disclosed herein, involve the step of determining cell viability. In some embodiments, the cell viability is determined by using at least one cell-impermeant DNA-binding dyes (propidium iodide (PI, measuring dead cells), nuclear staining (Hoechst 33342) and XTT).

Still further, the methods disclosed herein provide prognostic information with respect to responsiveness of a subject to therapeutic active agent, that may be at least one of a chemotherapeutic agent, a biological therapy agent, an immuno therapeutic agent, an hormonal therapy gent or any combination thereof.

In some embodiments, the therapeutic or candidate active agent of the invention may be a chemotherapeutic agent.

“Chemotherapeutic agent” or “chemotherapeutic drug” (also termed chemotherapy) as used herein refers to a drug treatment intended for eliminating or destructing (killing) cancer cells or cells of any other proliferative disorder. The mechanism underlying the activity of some chemotherapeutic drugs is based on destructing rapidly dividing cells, as many cancer cells grow and multiply more rapidly than normal cells. As a result of their mode of activity, chemotherapeutic agents also harm cells that rapidly divide under normal circumstances, for example bone marrow cells, digestive tract cells, and hair follicles. Insulting or damaging normal cells result in the common side-effects of chemotherapy: myelosuppression (decreased production of blood cells, hence also immuno-suppression), mucositis (inflammation of the lining of the digestive tract), and alopecia (hair loss).

Various different types of chemotherapeutic drugs are available. A chemotherapeutic drug may be used alone or in combination with another chemotherapeutic drug or with other forms of cancer therapy, such as a biological drug, radiation therapy or surgery.

Certain chemotherapy agents have also been used in the treatment of conditions other than cancer, including ankylosing spondylitis, multiple sclerosis, hemangiomas, Crohn's disease, psoriasis, psoriatic arthritis, rheumatoid arthritis, lupus and scleroderma.

Chemotherapeutic drugs affect cell division or DNA synthesis and function and can be generally classified into groups, based on their structure or biological function. The present invention generally pertains to chemotherapeutic agents that are classified as alkylating agents, anti-metabolites, anthracyclines, plant alkaloids, topoisomerase inhibitors, and other anti-tumor agents such as DNA-alkylating agents, anti-tumor antibiotic agents, tubulin stabilizing agents, tubulin destabilizing agents, hormone antagonist agents, protein kinase inhibitors, HMG-CoA inhibitors, CDK inhibitors, cyclin inhibitors, caspase inhibitors, metalloproteinase inhibitors, antisense nucleic acids, triple-helix DNAs, nucleic acids aptamers, and molecularly-modified viral, bacterial or exotoxic agents.

However, several chemotherapeutic drugs may be classified as relating to more than a single group. It is noteworthy that some agents, including monoclonal antibodies and tyrosine kinase inhibitors, which are sometimes referred to as “chemotherapy”, do not directly interfere with DNA synthesis or cell division but rather function by targeting specific components that differ between cancer cells and normal cells and are generally referred to as “targeted therapies”, “biological therapy” or “immunotherapeutic agent” as detailed below. Thus in some embodiments, the therapeutic or candidate active agent of the invention may refer to targeted therapy, biological therapy or “immunotherapeutic agent.

More specifically, as their name implies, alkylating agents function by alkylating many nucleophilic functional groups under conditions present in cells. Examples of chemotherapeutic agents that are considered as alkylating agents are cisplatin and carboplatin, as well as oxaliplatin. Alkylating agents impair cell function by forming covalent bonds with amino, carboxyl, sulhydryl, and phosphate groups in various biologically-significant molecules. Examples of agents which function by chemically modifying DNA are mechlorethamine, cyclophosphamide, chlorambucil and ifosfamide. An additional agent acting as a cell cycle non-specific alkylating antineoplastic agent is the alkyl sulfonate agent busulfan (also known as Busulfex).

Still further, Anthracyclines (or anthracycline antibiotics) are a class of drugs used in cancer chemotherapy that are derived from the streptomyces bacterium. These compounds are used to treat many cancers, including leukemias, lymphomas, breast, uterine, ovarian, and lung cancers. These agents include, inter alia, the drugs daunorubicin (also known as Daunomycin), and doxorubicin and many other related agents (e.g., Valrubicin and Idarubicin). For example, the anthracycline agent Idarubicin acts by interfering with the enzyme topoisomerase II.

In some embodiments, the therapeutic or candidate active agent of the invention may be a biological therapy agent. it should be noted that the term “biological therapy agent” or “biological treatment” or “biological agent” or “biological drug”, as used herein refers to any biological material that affects different cellular pathways. Such agent may include antibodies, for example, antibodies directed to cell surface receptors participating in signaling, that may either activate or inhibit the target receptor. Such biological agent may also include any soluble receptor, cytokine, peptides or ligands.

Still further, the term “biological drug” refers to drugs consisting of or comprising biological molecules or material, i.e. both, proteins, polypeptides, peptides, polynucleotides, oligonucleotides, polysaccharides, oligosaccharides and fragments thereof, as well as cells, tissues, biological fluids or extracts thereof, and which induce antibodies in a subject. In some embodiments, biological drugs may include proteins such as monoclonal antibodies, cytokines, soluble receptors, growth factors, hormones, enzymes, adhesion molecules and fusion proteins and peptides that are specific to certain targets known to modulate disease mechanisms. In yet some further embodiments, biological drugs may include or target any component participating in molecular and/or cellular processes such as, cell cycle, cell survival, apoptosis, immunity and the like. In more specific embodiments, biological drugs may be any checkpoint protein/s or any modulators or inhibitors thereof, or any combinations thereof. In yet some further embodiments, biological drugs (or their precursors or components) may be isolated from living sources human, animal, plant, fungal, or microbial.

Still further in some embodiments, “biological drug” or “biologics” refers to a class of therapeutics that are produced by means of biological processes involving recombinant DNA technology which are usually one of three types: (a) substances that are similar to the natural occurring proteins: (b) monoclonal antibodies; and (c) receptor constructs or fusion proteins, usually based on a naturally occurring receptor linked to the immunoglobulin frame. Major kinds of biologics include but are not limited to: Blood factors (such as Factor VIII and Factor IX), Thrombolytic agents (such as tissue plasminogen activator), Hormones (such as insulin, glucagon, growth hormone, gonadotrophins), Haematopoietic growth factors (such as Erythropoietin, colony stimulating factors), Interferons (such as Interferons-α, -β, -γ), Interleukin-based products (such as Interleukin-2), Vaccines (such as Hepatitis B surface antigen) and monoclonal antibodies. Non-limiting examples of biological drugs made with recombinant DNA technology may include at least one of: abatacept (Orencia®), that is a fusion protein composed of the Fc region of the immunoglobulin IgG1 fused to the extracellular domain of CTLA-4, used to treat autoimmune diseases like rheumatoid arthritis, by interfering with the immune activity of T cells; erythropoietin or Epoetin alfa (Epogen®), that is a human erythropoietin produced in cell culture using recombinant DNA technology, that stimulates erythropoiesis and is used to treat anemia, commonly associated with chronic renal failure and cancer chemotherapy; Muromonab-CD3 (Orthoclone OKT3®), that is a monoclonal antibody working as an immunosuppressant drug given to reduce acute rejection in patients with organ transplants. It binds to the T cell receptor-CD3-complex on the surface of circulating T cells thereby inducing blockage and apoptosis of the T cells; Abciximab (ReoPro®), that is a glycoprotein IIb/IIIa receptor antagonist mainly used during and after coronary artery procedures; Basiliximab (Simulect®), that is a chimeric CD25 monoclonal antibody of the IgG1 isotype, used as an immunosuppressant to prevent immediate transplant rejection; and Palivizumab (Synagis®), that is a humanized monoclonal antibody (IgG) directed against an epitope in the A antigenic site of the F protein of the respiratory syncytial virus (RSV).

Thus, in some embodiments, the therapeutic or candidate active agent of the invention may refer to antibody-mediated therapy. Antibody-mediated therapy as referred to herein refers to the use of antibodies that are specific to a cancer cell or to any protein derived there-from for the treatment of cancer. As a non-limiting example, such antibodies may be monoclonal or polyclonal which may be naked or conjugated to another molecule. Antibodies used for the treatment of cancer may be conjugated to a cytotoxic moiety or radioactive isotope, to selectively eliminate cancer cells. Non limiting examples for monoclonal antibodies that are used for the treatment of cancer include bevacizumab (also known as Avastin), rituximab (anti CD20 antibody), cetuximab (also known as Erbitux), anti-CTLA4 antibody and panitumumab (also known as Vectibix) and anti Gr1 antibodies as further detailed below.

Thus, further non-limiting examples for such antibody that may be used in the methods of the invention include at least one of infliximab, etanercept, adalimumab, certolizumab pegol, golimumab, any biosimilar thereof and any combinations of the same.

In more specific embodiments, therapeutic or candidate active agent of the invention may also refer to biosimilar as further detailed below such as Remsima/INFLECTRA® (infliximab-dyyb), SB4 etanercept, SB2 infliximab and SB5 adalimumab.

In more embodiments, therapeutic or candidate active agent of the invention may refer to a TNF inhibitor. TNF inhibitors are pharmaceutical drugs that suppresses the physiologic response to tumor necrosis factor (TNF), which is part of the inflammatory response. Inhibition of TNF effects can be achieved using a monoclonal antibody such as infliximab REMICASE®, etanercept, ENBREL®, adalimumab HUMIRA®, certolizumab pegol CIMZIA®, golimumab, SIMPONI®, and any biosimilars thereof, to name but a few, Remsima/INFLECTRA® (infliximab-dyyb), SB4 etanercept, SB2 infliximab and SB5 adalimumab. Thalidomide (immunoprin) and its derivatives lenalidomide (Revlimid) and pomalidomide (Pomalyst, Imnovid) are also active against TNF.

In some specific embodiments, the biological drug used by the methods of the invention may be infliximab. The term “infliximab” refers to the anti-TNF antibody marketed as REMICADE®, having FDA Unique Ingredient Identifier (UNII): B72HH48FLU and DRUG BANK Accession number DB00065. It is an Immunoglobulin G, (human-mouse monoclonal cA2 heavy chain), disulfide with human-mouse monoclonal cA2 light chain, dimer. More specifically, infliximab is used to treat immune-mediated diseases such as Crohn's disease, ulcerative colitis, psoriasis, psoriatic arthritis, ankylosing spondylitis, and rheumatoid arthritis as well as Behçet's disease and other conditions. Infliximab is administered by intravenous infusion, typically at six- to eight-week intervals, but cannot be given orally.

Infliximab is a purified, recombinant DNA-derived chimeric human-mouse IgG monoclonal antibody that consists of mouse heavy and light chain variable regions combined with human heavy and light chain constant regions. It has a serum half-life of 9.5 days and can be detected in serum 8 weeks after infusion treatment.

Infliximab neutralizes the biological activity of TNF-α by binding with high affinity to both the soluble and transmembranal forms of TNF-α thereby inhibiting the effective binding of TNF-α with its receptors.

Infliximab has high specificity for TNF-α, and does not neutralize TNF beta (TNFβ, also called lymphotoxin α), an unrelated cytokine that uses different receptors from TNF-α. Blocked actions of TNF-α further leads to downregulation of local and systemic pro-inflammatory cytokines (i.e. IL-1, IL-6), reduction of lymphocyte and leukocyte migration to sites of inflammation, induction of apoptosis of TNF-producing cells (i,e. activated monocytes and T lymphocytes), increased levels of nuclear factor-κB inhibitor, and reduction of reduction of endothelial adhesion molecules and acute phase proteins. Infliximab also attenuates the production of tissue degrading enzymes synthesized by synoviocytes and/or chondrocytes.

In yet some further specific embodiments, the biological drug used by the methods of the invention may be etanercept. The term “etanercept” refers to the anti-TNF antibody marketed as ENBREL®, having FDA Unique Ingredient Identifier (UNII): OP401G7OJC and DRUG BANK Accession number DB00005. Etanercept is a fusion protein produced by recombinant DNA. It fuses the INF receptor to the constant end of the IgG1 antibody as follows: residues 1-235-are of Tumor necrosis factor receptor (human) fusion protein with residues 236-467-immunoglobulin G1 (human γ1-chain Fc fragment). It is a large molecule, with a molecular weight of 150 kDa.

In still further specific embodiments, the biological drug used by the methods of the invention may be adalimumab. The terms “adalimumab” refers to the anti-TNF antibody marketed as HUMIRA®, having FDA Unique Ingredient Identifier (UNII): FYS6T7F842 and DRUG BANK. Accession number DB00051. It is an Immunoglobulin G1, (human monoclonal D2E7 heavy chain), disulfide with human monoclonal D2E7 light chain, dimer,

In yet some further specific embodiments, the biological drug used by the methods of the invention may be certolizumab pegol. The term “certolizumab pegol” refers to the anti-TNF antibody marketed as CIMZIA®, having FDA Unique Ingredient Identifier (UNII): UNID07X179E. It is a polyethylene-glycolated Fab′ fragment of TNF antibody that binds specifically to TNFα and neutralizes it in a dose-dependent manner.

In some further specific embodiments, the biological drug used by the methods of the invention may be golimumab. The term “golimumab” refers to the anti-TNF antibody marketed as SIMPONI®, having FDA Unique Ingredient identifier (UNII): 91X1KLU43E. It is an Immunoglobulin G1, (human monoclonal CNTO 148 gamma1-chain), disulfide with human monoclonal CNTO 148 kappa-chain, dimer. Its molecular weight is approximately 147 kDa.

In still further specific embodiments, the biological drug used by the methods of the invention may be Ustekinumab. The term “Ustekinumab” refers to a humanized monoclonal antibody that binds to IL-12 and IL-23 marketed as STELARA®, having FDA Unique Ingredient Identifier (UNII): FU77B4U5Z0. It is an Immunoglobulin G1, anti-(human interleukin 12 p40 subunit) (human monoclonal CNTO 1275 gamma1-chain), disulfide with human monoclonal CNTO 1275 kappa-chain, dimer.

In still further specific embodiments, the biological drug used by the methods of the invention may be Etrolizumab. The term “Etrolizumab” or “rhuMAb Beta7” refers to a humanized monoclonal antibody against the β7 subunit of integrins α4β7 and αEβ7, having FDA Unique Ingredient Identifier (UNII): I2A72G2V3J. It is an Immunoglobulin G1, anti-(human integrin alpha47/integrin alphaE7) (human-rat monoclonal rhuMAb Beta7 heavy chain), disulfide with human-rat monoclonal rhuMAb Beta7 light chain, dimer. It should be appreciated that in certain embodiment, any biosimilar of the above, specifically, any approved biosimilar, may be used by the methods of the invention as a target. In yet some further embodiments, the drug used by the methods of the invention may be Mirikizumab (LY3074828) that targets interleukin 23A and is in clinical use in treating inflammatory conditions such as Moderate-to-Severe Ulcerative Colitis. In yet some further embodiments the methods of the invention may use Risankizumab (ABBV-066) that is an anti-IL-23 antibody being clinically used for the treatment of multiple inflammatory diseases, including psoriasis, Crohn's disease and psoriatic arthritis.

Additional non-limiting examples of active agents suitable for the methods of the invention are further detailed below. More specifically, Axitinib (Inlyta®), a small molecule tyrosine kinase inhibitor, is used as a treatment option for kidney cancer. Revacizumab (Avastin®), is a recombinant humanized monoclonal antibody that blocks angiogenesis by inhibiting VEGF-A.Avastin is used in the treatment of colorectal, kidney, and lung cancers. Cabozantinib (Cometriq®), is a small molecule inhibitor of the tyrosine kinases c-Met and VEGFR2, and also inhibits AXL and RET. Cabozantinib is used in the treatment of medullary thyroid cancer and kidney cancer. Lenalidomide (CC-5013; IMiD3; Revlimid®), having the formula C₁₃H₁₃N₃O₃, is an analogue of thalidomide, a glutamic acid derivative with anti-angiogenic properties and potent anti-inflammatory effects owing to its anti-tumor necrosis factor (TNF)α activity, and is therefore classified as an Imunomodulatory drug (IMiD). Lenalidomide is used as a treatment option for multiple myeloma and mantle cell lymphoma, which is a type of non-Hodgkin lymphoma, Lenvatinib mesylate (Lenvima®), having the formula C₂₁H₁₉ClN₄O₄, acts as a multiple kinase inhibitor against the VEGFR1, VEGFR2 and VEGFR3 kinases, and is used for the treatment of certain kinds of thyroid cancer. Pazopanib (Votrient®), having the formula C₂₁H₂₃N₇O₂S, is a potent multi-targeted receptor tyrosine kinase inhibitor, that inhibits VEGFR, PDGFR, c-KIT and FGFR. Pazopanib is used as a treatment option for kidney cancer and advanced soft tissue sarcoma, Ramucirumab (Cyramza®), is a fully human monoclonal antibody (IgG1) that binds with high affinity to the extracellular domain of VEGFR2 and block the binding of natural VEGFR ligands (VEGF-A, VEGF-C and VEGF-D). Ramucirumab is used in the treatment of advanced stomach cancer; gastroesophageal junction adenocarcinoma, colorectal cancers; and non-small cell lung (NSCL) cancers. Regorafenib (Stivarga®), having the formula C₂₁H₁₅ClF₄N₄O₃, is an oral multi-kinase inhibitor that display dual inhibitory activity on VEGFR2-TIE2. Regorafenib is used as a treatment option for colorectal cancer and gastrointestinal stromal tumors (GIST). Sorafenib (Nexavar®), having the formula C₂₁H₁₆ClF₃N₄O₃, is a protein kinase inhibitor of various protein kinases, including VEGFR, PDGFR and RAF kinases. This drug is used in the treatment of kidney, liver, and thyroid cancers. Sunitinib (Sutent®), is an oral, small-molecule, multi-targeted receptor tyrosine kinase (RTK) inhibitor having the formula C₂₂H₂₇FN₄O₂, that blocks the tyrosine kinase activities of KIT, PDGFR, VEGFR2 and other tyrosine kinases. Sunitinib is used as a treatment option for kidney cancer, PNETs, and GIST. Thalidomide (Synovir, Thalomid®) (α-N-phthalimido-glutarimide), is a synthetic derivative of glutamic acid, which was know for causing birth defects when used as an antiemetic in pregnancy in the late 1950s and early 1960s. As indicated above, Thalidomide and its analogs are IMiDs. These drugs bind CRBN, a substrate receptor of CRL4 E3 ligase, to induce the ubiquitination and degradation of IKZF1 and IKZF3. Thalidomide is used in the treatment of multiple myeloma, Vandetanib (Caprelsa®), having the formula C₂₂H₂₄BrFN₄O₂, acts as a kinase inhibitor of a number of cell receptors, mainly the VEGFR, the EGFR, and the RET-tyrosine kinase, This drug is used as a treatment option for medullary thyroid cancer. Ziv-aflibercept (Zaltrap®), is a recombinant fusion protein consisting of VEGF-binding portions of the extracellular domains of human VEGF receptors 1 and 2, that are fused to the Fc portion of the human IgG1 immunoglobulin. This drug is used in the treatment of wet macular degeneration and metastatic colorectal cancer. It should be appreciated that any of the anti-angiogenic agents disclosed herein are applicable as an additional therapeutic agent for any of the aspects of the present disclosure.

In some embodiments, the therapeutic or candidate active agent of the invention may be a cancer vaccine. More specifically, cancer vaccines as referred to herein are vaccines that induce the immune system to mount an attack against cancer cells in the body. A cancer treatment vaccine uses cancer cells, parts of cells, or pure antigens to increase the immune response against cancer cells that are already in the body. These cancer vaccines are often combined with other substances or adjuvants that enhance the immune response. Furthermore, non-specific immunotherapies may also be suitable for the methods of the invention and as referred to herein, do not target a certain cell or antigen, but rather stimulate the immune system in a general way, which may still result in an enhanced activity of the immune system against cancer cells. A non-limiting example of non-specific immunotherapies includes cytokines (e.g. interleukins, interferons). It should be thus appreciated that in some embodiments, the active agent of the invention may be used as a combined supportive treatment for patients suffering from immune suppression. This supportive treatment may be combined with other supportive therapies as discussed herein.

In some embodiments, the therapeutic or candidate active agent of the invention may be a cytokine. The term “cytokine” generally refers to proteins produced by a wide variety of hematopoietic and non-hematopoietic cells that affect the behavior of other cells. They act through receptors, and are especially important in the immune system; cytokines modulate the balance between humoral and cell-based immune responses, and regulate the maturation, growth, and responsiveness of particular cell populations. Their particular importance in the regulation of the immune response motivated the production of biological drug to specifically target them. Cytokines may be such as Acylation stimulating protein, Adipokine, Albinterferon, CCL1, CCL2, CCL3, CCL5, CCL6, CCL7, CCL8, CCL9, CCL11, CCL12, CCL13, CCL14, CCL15, CCL16, CCL17, CCL18, CCL19, CCL20, CCL21, CCL22, CCL23, CCL24, CCL25, CCL26, CCL27, CCL28, Cerberus, protein, Chemokine, Colony-stimulating factor, CX3CL1, CX3CR1, CXCL1, CXCL2, CXCL3, CXCL5, CXCL6, CXCL7, CXCL9, CXCL10, CXCL11, CXCL13, CXCL14, CXCL15, CXCL16, CXCL17, Erythropoietin, FMS-like tyrosine kinase 3 ligand, GcMAF, Granulocyte colony-stimulating factor (or CSF 3), Granulocyte macrophage colony-stimulating factor (or CSF2), IL 17 family, IL-10 family, Interferon, Interferon beta-1a, Interferon beta-1b, Interferon gamma, Interferon type I, Interferon type II, Interferon type III, Interferon-stimulated gene, Interleukin 1 receptor antagonist, Interleukin 8, Interleukin 12, Interleukin-18, Leukemia inhibitory factor, Leukocyte-promoting factor, Lymphokine, Lymphotoxin, Lymphotoxin alpha, Lymphotoxin beta, Macrophage colony-stimulating factor (CSF1), Macrophage inflammatory protein, Macrophage-activating factor, Monokine, Myokine, My onectin, Nicotinamide phosphoribosyltransferase (NAmPRTase or Nampt) also known as pre-B-cell colony-enhancing factor 1 (PBEF1), Oncostatin M, Oprelvekin, Platelet factor 4, Receptor activator of nuclear factor kappa-B ligand (RANKL), also known as tumor necrosis factor ligand superfamily member 11 (TNFSF11), stromal cell-derived factor 1 (SDF1), also known as C-X-C motif chemokine 12 (CXCL12), tumor necrosis factor (TNF) superfamily such as Tumor necrosis factor alpha, Lymphotoxin-alpha, cell antigen gp39 (CD40L), CD27L, CD30L, FASL, 4-1BBL, OX40L, TNF-related apoptosis inducing ligand (TRAIL), Vascular endothelial growth inhibitor (VEGI), also known as ligand 1A (TL1A), XCL1, XCL2, XCR1. It should be appreciated that cytokines as specified herein, may be also applicable in any other aspect of the invention disclosed herein after.

In some further embodiments, the therapeutic or candidate active agent of the invention may be an angiogenesis inhibitor. Non-limiting examples of angiogenesis inhibitors useful in the methods, of the present disclosure include at least one of: VEGF inhibitors, for example, anti-VEGF antibodies such as Bevacizumab (Avastin®), and Ramucirumab (Cyramza®), VEGF fusion proteins such as Ziv-aflibercept (Zaltrap®), kinase inhibitors such as Vandetanib (Caprelsa®), Sunitinib (Sutent®), Sorafenib (Nexavar®), Regorafenib (Stivarga®), Pazopanib (Votrient®), Cabozantinib (Cometriq®), Axitinib (Inlyta®), and agents involved with degradation of proteins (e.g., via interaction with E3 ligases) such as Thalidomide (Synovir, Thalomid®), and related drugs, for example, Lenalidomide (Revlimid®).

It should be appreciated that in certain embodiment, the biological drug used by the methods of the invention may be any biosimilar, specifically, any approved biosimilar of the aforementioned originator biologics.

The term “biosimilar” means a biological product that is highly similar to a U.S. licensed reference biological product notwithstanding minor differences in clinically inactive components, and for which there are no clinically meaningful differences between the biological product and the reference product in terms of the safety, purity, and potency of the product.

A biosimilar as described herein may be similar to the reference medicinal product by way of quality characteristics, biological activity, mechanism of action, safety profiles and/or efficacy, or any combinations thereof. In addition, the biosimilar may be used or be intended for use to treat the same conditions as the reference medicinal product. Thus, a biosimilar as described herein may be deemed to have similar or highly similar quality characteristics to a reference medicinal product. Alternatively, or in addition, a biosimilar as described herein may be deemed to have similar or highly similar biological activity to a reference medicinal product. Alternatively, or in addition, a biosimilar as described. herein may be deemed to have a similar or highly similar safety profile to a reference medicinal product. Alternatively, or in addition, a biosimilar as described herein may be deemed to have similar or highly similar efficacy to a reference medicinal product. As described herein, a biosimilar in US is compared to a reference medicinal product which has been authorized by the FDA. However, in some instances, the biosimilar may be compared to a biological medicinal product which has been authorized outside the FDA in certain studies. Such studies include for example certain clinical and in vivo non-clinical studies.

As used herein, the term “biosimilar” also relates to a biological medicinal product which has been or may be compared to a non-FDA authorized comparator. Certain biosimilars are proteins such as antibodies, antibody fragments (for example, antigen binding portions) and fusion proteins. A protein biosimilar may have an amino acid sequence that has minor modifications in the amino acid structure (including for example deletions, additions, and/or substitutions of amino acids) which do not significantly affect the function of the polypeptide. The biosimilar may comprise an amino acid sequence having a sequence identity of 97 percent or greater to the amino acid sequence of its reference medicinal product, e.g., 97 percent, 98 percent, 99 percent or 100 percent. The biosimilar may comprise one or more post-translational modifications, for example, although not limited to, glycosylation, oxidation, deamidati on, and/or truncation which is/are different to the post-translational modifications of the reference medicinal product, provided that the differences do not result in a change in safety and/or efficacy of the medicinal product. The biosimilar may have an identical or different glycosylation pattern to the reference medicinal product. Particularly, although not exclusively, the biosimilar may have a different glycosylation pattern if the differences address or are intended to address safety concerns associated with the reference medicinal product. Additionally, the biosimilar may deviate from the reference medicinal product in for example its strength, pharmaceutical form, formulation, excipients and/or presentation, providing safety and efficacy of the medicinal product is not compromised. The biosimilar may comprise differences in for example pharmacokinetic (PK) and/or pharmacodynamic (PD) profiles as compared to the reference medicinal product but is still deemed sufficiently similar to the reference medicinal product as to be authorized or considered suitable for authorization. In certain circumstances, the biosimilar exhibits different binding characteristics as compared to the reference medicinal product, wherein the different binding characteristics are considered by a Regulatory Authority such as the FDA not to be a barrier for authorization as a similar biological product.

In yet some further embodiments, such therapeutic active agent may be at least one of Alectinib, Crizotinib, doxorubicin, docetaxel, paclitaxel, methotrexate, and any combinations thereof.

In some embodiments, the therapeutic active agent may be Alectinib. Alectinib (marketed as Alecensa®) is an oral drug that blocks the activity of anaplastic lymphoma kinase (ALK) and is used to treat non-small-cell lung cancer (NSCLC). It can be given by mouth or by injection. It has FDA Unique Ingredient Identifier (UNII): LIJ4CT1Z3Y and DRUG BANK Accession number DB11363.

In some embodiments, the therapeutic active agent may be Crizotinib. Crizotinib, sold under the brand name Xalkori® among others, is an anti-cancer medication acting as an ALK (anaplastic lymphoma kinase) and ROS1 (c-ros oncogene 1) inhibitor, approved for treatment of some non-small cell lung carcinoma (NSCLC) in the US and some other countries, and undergoing clinical trials testing its safety and efficacy in anaplastic large cell lymphoma, neuroblastoma, and other advanced solid tumors in both adults and children. It can be given by mouth or by injection. It has FDA Unique Ingredient Identifier (UNII): 53AH36668S and DRUG BANK Accession number DB08700.

In some embodiments, the therapeutic active agent may be Doxorubicin. Doxorubicin, sold under the brand name Adriamycin® among others, is a chemotherapy medication used to treat cancer e.g. breast cancer, bladder cancer, Kaposi's sarcoma, lymphoma, and acute lymphocytic leukemia. It is often used together with other chemotherapy agents. Doxorubicin is given by injection into a vein. It has FDA Unique Ingredient Identifier (UNII): 80168379AG and DRUG BANK Accession number DB00997.

In some embodiments, the therapeutic active agent may be Docetaxel. Docetaxel (DTX or DXL), sold under the brand name Taxotere® among others, is a chemotherapy medication used to treat a number of types of cancer e.g, breast cancer, head and neck cancer, stomach cancer, prostate cancer and non-small-cell lung cancer. It may be used by itself or along with other chemotherapy medication. It is administered by slow injection into a vein. It has FDA Unique Ingredient Identifier (UNII): 6991121PHCA and DRUG BANK Accession number DB01248.

In some embodiments, the therapeutic active agent may be Paclitaxel. Paclitaxel (PTX), sold under the brand name Taxol® among others, is a chemotherapy medication used to treat a number of types of cancer e.g. ovarian cancer, esophageal cancer, breast cancer, lung cancer, Kaposi sarcoma, cervical cancer, and pancreatic cancer. It is given by injection into a vein. It has FDA Unique Ingredient Identifier (UNII): P88XT4IS4D and DRUG BANK Accession number DB01229.

In some embodiments, the therapeutic active agent may be Methotrexate, Methotrexate (MTX), formerly known as amethopterin, sold under the brand name Trexall®, Rheumatrex®, Otrexup® among others, is a chemotherapy agent and immune-system suppressant. It is used to treat cancer such as breast cancer, leukemia, lung cancer, lymphoma, gestational trophoblastic disease, and osteosarcoma, autoimmune diseases such as psoriasis, rheumatoid arthritis, and Crohn's disease, and ectopic pregnancy and for medical abortions. It can be given by mouth or by injection. It has FDA Unique Ingredient Identifier (UNII): YL5FZ2Y5U1 and DRUG BANK Accession number DB00563.

In another embodiments, the therapeutic active agent may be Pemetrexed. Pemetrexed, sold under the brand name Alimta®) among others, is a chemotherapy medication for the treatment of pleural mesothelioma and non-small cell lung cancer (NSCLC). It has FDA Unique Ingredient Identifier (UNII): 04Q9AIZ7NO and DRUG BANK Accession number DB00642.

In some specific embodiments, the methods disclosed herein provide for predicting/determining and assessing responsiveness of a subject suffering from a malignant proliferative disorder to a treatment regimen comprising at least one anti-cancerous drug. In some optional embodiments, these methods may further optionally provide monitoring disease progression. In some specific embodiments, the method comprising the steps of:

First in step (a), exposing cancer cells of the assessed subject, that are grown in at least one cell chamber of a microfluidic test platform, to the anti-cancerous drug. The drug is accommodated in at least one respective active-agent chamber of the test platform. In the next step (b), determining for the exposed cells of (a), cell viability for at least one time interval.

The next step (c), involves classifying the cancer subject that is a cancer patient as:

Either (i), a responsive subject to the treatment regimen, if cell viability is reduced as compared with the cell viability in the absence of the anti-cancerous drug; or alternatively, (ii), as a drug-resistant subject if cell viability is not reduced as compared with the cell viability in the absence of the anti-cancerous drug.

The method therefore provides predicting, assessing and monitoring responsiveness of the mammalian subject to the treatment regimen. In some embodiments, the microfluidic test platform used in the disclosed method comprises a block of substrate material defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; while the reaction units are provided with desired active agents in situ during manufacture of the microfluidic test platform.

A further aspect of the present disclosure provides a method for determining a personalized treatment regimen for a subject suffering from a pathologic disorder. In some specific embodiments, the method comprising the steps of:

First in step (a), exposing cells of the subject grown in at least one cell chamber of at least one reaction unit of a microfluidic test platform, to at least one therapeutic active agent accommodated in at least one respective active-agent chamber of at least one reaction unit of the test platform.

The next step (b), involves determining for the exposed cells of (a), cell viability and/or at least one cell phenotype, for at least one time interval.

In the next step (c), classifying the subject as: either (i), a responsive subject to the treatment regimen, if at least one of, cell viability and/or at least one cell phenotype is modulated as compared with at least one of the cell viability and/or at least one cell phenotype in the absence of the candidate active agent; or alternatively as (ii), a drug-resistant subject if at least one of, cell viability and/or at least one cell phenotype is not modulated as compared with at least one of the cell viability and/or at least one cell phenotype in the absence of the therapeutic active agent.

The next step that follows classification of the subjects involves administering to a subject classified as a responder, an effective amount of the therapeutic active agent, or any compositions thereof. In some embodiments, the microfluidic test platform used herein, is as defined by the invention and comprises a block of substrate material defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; whille the reaction units are provided with desired active agents in situ during manufacture of the microfluidic test platform.

In some embodiments, the microfluidic test platform used in the method disclosed herein comprising a block defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; wherein the reaction units are provided with desired said active agents in situ during manufacture of the microfluidic test platform. In some embodiments, the personalized treatment disclosed herein may be is offered to a subject that is and/or was subjected to a treatment regimen comprising the therapeutic active agent and is monitored for disease progression. Accordingly, the method comprising the steps of:

First in step (a), exposing cells of the subject grown in at least one cell chamber of a microfluidic test platform, to at least one therapeutic active agent accommodated in at least one respective active-agent chamber in said test platform. It should be understood that in some embodiments, the cell sample is obtained after the initiation of the treatment regimen.

The next step (b), involves determining for the exposed cells of (a), cell viability and/or at least one cell phenotype, for at least one time interval.

In the next step (c), determining at least one of: (i), loss of responsiveness, and/or drug-resistance of the subject, if at least one of, cell viability and/or at least one cell phenotype is not modulated as compared with the cell viability and/or at least one cell phenotype in the absence of the candidate active agent; or (ii), responsiveness or maintained responsiveness of the subject, if at least one of, cell viability and/or at least one cell phenotype is modulated as compared with the cell viability and/or at least one cell phenotype in the absence of the candidate active agent. Upon determination as discussed herein, the next step (d), involves either ceasing a treatment regimen comprising the therapeutic active agent of a subject displaying disease relapse and/or loss of responsiveness, and/or drug-resistance; or alternatively, maintaining the treatment regimen of a subject displaying responsiveness or maintained responsiveness.

In some embodiments, at least one more temporally-separated sample used in the disclosed method is obtained after the initiation of at least one treatment regimen comprising the therapeutic active agent.

In some embodiments, the therapeutic active agent is placed prior to exposure to the cells, in a predetermined amount, within the respective active-agent chamber.

In some embodiments, the therapeutic active agent used for the personalized treatment approach disclosed herein may be at least one of: an inorganic or organic molecule, a small molecule, a nucleic acid-based molecule, an aptamer, a polypeptide, or any combinations thereof.

In yet some further embodiments, the cells form aggregates/clusters in the cell chamber, prior to exposure to said candidate agent.

In some embodiments, the cells used herein are cells of a subject suffering from a pathologic disorder.

In yet some further embodiments, the method for determining a personalized treatment regimen disclosed herein is applicable for a subject suffering from any one of a malignant proliferative disorder, an inflammatory condition, a metabolic condition, an infectious disease, an autoimmune disease, protein misfolding disorder or deposition disorder.

In certain embodiments, such pathologic disorder is a malignant proliferative disorder. Accordingly, the cells used by the method are primary cancer cells of the subject. In some embodiments, the cells may be a mixture of different primary cells.

In more specific embodiments, the malignant proliferative disorder applicable for the personalized treatment provided by the present disclosure is any one of carcinoma, melanoma, lymphoma, leukemia, myeloma and sarcoma.

As used herein to describe the present invention, “malignant proliferative disorder” or “proliferative disorder”, “cancer”, “tumor” and “malignancy” all relate equivalently to a hyperplasia of a tissue or organ. If the tissue is a part of the lymphatic or immune systems, malignant cells may include non-solid tumors of circulating cells. Malignancies of other tissues or organs may produce solid tumors. In general, the methods, methods of the present invention may be applicable for a patient suffering from any one of non-solid and solid tumors.

Malignancy, as contemplated in the present invention may be any one of carcinomas, melanomas, lymphomas, leukemia, myeloma and sarcomas. Therefore, in some embodiments any of the methods of the invention disclosed herein, may be applicable for any of the malignancies disclosed by the present disclosure.

More specifically, carcinoma as used herein, refers to an invasive malignant tumor consisting of transformed epithelial cells. Alternatively, it refers to a malignant tumor composed of transformed cells of unknown histogenesis, but which possess specific molecular or histological characteristics that are associated with epithelial cells, such as the production of cytokeratins or intercellular bridges.

Melanoma as used herein, is a malignant tumor of melanocytes. Melanocytes are cells that produce the dark pigment, melanin, which is responsible for the color of skin. They predominantly occur in skin but are also found in other parts of the body, including the bowel and the eye. Melanoma can occur in any part of the body that contains melanocytes.

Leukemia refers to progressive, malignant diseases of the blood-forming organs and is generally characterized by a distorted proliferation and development of leukocytes and their precursors in the blood and bone marrow. Leukemia is generally clinically classified on the basis of (1) the duration and character of the disease-acute or chronic; (2) the type of cell involved; myeloid (myelogenous), lymphoid (lymphogenous), or monocytic; and (3) the increase or non-increase in the number of abnormal cells in the blood-leukemic or aleukemic (subleukemic).

Sarcoma is a cancer that arises from transformed connective tissue cells. These cells originate from embryonic mesoderm, or middle layer, which forms the bone, cartilage, and fat tissues. This is in contrast to carcinomas, which originate in the epithelium. The epithelium lines the surface of structures throughout the body, and is the origin of cancers in the breast, colon, and pancreas.

Myeloma as mentioned herein is a cancer of plasma cells, a type of white blood cell normally responsible for the production of antibodies. Collections of abnormal cells accumulate in bones, where they cause bone lesions, and in the bone marrow where they interfere with the production of normal blood cells. Most cases of myeloma also feature the production of a paraprotein, an abnormal antibody that can cause kidney problems and interferes with the production of normal antibodies leading to immunodeficiency. Hypercalcemia (high calcium levels) is often encountered.

Lymphoma is a cancer in the lymphatic cells of the immune system. Typically, lymphomas present as a solid tumor of lymphoid cells. These malignant cells often originate in lymph nodes, presenting as an enlargement of the node (a tumor). It can also affect other organs in which case it is referred to as extra-nodal lymphoma. Non limiting examples for lymphoma include Hodgkin's disease, non-Hodgkin's lymphomas and Burkitt's lymphoma.

In some embodiments, the methods of the present disclosure may be applicable for any solid tumor. In more specific embodiments, the methods disclosed herein may be applicable for any malignancy that may affect any organ or tissue in any body cavity, for example, the peritoneal cavity (e.g., liposarcoma), the pleural cavity (e.g., mesothelioma, invading lung), any tumor in distinct organs, for example, the urinary bladder, ovary carcinomas, and tumors of the brain meninges. Particular and non-limiting embodiments of tumors applicable in the methods, of the present disclosure may include but are not limited to at least one of ovarian cancer, liver carcinoma, colorectal carcinoma, breast cancer, pancreatic cancer, brain tumors and any related conditions, as well as any metastatic condition, tissue or organ thereof.

In some other embodiments, the methods, of the invention are relevant to colorectal carcinoma, or any malignancy that may affect all organs in the peritoneal cavity, such as liposarcoma for example. In some further embodiments, the method of the invention may be relevant to tumors present in the pleural cavity (mesothelioma, invading lung) the urinary bladder, and tumors of the brain meninges.

In some particular embodiments, the methods of the invention may be applicable for ovarian cancer. It should be further understood that the invention further encompasses any tissue, organ or cavity barring ovarian metastasis, as well as any cancerous condition involving metastasis in ovarian tissue. As used herein, the term “ovarian cancer” is used herein interchangeably with the term “fallopian tube cancer” or “primary peritoneal cancer” referring to a cancer that develops from ovary tissue, fallopian tube tissue or from the peritoneal lining tissue, Still further, Choriocarcinoma, can occur as a primary ovarian tumor developing from a germ cell, though it is usually a gestational disease that metastasizes to the ovary. Mature teratomas, or dermoid cysts, are rare tumors consisting of mostly benign tissue that develop after menopause. Embryonal carcinomas, a rare tumor type usually found in mixed tumors, develop directly from germ cells but are not terminally differentiated; in rare cases they may develop in dysgenetic gonads. They can develop further into a variety of other neoplasms, including choriocarcinoma, yolk sac tumor, and teratoma. Primary ovarian squamous cell carcinomas are rare and have a poor prognosis when advanced. More typically, ovarian squamous cell carcinomas are cervical metastases, areas of differentiation in an endometrioid tumor, or derived from a mature teratoma.

In yet some other embodiments, the methods of the present disclosure may be suitable for liver cancer. It should be further understood that the invention further encompasses any tissue, organ or cavity barring liver originated metastasis, as well as any cancerous condition having metastasis of any origin in liver tissue. Liver cancer, also known as hepatic cancer and primary hepatic cancer, is cancer that starts in the liver. Cancer which has spread from elsewhere to the liver, known as liver metastasis, is more common than that which starts in the liver. Symptoms of liver cancer may include a lump or pain in the right side below the rib cage, swelling of the abdomen, yellowish skin, easy bruising, weight loss and weakness.

The leading cause of liver cancer is cirrhosis due to hepatitis B, hepatitis C or alcohol. Other causes include aflatoxin, non-alcoholic fatty liver disease and liver flukes. The most common types are hepatocellular carcinoma (HCC), which makes up 80% of cases, and cholangiocarcinoma. Less common types include mucinous cystic neoplasm and intraductal papillary biliary neoplasm. The diagnosis may be supported by blood tests and medical imaging, with confirmation by tissue biopsy. As used herein, HCC, is the most common type of primary liver cancer in adults, and is the most common cause of death in people with cirrhosis. It occurs in the setting of chronic liver inflammation and is most closely linked to chronic viral hepatitis infection (hepatitis B or C) or exposure to toxins such as alcohol or aflatoxin. Certain diseases, such as hemochromatosis, Diabetes mellitus and alpha 1-antitrypsin deficiency, markedly increase the risk of developing HCC. Metabolic syndrome and NASH are also increasingly recognized as risk factors for HCC.

Cholangiocarcinoma, also known as bile duct cancer, is a type of cancer that forms in the bile ducts. Symptoms of cholangiocarcinoma may include abdominal pain, yellowish skin, weight loss, generalized itching, and fever. Light colored stool or dark urine may also occur. Other biliary tract cancers include gallbladder cancer and cancer of the ampulla of Vater. Risk factors for cholangiocarcinoma include primary sclerosing cholangitis (an inflammatory disease of the bile ducts), ulcerative colitis, cirrhosis, hepatitis C, hepatitis B, infection with certain liver flukes, and some congenital liver malformations. The diagnosis is suspected based on a combination of blood tests, medical imaging, endoscopy, and sometimes surgical exploration. The disease is confirmed by examination of cells from the tumor under a microscope. It is typically an adenocarcinoma (a cancer that forms glands or secretes mucin).

In other embodiments, the methods of the present disclosure may be applicable for pancreatic cancer. It should be further understood that the invention further encompasses any tissue, organ or cavity barring pancreatic metastasis, as well as any cancerous condition having metastasis of any origin in the pancreas. Pancreatic cancer arises when cells in the pancreas, a glandular organ behind the stomach, begin to multiply out of control and form a mass. There are a number of types of pancreatic cancer. The most common, pancreatic adenocarcinoma, accounts for about 90% of cases. These adenocarcinomas start within the part of the pancreas which makes digestive enzymes. Several other types of cancer, which collectively represent the majority of the non-adenocarcinomas, can also arise from these cells. One to two percent of cases of pancreatic cancer are neuroendocrine tumors, which arise from the hormone-producing cells of the pancreas. These are generally less aggressive than pancreatic adenocarcinoma. Signs and symptoms of the most-common form of pancreatic cancer may include yellow skin, abdominal or back pain, unexplained weight loss, light-colored stools, dark urine, and loss of appetite. There are usually no symptoms in the disease's early stages, and symptoms that are specific enough to suggest pancreatic cancer typically do not develop until the disease has reached an advanced stage. By the time of diagnosis, pancreatic cancer has often spread to other parts of the body.

Pancreatic cancer rarely occurs before the age of 40, and more than half of cases of pancreatic adenocarcinoma occur in those over 70. Risk factors for pancreatic cancer include tobacco smoking, obesity, diabetes, and certain rare genetic conditions. Pancreatic cancer is usually diagnosed by a combination of medical imaging techniques such as ultrasound or computed tomography, blood tests, and examination of tissue samples (biopsy).

It should be understood that the methods of the present disclosure are applicable for any type and/or stage and/or grade of any of the malignant disorders discussed herein or any metastasis thereof. Still further, it must be appreciated that the methods of the invention may be applicable for invasive as well as non-invasive cancers. When referring to “non-invasive” cancer it should he noted as a cancer that do not grow into or invade normal tissues within or beyond the primary location. When referring to “invasive cancers” it should be noted as cancer that invades and grows in normal, healthy adjacent tissues.

Still further, in some embodiments, the methods kits of the present disclosure are applicable for any type and/or stage and/or grade of any metastasis, metastatic cancer or status of any of the cancerous conditions disclosed herein.

As used herein the term “metastatic cancer” or “metastatic status” refers to a cancer that has spread from the place where it first started (primary cancer) to another place in the body. A tumor formed by metastatic cancer cells originated from primary tumors or other metastatic tumors, that spread using the blood and/or lymph systems, is referred to herein as a metastatic tumor or a metastasis.

In some embodiments, the methods of the invention may be applicable to an inflammatory condition. The general term “inflammatory disorder” relates to disorders where an inflammation is a main response to harmful stimuli, such as pathogens, damaged cells, or irritants. Inflammation is a protective response that involves immune cells, blood vessels, and molecular mediators, as well as the end result of long-term oxidative stress.

“Inflammatory disorders” are a large group of disorders that underlie a vast variety of human diseases. Also, the immune system can be involved in inflammatory disorders, stemming from abnormal immune response of the organism against substances of its own, or initiation the inflammatory process for unknown reason, i.e, autoimmune and auto-inflammatory disorders, respectively. Non-immune diseases with etiological origins in inflammatory processes include cancer, atherosclerosis, and ischemic heart disease.

The purpose of inflammation is to eliminate the initial cause of cell injury, clear out necrotic cells and tissues and to initiate tissue repair. The classical physiological signs of acute inflammation are pain, heat, redness, swelling, and loss of function. A series of biochemical events propagates and matures the inflammatory response, involving the local vascular system, the immune system, and various cells within the injured tissue.

Prolonged inflammation, known as “chronic inflammation”, leads to a progressive shift in the type of cells present at the site of inflammation and is characterized by simultaneous destruction and healing of the tissue from the inflammatory process. Inflammation also induces high systemic levels of specific cytokines designated as pro-inflammatory cytokines which include IL-1α, IL-6, IL-8, IFN-γ, TNF-α, IL-17 and IL-18. The inflammatory response must be actively terminated when no longer needed to prevent unnecessary “bystander” damage to tissues. Failure to do so results in chronic inflammation, and cellular destruction. Resolution of inflammation occurs by different mechanisms in different tissues. Acute inflammation normally resolves by mechanisms that have remained somewhat elusive. Emerging evidence now suggests that an active, coordinated program of resolution initiates in the first few hours after an inflammatory response begins. After entering tissues, granulocytes promote the switch of arachidonic acid-derived prostaglandins and leukotrienes to lipoxins, which initiate the termination sequence. Neutrophil recruitment thus ceases, and programmed death by apoptosis (programmed cell death) is engaged. These events coincide with the biosynthesis, from omega-3 polyunsaturated fatty acids, of resolvins and protectins, which critically shorten the period of neutrophil infiltration by initiating apoptosis. As a consequence, apoptotic neutrophils undergo phagocytosis by macrophages, leading to neutrophil clearance and release of anti-inflammatory and reparative cytokines such as transforming growth factor-β1. The anti-inflammatory program ends with the departure of macrophages through the lymphatics.

Still further, the term “Inflammatory disorders” or “pathological conditions associated with inflammation” as used herein relates to at least one but not limited to the following: arthritis (ankylosing spondylitis, systemic lupus erythematosus, osteoarthritis, rheumatoid arthritis, psoriatic arthritis), asthma, atherosclerosis, inflammatory bowel disease (Crohn's disease, ulcerative colitis), dermatitis (including psoriasis).

In some embodiments, the methods of the invention may be applicable to a metabolic condition. A “metabolic disorder” occurs when abnormal chemical reactions disrupt the metabolism process i.e. chemical reactions involved in maintaining the living state of the cells and the organism. The three main purposes of metabolism are: the conversion of food to energy to run cellular processes; the conversion of food/fuel to building blocks for proteins, lipids, nucleic acids, and some carbohydrates; and the elimination of metabolic wastes. An individual can develop a metabolic disorder when some organs involved in these processes, such as liver or pancreas, become diseased or do not function normally. Non limiting examples of metabolic disorders are such as type II diabetes, metabolic syndrome, and cancer.

In some embodiments, the methods of the invention may be applicable to an infectious disease, or condition caused by any pathogen, specifically, at least one of, bacterial pathogen, a viral pathogen and a parasite.

“Infection” as used herein, is the invasion of an organism's body tissues by disease-causing agents, their multiplication, and the reaction of host tissues to these organisms and the toxins they produce. Infectious disease, also known as transmissible disease or communicable disease, is illness resulting from an infection. It should be appreciated that an infectious disease as used herein also encompasses any infectious disease caused by a pathogenic agent. Pathogenic agents include bacteria, viruses, prokaryotic microorganisms, lower eukaryotic microorganisms, complex eukaryotic organisms, prions, parasites, yeasts, nematodes such as parasitic roundworms and pinworms, arthropods such as ticks, mites, fleas, and lice, fungi such as ringworm, and other macroparasites such as tapeworms and other helminths.

Prokaryotic microorganisms includes bacteria as detailed herein after, for example, Gram positive, Gram negative, Gram variable bacteria, acid fast organisms and intracellular bacteria.

A lower eukaryotic organism includes a yeast or fungus such as but not limited to Pneumocystis carinii, Candida albicans, Aspergillus, Histoplasma capsulatum, Blastomyces dermatitidis, Cryptococcus neoformans, Trichophyton and Microsporum. A complex eukaryotic organism includes worms, insects, arachnids, nematodes, aemobe, Entamoeba histolytica, Giardia lamblia, Trichomonas vaginalis, Trypanosoma brucei gainbiense, Trypanosoma cruzi, Balantidium coli, Toxoplasma gondii, Cryptosporidium or Leishmania.

The term “viruses” is used in its broadest sense to include viruses of the families coronaviruses, adenoviruses, papovaviruses, herpesviridae (simplex, varicella zoster, Epstein-Barr, CMV), hepatitis A, hepatitis B, hepatitis C, influenza viruses A and B, pox viruses: smallpox, vaccinia, rhinoviruses, poliovirus, rubella virus, arboviruses, rabies virus, flaviviruses, measles virus, mumps virus, HIV, HTLV I and II.

The term “fungi” includes for example, fungi that cause diseases such as ringworm, histoplasmosis, blastomycosis, aspergillosis, cryptococcosis, sporotrichosis, coccidioidomycosis, paracoccidio-idoinycosis, and candidiasis.

The term “parasite” includes, but is not limited to, infections caused by somatic tapeworms, blood flukes, tissue roundworms, ameba, and Plasmodium, Trypanosoma, Leishmania, and Toxoplasma species.

Thus, in some embodiments, the present invention provides methods for treating an infectious disease caused by a bacterial pathogen.

In some specific embodiments, the bacterial pathogen may be at least one of enteropathogenic Escherichia coli (EPEC), Pseudomonas aeruginosa and Staphylococcus aureus.

Bacterial infection is an example for inflammation-related disorder. More specifically, the term “bacterial infections” relates to infection caused by bacteria. The term “bacteria” (in singular a “bacterium”) in this context refers to any type of a single celled microbe. This term encompasses herein bacteria belonging to general classes according to their basic shapes, namely spherical (cocci), rod (bacilli), spiral (spirilla), comma (vibrios) or corkscrew (spirochaetes), as well as bacteria that exist as single cells, in pairs, chains or clusters.

In more specific embodiments, the term “bacteria” specifically refers to Gram positive, Gram negative or acid fast organisms. The Gram-positive bacteria can be recognized as retaining the crystal. violet stain used in the Gram staining method of bacterial differentiation, and therefore appear to be purple-colored under a microscope. The Gram-negative bacteria do not retain the crystal violet, making positive identification possible. In other words, the term ‘bacteria’ applies herein to bacteria with a thicker peptidoglycan layer in the cell wall outside the cell membrane (Gram-positive), and to bacteria with a thin peptidoglycan layer of their cell wall that is sandwiched between an inner cytoplasmic cell membrane and a bacterial outer membrane (Gram-negative).

In some embodiments, examples of bacteria contemplated herein include the species of the genera Treponema sp., Borrelia sp., Neisseria sp., Legionella sp., Bordetella sp., Escherichia sp., Salmonella sp., Shigella sp., Klebsiella sp., Yersinia sp., Vibrio sp., Hemophilia sp., Rickettsia sp., Chlamydia sp., Mycoplasma sp., Staphylococcus sp., Streptococcus sp., Bacillus sp., Clostridium sp., Corynebacterium sp., Proprionibacterium sp., Mycobacterium sp., Ureaplasma sp. and Listeria sp. In yet some more specific embodiments, bacterial pathogens in the context of the invention may include but are not limited to enteropathogenic Escherichia coli (EPEC), Pseudomonas aeruginosa, Staphylococcus aureus, Streptococcus pyogenes, Clostidium difficile Enterococcus faecium, Klebsiella pneumonia, Acinetobacter baumanni and Enterobacter species, Mycobacterum tuberculosis, Alcaligenes faecalis, Neisseria meningitis, Prevotella intermedia, Porphyromonas gingivalis, species of Salmonella, Shigella, Proteus, Providencia, Enterobacter and Morganella.

In some embodiments, the methods of the invention may be applicable to an autoimmune disease. An autoimmune disease is a condition arising from an abnormal immune response to a normal body part. Examples of an autoimmune disorder include Rheumatoid arthritis (RA), Multiple sclerosis (MS), Systemic lupus erythematosus (lupus), Type 1 diabetes, Psoriasis/psoriatic arthritis, Inflammatory bowel disease including Crohn's disease and Ulcerative colitis, and Vasculitis.

In some embodiments, the methods of the invention may be applicable to a protein misfolding disorder also named proteopathy, or deposition disorder. Thus, the present disclosure provides prognostic methods and personalized therapeutic methods applicable for subjects suffering from any proteopathy, such as amyloidosis.

Proteopathy refers to a class of diseases in which certain proteins become structurally abnormal, and thereby disrupt the function of cells, tissues and organs of the body. Often the proteins fail to fold into their normal configuration; in this misfolded state, the proteins can become toxic in some way (a gain of toxic function) or they can lose their normal function. The proteopathies (also known as proteinopathies, protein conformational disorders, or protein misfolding diseases) include such diseases as Creutzfeldt-Jakob disease and other prion diseases,Alzheimer's disease, Parkinson's disease, amyloidosis, multiple system atrophy, and a wide range of other disorders. In some specific embodiments, the proteopathy or protein-misfolding disorder may be Amyloidosis. Specifically, Amyloidosis is a group of diseases in which abnormal proteins, known as amyloid fibrils, build up in tissue. Symptoms depend on the type and are often variable. They may include diarrhea, weight loss, feeling tired, enlargement of the tongue, bleeding, numbness, feeling faint with standing, swelling of the legs, or enlargement of the spleen.

There are about 30 different types of amyloidosis, each due to a specific protein misfolding. Some are genetic while others are acquired. They are grouped into localized and systemic forms. The four most common types of systemic disease are light chain (AL), inflammation (AA), dialysis (Aβ₂M), and hereditary and old age (ATTR). It should be understood that the prognostic and personalized therapeutic methods of the invention, as well as any of the therapeutic methods, compositions and kits disclosed herein after, may be applicable for any type of amyloidosis, specifically, any type discussed in the present disclosure.

Additional examples of protein misfolding diseases relevant to the methods of the present disclosure, include but are not limited to Alzheimer's disease, Cerebral β-amyloid angiopathy, Retinal ganglion cell degeneration in glaucoma, Prion diseases (multiple), Parkinson's disease and other synucleinopathies (multiple), Tauopathies (multiple) Frontotemporal lobar degeneration (FTLD), Amyotrophic lateral sclerosis (ALS), Huntington's disease and other trinucleotide repeat disorders (multiple), Familial British dementia, Familial Danish dementia, Hereditary cerebral hemorrhage with amyloidosis (Icelandic) (HCHWA-I), Alexander disease, Pelizaeus-Merzbacher disease, Seipinopathies, Familial amyloidotic neuropathy, Senile systemic amyloidosis, Serpinopathies (multiple), AL (light chain) amyloidosis (primary systemic amyloidosis), AH (heavy chain) amyloidosis, AA (secondary) amyloidosis. Type II diabetes, Aortic medial amyloidosis, ApoAI amyloidosis, ApoAII amyloidosis, ApoAIV amyloidosis, Familial amyloidosis of the Finnish type (FAF), Lysozyme amyloidosis, Fibrinogen amyloidosis, Dialysis amyloidosis, Inclusion body myositis/myopathy, Cataracts, Retinitis pigmentosa with rhodopsin mutations, Medullary thyroid carcinoma, Cardiac atrial amyloidosis, Pituitary prolactinoma, Hereditary lattice corneal dystrophy, Cutaneous lichen amyloidosis, Mallory bodies, Corneal lactoferrin amyloidosis, Pulmonary alveolar proteinosis, Odontogenic (Pindborg) tumor amyloid, Seminal vesicle amyloid, Apolipoprotein C2 amyloidosis, Apolipoprotein C3 amyloidosis, Lect2 amyloidosis, Insulin amyloidosis, Galectin-7 amyloidosis (primary localized cutaneous amyloidosis), Corneodesmosin amyloidosis, Enfuvirtide amyloidosis, Cystic fibrosis, Sickle cell disease.

In yet some further embodiments, since amyloidosis is also classified as a deposition disorder, the methods of the invention may be also applicable for any deposition disorder Deposition disorder, as used herein is any disorder involving or characterized by deposition of insoluble extracellular protein fragments, or any other metabolite, that have been rendered resistant to digestion, thereby interfering and impairing tissue or organ function and may lead to organ failure.

In some embodiments, the method for determining a personalized treatment regimen comprises the step of determining cell viability. In more specific embodiments, cell viability is determined by using at least one cell-impermeant DNA-binding dyes (propidium iodide (PI, measuring dead cells), nuclear staining (Hoechst 33342) and XTT).

Still further, in some embodiments, the method for determining a personalized treatment regimen in accordance with the present disclosure may be applicable for various treatment regimen that comprise any therapeutic active agent. In some specific embodiments, such therapeutic active agent may be any agent or drug applicable for cancer treatment. More specifically, in some embodiments such agent may be at least one of a chemotherapeutic agent, a biological therapy agent, an immuno therapeutic agent, an hormonal therapy agent or any combination thereof.

In more specific and non-limiting embodiments, the therapeutic active agent is at least one of Alectinib, Crizotinib, doxorubicin, docetaxel, paclitaxel, methotrexate, and any combinations thereof.

In certain embodiments, the method provided herein is applicable for determining a personalized treatment regimen for a subject suffering from a malignant proliferative disorder. More specifically, the method comprising the steps of:

First in step (a), exposing and/or contacting cancer cells of the subject grown in at least one cell chamber of a microfluidic test platform, to at least one anti-cancer drug accommodated in at least one respective active-agent chamber in said test platform.

The next step (b), involves determining for the exposed cells of (a), cell viability for at least one time interval. The next (c), allows classifying the subject either as (i), a responsive subject to the treatment regimen, if cell viability is reduced as compared with the cell viability in the absence of the anti-cancer drug. Alternatively, the subject is classified as (ii), a drug-resistant subject if cell viability is not reduced as compared with cell viability in the absence of the anti-cancer drug. The next step (d) involves administering to a subject classified as a responder, an effective amount of the anti-cancer drug, or any compositions thereof It should be understood that in some embodiments, the microfluidic test platform used by the methods disclosed herein is as defined by the invention and comprises a block of substrate material defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; while the reaction units are provided with desired active agents in situ during manufacture of the microfluidic test platform.

A further aspect of the invention provides a method for treating, preventing, inhibiting, reducing, eliminating, protecting or delaying the onset of at least one pathologic disorder in a subject in need thereof. More specifically, the method comprising the following steps.

In a first step (a), exposing cells of the subject grown in at least one cell chamber of at least one reaction unit of a microfluidic test platform, to at least one therapeutic active agent accommodated in at least one respective active-agent chamber of at least one reaction unit of the test platform. The next step (b) involves determining for the exposed cells of (a), cell viability and/or at least one cell phenotype, for at least one time interval. The next step (c), allows classifying the subject as: (i), a responsive subject to the treatment regimen, if at least one of, cell viability and/or at least one cell phenotype is modulated as compared with at least one of the cell viability and/or at least one cell phenotype in the absence of the therapeutic active agent. Alternatively, the subject is classified as a drug-resistant subject if at least one of, cell viability and/or at least one cell phenotype is not modulated as compared with at least one of the cell viability and/or at least one cell phenotype in the absence of the therapeutic active agent. The next step following the subject classification (d), allows selecting a treatment regimen based on the responsiveness, thereby treating the subject with the selected treatment regimen.

In some embodiments, the microfluidic test platform used in the therapeutic method disclosed herein comprising a block defining a first plurality of reaction units, a first network of feeding channels, a second network of seeding channels, and a control system for enabling control of fluid flows with respect to the first network of feeding channels and with respect to the second network of seeding channels; each said reaction unit being in selective fluid communication with the first network of seeding channels and in selective fluid communication with the second network of feeding channels; each said reaction unit configured, during operation of the platform, for enabling a cell sample to be interacted with a respective active agent; wherein the reaction units are provided with desired said active agents in situ during manufacture of the microfluidic test platform. In more specific wherein step (d) comprises at least one of: in some embodiments, (i), administering to a subject classified as a responder, an effective amount of the therapeutic active agent, or any compositions thereof. In yet some other embodiments (ii), maintaining said treatment regimen, of a subject displaying responsiveness or maintained responsiveness. In another alternative embodiment (iii), ceasing the treatment regimen of a subject displaying loss of responsiveness.

In some embodiments, the therapeutic active agent is placed prior to exposure to the cells, in a predetermined amount, within the respective active-agent chamber.

In yet some further embodiments, the therapeutic active agent applicable in the therapeutic methods disclosed herein is at least one of: an inorganic or organic molecule, a small molecule, a nucleic acid-based molecule, an aptamer, a polypeptide, or any combinations thereof.

In some embodiments, the cells used in the diagnostic step of the therapeutic methods disclosed herein, form aggregates/clusters in the cell chamber, prior to exposure to the therapeutic active agent.

In some embodiments, the cells used in the diagnostic steps of the therapeutic methods disclosed herein are cells of a subject suffering from a pathologic disorder. In yet some further embodiments, the cells are of the subject that will be treated by the disclosed method, thereby providing tailored personalized therapeutic approach.

In some embodiments pathologic disorder treatable by the disclosed therapeutic method is any one of a malignant proliferative disorder, an inflammatory condition a metabolic condition, an infectious disease, an autoimmune disease, protein misfolding disorder or deposition disorder.

In yet some further embodiments, the pathologic disorder is a malignant proliferative disorder. In further embodiments, the cells used for the assessment prognostic stage of the disclosed method are primary cancer cells of the subject. In some embodiments, the cells may be a mixture of different primary cells.

In more specific embodiments, the malignant proliferative disorder is any one of carcinoma, melanoma, lymphoma, leukemia, myeloma and sarcoma.

In some embodiments, the prognostic steps of the therapeutic methods disclosed herein, involves determination of cell viability of cells obtained from the subject. In certain embodiments, the cell viability is determined by using at least one cell-impermeant DNA-binding dyes (propidium iodide (PI, measuring dead cells), nuclear staining (Hoechst 33342) and XTT).

In some embodiments, the therapeutic active agent applicable in the disclose therapeutic methods, is at least one of a chemotherapeutic agent, a biological therapy agent, an immuno therapeutic agent, an hormonal therapy gent or any combination thereof.

In some specific and non-limiting embodiments, the therapeutic active agent applicable in the therapeutic methods discussed herein, is at least one of Alectinib, Crizotinib, doxorubicin, docetaxel, paclitaxel, methotrexate, and any combinations thereof.

Thus, in some specific and non-limiting embodiments, the present disclosure provides methods for treating, preventing, inhibiting, reducing, eliminating, protecting or delaying the onset of at least one malignant proliferative disorder in a subject in need thereof. These methods involve therapeutic and diagnostic steps. More specifically, the method comprising the steps of:

First in step (a), exposing cancer cells of the subject grown in at least one cell chamber of a microfluidic test platform, to at least one therapeutic active agent accommodated in at least one respective active-agent chamber in said test platform. The next step (b), involves determining for the exposed cells of (a), cell viability for at least one time interval. The final step (c), of the prognostic/diagnostic stage of the method discussed herein involves classifying the subject as: (i) a responsive subject to the treatment regimen, if cell viability is reduced as compared with the cell viability in the absence of said therapeutic active agent; or (ii) a drug-resistant subject if cell viability is not reduced as compared with the cell viability in the absence of the therapeutic active agent. The next step (d) is the therapeutic step that involves selecting a treatment regimen based on said responsiveness, thereby treating the subject with the selected treatment regimen.

In some further embodiments, the selected treatment or therapeutic active agent of the invention may be administered and dosed by the methods of the invention, in accordance with good medical practice, systemically, for example by parenteral, e.g. intravenous. It should be noted however that the invention may further encompass additional administration modes. In other examples, the active agent can be introduced to a site by any suitable route including intraperitoneal, subcutaneous, transcutaneous, topical, intramuscular, intraarticular, subconjunctival, or mucosal, e.g. oral, intranasal, or intraocular administration.

Local administration to the area in need of treatment may be also achieved by, for example, by local infusion during surgery, topical application, direct injection into the specific organ, etc. More specifically, the active agent used in any of the methods of the invention, described herein before, may be adapted for administration by parenteral, intraperitoneal, transdermal, oral (including buccal or sublingual), rectal, topical (including buccal or sublingual), vaginal, intranasal and any other appropriate routes.

It is to be understood that the terms “treat”, “treating”, “treatment” or forms thereof, as used herein, mean preventing, ameliorating or delaying the onset of one or more clinical indications of disease activity in a subject having a pathologic disorder. Treatment refers to therapeutic treatment. Those in need of treatment are subjects suffering from a pathologic disorder. Specifically, providing a “preventive treatment” (to prevent) or a “prophylactic treatment” is acting in a protective manner, to defend against or prevent something, especially a condition or disease. The term “treatment or prevention” as used herein, refers to the complete range of therapeutically positive effects of administrating to a subject including inhibition, reduction of, alleviation of, and relief from, pathologic disorder involved with at least one short term cellular stress condition/process and any associated condition, illness, symptoms, undesired side effects or related disorders. More specifically, treatment or prevention of relapse or recurrence of the disease, includes the prevention or postponement of development of the disease, prevention or postponement of development of symptoms and/or a reduction in the severity of such symptoms that will or are expected to develop. These further include ameliorating existing symptoms, preventing-additional symptoms and ameliorating or preventing the underlying metabolic causes of symptoms. It should be appreciated that the terms “inhibition”, “moderation”, “reduction”. “decrease” or “attenuation” as referred to herein, relate to the retardation, restraining or reduction of a process by any one of about 1% to 99.9%, specifically, about 1% to about 5%, about 5% to 10%, about 10% to 15%, about 15% to 20%, about 20% to 25%, about 25% to 30%, about 30% to 35%, about 35% to 40%, about 40% to 45%, about 45% to 50%, about 50% to 55%, about 55% to 60%, about 60% to 65%, about 65% to 70%, about 75% to 80%, about 80% to 85% about 85% to 90%, about 90% to 95%, about 95% to 99%, or about 99% to 99.9%, 100% or more.

With regards to the above, it is to be understood that, where provided, percentage values such as, for example, 10%, 50%, 120%, 500%, etc., are interchangeable with “fold change” values, i.e., 0.1, 0.5, 1.2, 5, etc., respectively.

The term “amelioration” as referred to herein, relates to a decrease in the symptoms, and improvement in a subject's condition brought about by the methods according to the invention, wherein said improvement may be manifested in the forms of inhibition of pathologic processes associated with the disorders described herein, a significant reduction in their magnitude, or an improvement in a diseased subject physiological state.

The term “inhibit” and all variations of this term is intended to encompass the restriction or prohibition of the progress and exacerbation of pathologic symptoms or a pathologic process progress, said pathologic process symptoms or process are associated with.

The term “eliminate” relates to the substantial eradication or removal of the pathologic symptoms and possibly pathologic etiology, optionally, according to the methods of the invention described herein.

The terms “delay”, “delaying the onset”, “retard” and all variations thereof are intended to encompass the slowing of the progress and/or exacerbation of a disorder associated with the at least one short term cellular stress condition/process and their symptoms, slowing their progress, further exacerbation or development, so as to appear later than in the absence of the treatment according to the invention.

As indicated above, the methods provided by the present invention may be used for the treatment of a “pathological disorder”, i.e. pathologic disorder or condition involved with at least one short term cellular stress condition/process, which refers to a condition, in which there is a disturbance of normal functioning, any abnormal condition of the body or mind that causes discomfort, dysfunction, or distress to the person affected or those in contact with that person. It should be noted that the terms “disease”, “disorder”, “condition” and “illness”, are equally used herein.

It should be appreciated that any of the methods described by the invention may be applicable for treating and/or ameliorating any of the disorders disclosed herein or any condition associated therewith. It is understood that the interchangeably used terms “associated”, “linked” and “related”, when referring to pathologies herein, mean diseases, disorders, conditions, or any pathologies which at least one of: share causalities, co-exist at a higher than coincidental frequency, or where at least one disease, disorder condition or pathology causes the second disease, disorder, condition or pathology. More specifically, as used herein, “disease”, “disorder”, “condition”, “pathology” and the like, as they relate to a subject's health, are used interchangeably and have meanings ascribed to each and all of such terms.

It should be appreciated that the platforms, systems and methods of the present disclosure may be suitable for any subject that may be any multicellular organism, specifically, any vertebrate subject, and more specifically, a mammalian subject, avian subject, fish or insect. In some specific embodiments, the prognostic as well as the therapeutic, cosmetic and agricultural methods presented by the enclosed disclosure may be applicable to mammalian subjects, specifically, human subjects. By “patient” or “subject” it is meant any mammal that may be affected by the above-mentioned conditions, and to whom the treatment and prognosis methods herein described is desired, including human, bovine, equine, canine, murine and feline subjects. Specifically, the subject is a human.

All definitions, as defined and used herein, should be understood to control over dictionary definitions, definitions in documents incorporated by reference, and/or ordinary meanings of the defined terms.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. In some embodiments, the term “about” refers to ±10%.

The indefinite articles “a” and “an,” as used herein in the specification and in the claims, unless clearly indicated to the contrary, should be understood to mean “at least one.” It must be noted that, as used in this specification and the appended claims, the singular forms “a”, “an” and “the” include plural referents unless the content clearly dictates otherwise.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

Throughout this specification and the Examples and claims which follow, all transitional phrases such as “comprising,” “including,” “carrying,” “having,” “containing,” “involving,” “holding,” “composed of,” and the like are to be understood to be open-ended, i.e., to mean including but not limited to. Specifically, it should understood to imply the inclusion of a stated integer or step or group of integers or steps but not the exclusion of any other integer or step or group of integers or steps. Only the transitional phrases “consisting of” and “consisting essentially of” shall be closed or semi-closed transitional phrases, respectively, as set forth in the United States Patent Office Manual of Patent Examining Procedures. More specifically, the terms “comprises”, “comprising”, “includes”, “including”, “having” and their conjugates mean “including but not limited to”. The term “consisting of means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

It should be noted that various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub ranges as well as individual numerical values within that range. For example, description of a range such as from 1 to 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Various embodiments and aspects of the present invention as delineated herein above and as claimed in the claims section below find experimental support in the following examples.

Disclosed and described, it is to be understood that this invention is not limited to the particular examples, methods steps, and compositions disclosed herein as such methods steps and compositions may vary somewhat. It is also to be understood that the terminology used herein is used for the purpose of describing particular embodiments only and not intended to be limiting since the scope of the present invention will be limited only by the appended claims and equivalents thereof.

The following examples are representative of techniques employed by the inventors in carrying out aspects of the present invention. It should be appreciated that while these techniques are exemplary of preferred embodiments for the practice of the invention, those of skill in the art, in light of the present disclosure, will recognize that numerous modifications can be made without departing from the spirit and intended scope of the invention.

### EXAMPLES

Without further elaboration, it is believed that one skilled in the art can, using the preceding description, utilize the present invention to its fullest extent. The following preferred specific embodiments are, therefore, to be construed as merely illustrative, and not limitative of the claimed invention in any way.

Experimental Procedures

Cell Cultivation in Culture Plates

MCF-7 Cell line was cultivated in 10 cm surface treated Petri Dish (Lumitron, Israel) and suspended in high glucose DMEM medium, supplemented with 10% FBS (BI, Israel), 1% penicillin+streptomycin (BI, Israel) and 1% L-glutamine (BI, Israel). The cells were incubated in a humidified 5% CO2 atmosphere (New Brunswik Galaxy 170 S) at 37° C. A maximum of 15 passages were applied for each tissue culture dish. All the experiments were carried out while the cells were in exponential growth phase.

Prior to a microfluidic experiments, the cells were cultured for 2-3 days. The cells were then dissociated from the culture dish at 60-70% confluence with 0.25% trypsin in PBS, resuspended in DMEM containing 10% FBS and introduced into the microfluidic device. The seeded device was placed in an incubator throughout the experiments. In all the experiments, cells were given an accommodation phase of 24 hours prior to stimulation with different compounds (dyes or drug). MCF7/Dx cell line was grown in the presence of 10 \hat{ }M doxorubicin and cultured for 4 weeks in drug-free medium prior to use. All other protocols were similar to the MCF7 cell lines treatment.

Testing Cell Lines on the Chip

MCF7 and MCF7/Dx were used as simple model for breast cancer tissue to mimic the physiological conditions of the human body on cytotoxicity test. Cells were separately cultured in high-glucose DMEM medium supplemented with 10% fetal calf serum, L-glutamine (2 mM), and penicillin (100 U/ml) and streptomycin (100 U/ml) at 37° C. in a humidified 5% CO2 atmosphere. Drugs application

The evaluation of anticancer drug effect on cells vitality was conducted in two steps. First, Docetaxel was used, which is one of the first-line chemotherapies used for metastatic breast cancer. Docetaxel, at different concentrations (1 uM, 10 uM and 100 uM), was flown into the microfluidics device for 5 minutes, following the cell accommodation period. Then the cells, were incubated with the drug for 2 hours. Cell feeding, by diffusion, commenced until the experiment was finished. Live/dead assay was applied up to 48 hours following drug administration. After the evaluation of cells response to one drug-Docetaxel the effect was tested of an array of drugs on the cells. The drugs were printed on a glass substrate and their spotted array was aligned to the drug chamber in the microfluidic device.

Microfluidic Device Manufacturing

PDMS devices were manufactured using standard methods in Gerber's lab. Briefly, the flow (cell culturing) and control (valves) layers were prepared separately on silicone molds casting silicone elastomer polydimethylsiloxane (PDMS, SYLGARD 184, Dow Corning, USA). For the control layer, PDMS and curing agent at a 5:1 ratio, were mixed, followed by degassing, baking and access hole piercing steps. The flow layer was prepared similarly except for the application of 20:1 ratio of PDMS and curing agent. It is important to explain that the flow layer contains two different heights, in which different components are located. The horizontal Filter tubes (F) that deliver medium to the cultivated cells, are located at the lower area of the flow layer whereas, the chambers and other vertical tubes are located at the higher zone of the layer.

After the preparation of both layers, both were aligned using home-built semi-automatic alignment system. Then the chip was placed in an oven at 80° C. for full curing. Holes were punched to allow the connection of tubes via pins, and the flowing of air or fluids within the chip during the experiment. The flow of medium/cells was regulated by using pneumatic system (regulated semi-automatically). Working pressure for cell flow was 5-7 PSI. Input and output control valves were operated with 20 PSI. The temperature, humidity and CO2 were controlled by the microscope incubator build in system (Bold Line, Okolab, Italy).

The Microfluidic Device

A schematic illustration of the microfluidics device with its setup in the microscope is shown in FIG. 1. A double layer microfluidic device composed of flow and control layers. Briefly, the device consists of a 16×32 cell culture units array in the flow layer, accessed through several input holes and drained into a single output. Micromechanical address valves compartmentalize the microfluidic device to allow setting up to 16 separate reaction conditions on a single device within isolated columns. Each reaction unit divides into two chambers -cell culture (C) and drug chambers (D) and is controlled by three types of micromechanical valves: ‘neck’, ‘sandwich’, and ‘drug chamber valve’. The dry spotted material (drug) is isolated in the drug chamber until exposure to reaction components. The ‘sandwich’ valve enables each reaction to occur in its own isolated reaction unit. The average unit height is 30 μm and average cell volume per chamber is about 5 nl.

Surface Chemistry Protocol

For surface treatment, the chip channels were washed with Ethanol (20 min), PBS (10 min), Poly-Lysine (20 min), and PBS+BSA (5%) (20 min) in this order. Then cells were flown in the main channel and were pushed to the incubation chambers through the horizontal small tubes. The neck valve, was closed and the main flow channels were thoroughly washed with Trypsin (0.25% BI, Israel) to remove cells aggregates. Trypsin was then washed out by PBS (15 min). The cells were left for 2 hours in the cultivation chamber for adhesion. Two hours later, phenol-free DMEM flow was renewed at a low pressure (3 PSI), and cells were left for cultivation overnight.

Cell Vitality Assessment

Custom assays for cells vitality evaluation were applied. Living cells were stained with Calcein-AM (50 ng/ul in DMEM medium) (Biotest, Israel) which colors the cytoplasm. Dead cells were stained with Propidium Iodide (PI) (Sigma, Israel) (15 ng/ul in DMEM medium), coloring the nuclear. All cells nuclear (live and dead) were stained by Hoechst 33342 stain (Bis-Benzimide H3342 trihydro-chloride, Sigma, Israel) (10 ng/μl in DMEM medium). A solution of all three dyes was prepared and flowed within the chip. The cells were washed with the solution for 20 min at a pressure of 2 psi. Following dyes application, the controlled valves were closed and the device was incubated for 30 min at 37° C. 5% CO2 to allow cells staining. Next, the valves were opened and the device was washed by phenol-free DMEM medium for 15 min, to remove colures remains.

Microscopy

Imaging was done by Nikon Eclipse Ti. Images were acquired by NIS Elements software (ver. 4.20.01 Nikon, USA). To allow automatic filming of specific chambers, a special attention was given to linear alignment of the entire chip to the slide borders during the manufacturing procedures.

Statistical Analysis

Statistical analysis was carried up using Microsoft Excel 2016 Data Analysis package and RStudio (RStudio Team (2015). RStudio: Integrated Development for R. RStudio, Inc., Boston, Mass.) Images were processed with NIS Elements Analysis software (ver. 40.20.01 Nikon, USA). For all experiments, variables are expressed as traditional boxplots, presenting median, maximum, minimum and Interquartiie range (IQR). Survival and mortality levels were normalized to the total number of cells present in each chamber. Cells mortality was normalized in each chamber to its initial cell mortality value (T0) to address variability between different chambers at the beginning of each experiment. For normally distributed data sets, with equal variances, two tail, unpaired student's t-test was applied. In all cases, significance was defined as p<0.05, one way analysis of variance was evaluated using Anova, while multiple comparison was evaluated using Tukey's range test (post-hoc Anova analysis).

### Example 1

Microfluidic Device Design

A cell-culture microfluidic device was designed containing an array of 16 by 32 cell-culture chambers. These chambers contain a side compartment that is separated by a micromechanical valve and can be used for storing drugs. Drugs can be pre-stored on the device using conventional microarray spotter (Einav, S. et al. Nat. Biotechnol. (2008). doi:10.1038/nbt.1490;Ronen, M, et al. Lab Chip (2014) doi:10.1039/c41c00150h). The main chamber volume is approximately 5 nanoliter. This chamber has a seeding channel that is 100 μm wide and on the opposite side, a filter made of 8 channels, each 5-micrometer wide and 3 micrometer high. The filter serves for both preventing cells from flowing out of the culture chamber and for cells feeding. The design and digital image of the C SRA device is presented in FIG. 1A-1B The device is placed in a microenvironment chamber (FIG. 1A) inside the microscope incubator. The goal of this chamber is to keep the cells in constant, adequate environmental conditions, needed for long-term cell survival. These conditions include constant temperature of 37° C., 5% CO2 levels and proper humidity, all controlled throughout the entire experimental period. The custom-made chamber was adapted for microscope imaging, as the dimensions of the chamber fit the slot on the microscope stage, and allow automatic imaging. The setup (FIG. 1A) allows real time analysis of cell responses to drugs and can potentially enable kinetic studies of cell responses. The stage was programed to move automatically, based on 2D coordinates, and images are taken automatically from each well.

### Example 2

Cell Seeding

Cell concentration was optimized to achieve a narrow cell distribution between cultivation chambers. In addition, flow velocity was optimized within the tubes that direct the cells from the main channels into the cultivation chambers, to control the concentration of cells within each chamber. To optimize cell seeding within the device, the starting concentrations of cells was optimized. Three initial concentrations were tested; 8·10⁶ cells mL⁻¹, 10⁷ cells mL⁻¹ and 15·10⁶ cells mL⁻¹. At 8·10⁶ cells mL⁻¹ and 10⁷ cells mL⁻¹ multiple empty chambers remained and the average number of cells per chamber was less than 10. The average number of cells per chamber at the third cell concentration was 39±19 (n=512) and the distribution of cells per well at 15·10⁶ cells mM⁻¹ is presented in FIG. 1C, with descriptive statistics in Table 1. The median number of cells in the chamber was 37 and the mean was 39.8. The minimum number of cells in the chamber was 2 and the maximum cells number was 105. Accordingly, 15·10⁶ cells mL⁻¹ were chosen as the initial cells concentration from this point forward.

TABLE 1
Descriptive statistics for MCF-7 cells distribution
within the cultivation chambers. A 50 ul
sample (15 · 10⁶ cells mL⁻¹) was loaded into
the device. All 512 chambers were analyzed.

| | 1st | | | 3rd | |
|---|---|---|---|---|---|
| Minimum | Quarter | Median | Mean | Quarter | Maximum |
| 2 | 26 | 37 | 39.84 | 52 | 105 |

Determination of Live/Dead Cell Ratio Inside the Microfluidic Device.

To assess cells vitality in the microfluidic device, a live/dead cell assay was applied. Cells were cultured inside the microfluidic device for at least 24 hours to allow cell accommodation. Then, the cells were stained inside the device using a mixture of Calcein-AM to stain for the living cells, Propidiurn Iodide (PT) to stain for the dead cells, and Hoechst 33342 to stain the nucleus of all cells (FIG. 2A). Previous studies on cell culture in microfluidic devices have shown the efficacy of these stains for rapid quantification of live/dead ratio (Kramer, C. E. M., et al. Sci. Rep. 6, (2016); Moussavi-Harami, S. F. et al. Integr. Biol. 8, 243-252 (2016). Images were captured in 3 different wavelengths from multiple culture chambers and calculated the frequency diagrams for total cells immediately after seeding (FIG. 2B-2C). The distribution of cells 24 hours post seeding was evaluated following live/dead staining assay (FIG. 3A-3B) showing that most chambers contained a range of 5-20 living cells, and a small percentage of chambers were highly occupied with cells (80-100 living cells). While only a small percentage of chambers contained a large number of dead cells (<5%) which was at the most ˜40 cells.

### Example 3

Cell Culturing and Feeding Protocol

The initial goal was to achieve at least 48 hours survival under controlled environmental conditions. MCF-7 cells and 293T cells were used as cell models. To achieve this goal, the process of medium flowing was optimized into the incubation chambers, after cell adhesion, to allow cell nutrition and waste clearance, by diffusion, through the filters in each cell chamber, without damaging the cells. For long-terms experiments, it was important not to move the device relative to the stage since such movements disabled automatic imaging protocol. Therefore, a 10 mL syringe was used and a long plastic tube filled with medium to teed the cells for long periods, and connected them to the device via an additional Tygon tube located distal to the device. In FIG. 4, cell survival was demonstrated inside the device for up to 96 hours post accommodation period. As presented, MCF7 cell survival rate increased within the first 24 hours due to proliferation. Then the survival rate decreased reaching a steady level that was maintained for up to 72 hrs. The 293T cells presented a steady level of survival throughout a period of 48 hours following with a significant decrease in survival at 72 hours (p<0.001). These results show a different cell dynamics in response to cultivation within the microfluidic device. Not only the duration of cells survival inside the chip was different, but also the kinetic of their survival. This issue must be considered when cell response to drugs is tested, since clearly cell type can impact the results.

### Example 4

Cell Mortality Dynamics Following Exposure to Docetaxel

After characterizing the live/dead dynamics of non-treated cells, it was decided to investigate the dynamics of cells following exposure to drugs. The effect of Docetaxel was determined on MCF7 and 293T cells. The cells were cultivated for 48 hours under continuous flow of medium (feeding by diffusion through filters). Forty-eight hours after cell seeding, the cells were incubated (no flow), with 10 nM/100 nM Docetaxel for 2 hours. A live/dead assay was conducted at T₀ (before drug exposure) and at 5, 24 and 48 hours post drug exposure (FIG. 5). For MCF7 cells (n=47) mortality rate significantly increased (p<0.05) within 5 hours post drug exposure with no further increase in mortality rate up to 48 hours. Control cells with no treatment displayed no differences in the mortality rate throughout the experiment. The 293T cells, also displayed an increase in mortality rate after 5 hrs (p<0.05) with no further deterioration during the rest of the experiment. A dramatic increase was observed in variability in the treated cells, for both cell types, compared to the corresponding control cells. It is believed that this variable response can be explained by the ability of some cells in the population to form clusters versus the absence of this trait. A second example of cell response to Docetaxel is presented in FIG. 6.

### Example 5

Clusters are Induced in the Microfluidic Device But Not in Culture Plates

It was observed that both MCF-7 and 293T cells form clusters inside the device under continuous media flow within 2-3 hrs. Cell death within these cluster is rare, compared with individual cells, and typically is Observed in the periphery of the cluster. Cells within the clusters seem to merge and may become multinuclear. This phenomena was observed in other cells as well, including Glioblastoma and lung cells. To clarify this issue, 293T that express GFP on their plasma membranes were followed for 24 hrs. These cells formed clusters and the GFP marked the cell membranes. Intact membranes were observed, albeit binding between cells was very tight within the clusters.

These clusters are important, as they better simulate cancer tumor behavior. The ability to achieve clusters inside the microfluidic device, using the seeding and feeding protocol, is a significant advantage (FIG. 7) Cluster morphology is not normally achieved in standard cell cultures, as previously observed.

### Example 6

Clusters Are More Resistant to Docetaxel Than Individual Cells

The results clearly showed that cell clusters are more resistant to drugs than dispersed cells. Clusters response were tested to 1 μM Docetaxel for 2 hours, following with a second, higher dose (10 μM) of Docetaxel, which was given 24 hours later, based on previously a published protocol (Wei, L. et al. Eur. Urol. 71, 183-192 (2017)). While analyzing the results, a different response was observed between clusters and dispersed cells. As presented in FIG. 8, the mortality rate of the dispersed cells population, 24 hours post the second drug exposure session, was 65±6% (Mean±S.E). Cluster mortality rate was about half that of dispersed cells (33±5%, p=13×10⁻⁵) (FIG. 8 and FIG. 9). These results were further supported by the experiment presented in FIG. 10, where a single dose of Docetaxel 10 μM was applied. As presented, after exposure to the drug, death was observed only in dispersed cells, whereas, cells within the clusters remained. intact. In other words, it seems that the morphology of cells and their grouping, affected their resistance to drugs (FIG. 10). No difference was seen in drug response between large and small clusters. In some cases, it was observed that nearly all cells within a cluster survived while, the entire population of dispersed cells died FIG. 9.

### Example 7

MCF-7 Cell Response to a Drug Array

To demonstrate the advantage of this microfluidic platform, an experiment was designed that tested the sensitivity of MCF-7 cells to 4 different drugs at 5 different doses, each repeated in 10 separate chambers. The drugs, Doxorubicin (Doxorubicin hydrochloride, Tocirs, USA), Docetaxel, Paclitaxel Methotrexate (drugs were supplied with the courtesy of Dr. Levanon, The institute of Oncology, Chaim Sheba Medical Center, Israel), were spotted on a microscope slide at 5 different concentrations (0, 0.1, 0.5, 0.7 and 1 mM) and then covered with the microfluidic device, encompassing the thy drugs inside the drug chamber. Cells were seeded on the device and cultured for 2 hours. Then the valve blocking the drug chamber was opened and the drugs were flooded and allowed to diffuse out and incubated with the cells for 2 hours. Cell response to the different drugs and doses is presented in FIG. 11. A different response was observed dynamics to the different drugs, expressed by different mortality rates. Nevertheless, in all cases, mortality rate increased starting from the lower dose of drug (0.1 mM) (p<0.05). A dose dependence sensitivity was observed for all 4 drugs. These initial results demonstrate the possible applicability of this platform to high throughput screening.

To demonstrate treatment specificity, the sensitivity of two cell lines, MCF-7 and MCF-7/dx (Doxorubicin resistant cells) was tested to 3 concentrations of Doxorubicin (0,1,1 and 10 μM). Preliminary results showed that in normal MCF-7 cells doxorubicin was mainly located in the nuclei while in MCF-7/dx it was located throughout the cytoplasm with the nuclei being almost completely negative for doxorubicin fluorescent signal (FIG. 12). These co-localization of doxorubicin and Hoechst 33342 fluorescence (bright purple fluorescence) indicates for the development of apoptotic/necrotic processes. After 24 hours of 10 μM doxorubicin treatment, about 98% of drug sensitive cells (MCF7) showed morphological features of apoptotic/necrotic processes, while these processes were almost absent in drug resistant MCF7/Dx cells.

### Example 8

CSRA Clinical Development—Patient Pleural Effusion Response to Drugs Correlates with Patient History.

The drug response of pleural effusion samples taken from 8 Non-small cell lung carcinoma patients was tested in a preliminary experiment. All these patients were analyzed for genomic mutations and had similar mutations suggesting treatment with ALK inhibitors. The genomic analysis could not predict however development of resistance. For each of the samples, the cells were first uploaded into the chip for a 24-hour acclimation period after which the cells were exposed different drugs.

The 24 hours response to two biological drugs, Alectinib and Crizotinib (15 μM) is shown herein. Cell viability was measured using Propidium iodide, which dyes the nuclei of dead cells (magenta). It was known that the biopsies originated from patients that were treated with Alectinib and Crizotinib, however their response to each treatment was not known nor the order in which the drugs were administered, in order to avoid any sort of confirmation bias when collecting and analyzing the data. The moment when the pleural effusions were collected during the treatments was neither known.

Alectinib is a biological cancer drug that was first approved in Japan in 2014 and granted accelerated approval by the FDA in 2015. In 2017, it was approved as a first-line drug for the treatment of non-small cell lung cancer. Alectinib works by inhibiting the anaplastic lymphoma kinase (ALK) gene also known as the ALK tyrosine kinase receptor. The ALK gene in many cancer cells undergoes a fusion with other genes that does not occur in healthy people and this fusion mutation induces abnormal behavior in the affected cells which in turn develops into uncontrolled cancerous growth.

Crizotinib, like Alectinib is an ALK inhibitor and works by operating as a competitive inhibitor to the ATP binding site of the tyrosine kinase enzyme that the ALK gene codes for and in doing so prevents its carcinogenic activity. It was granted initial approval by the FDA in 2011 and has been widely used in lung cancer treatment since then. At the end of the 24-hour exposure period, the data from the experiments was analyzed and calculated to determine the survival and or mortality rate of the cells.

It was found that all the patients were resistant to Alectinib. This correlates to the patients history as all these patients were first treated with Alectinib and developed resistance. At this juncture the patients' treatment was replaced with Crizotinib and the response was different between patients. The functional assay also showed different responses to Crizotinib varying from resistance to medium or high response. The results correlated completely with the patient response. FIG. 13 shows representative results from three patients demonstrating Alectinib resistance and a range of Crizotinib responses.

This successful preliminary experiment suggests that the use of the microfluidic CSRA device may provide important data for predicting development of drug resistance in patients. Together with nucleotide sequencing and proteomic profiling this project enables to collect a unique data set.

1. A microfluidic test platform, comprising:
a block defining a first plurality of reaction units, a first network of feeding channels, a second network of seeding channels, and a control system for enabling control of fluid flows with respect to the first network of feeding channels and with respect to the second network of seeding channels;
each said reaction unit being in selective fluid communication with the first network of seeding channels and in selective fluid communication with the second network of feeding channels;
each said reaction unit configured, during operation of the platform, for enabling a cell sample to be interacted with a respective active agent;
wherein the reaction units are provided with desired said active agents in situ during manufacture of the microfluidic test platform.

2. The microfluidic test platform according to claim 1, comprising a plurality of microfluidic valves, each microfluidic valve being configured for selectively allowing or preventing flow therethrough under the control of the control system.

3. The microfluidic test platform according to claim 1, including at least one of the following;
wherein at least one said reaction unit comprises a different said active agent as compared with at least one other said reaction unit;
wherein at least one said reaction unit comprises a different composition of said active agent as compared with at least one other said reaction unit;
wherein at least one said reaction unit comprises a different concentration of said active agent as compared with at least one other said reaction unit.

4. The microfluidic test platform according to claim 1, including at least one of the following:
wherein said active agent is any one of: a candidate active agent; a therapeutic active agent; a labeling active agent; a characterizing active agent;
wherein said active agent comprises any one of: an inorganic or organic molecule, a small molecule, a nucleic acid-based molecule, an aptamer, a polypeptide, or any combinations thereof.

5. The microfluidic test platform according to claim 1, including one of the following:
wherein said block comprises a block member in overlying fixed relationship with a base member, and wherein said block member comprises an outer-facing first block surface and an outer-facing second block surface, wherein the second block surface is spaced from the first block surface by a block member thickness dimension;
wherein said block comprises a block member in overlying fixed relationship with a base member, and wherein said block member comprises an outer-facing first block surface and an outer-facing second block surface, wherein the second block surface is spaced from the first block surface by a block member thickness dimension, and, wherein said block member comprises a material transparent to electromagnetic radiation at least in the visible spectrum;
wherein said block comprises a block member in overlying fixed relationship with a base member, and wherein said block member comprises an outer-facing first block surface and an outer-facing second block surface, wherein the second block surface is spaced from the first block surface by a block member thickness dimension, and, wherein said block member comprises a material transparent to electromagnetic radiation at least in the visible spectrum, and, wherein said material is or comprises polydimethylsiloxane;
wherein said block comprises a block member in overlying fixed relationship with a base member, and wherein said block member comprises an outer-facing first block surface and an outer-facing second block surface, wherein the second block surface is spaced from the first block surface by a block member thickness dimension, and, wherein said block member comprises a first block layer in overlying abutting relationship with a second block layer, wherein the second block layer comprises said control system, and said first block layer comprises said first plurality of reaction units, said first network and said second network.

6. The microfluidic test platform according to claim 1, including at least one of the following:
wherein said plurality of said reaction units are arranged in an array with respect to the block of substrate material;
wherein said first plurality is an integer greater than 100.

7. The microfluidic test platform according to claim 2, wherein said first network is configured for selectively delivering to at least a portion of the reaction units, under the action of the second network, a fluid including at least cell samples.

8. The microfluidic test platform according to claim 7, wherein second network is configured for selectively enabling pockets of said fluids trapped in feeding channel segments of the first network to be urged into the respective reaction units under predefined conditions.

9. The microfluidic test platform according to claim 8, wherein the first network comprises a plurality of feeding channels, each feeding channel being in selective fluid communication with a portion of said reaction chambers via respective said microfluidic, valves in the form of respective first microfluidic valves, wherein each said feeding channel further comprises a plurality of said microfluidic valves in the form of blocking valves, wherein each pair of adjacent blocking valves is configured for selectively isolating a respective said feeding channel segment therebetween from a remainder of the first network.

10. The microfluidic test platform according to claim 8, wherein each said reaction unit comprises a cell chamber configured for accommodating therein a cell sample, and at least one active agent chamber, wherein the respective said active agent of the respective reaction unit is accommodated in the respective said at least one active agent chamber during manufacture of the microfluidic test platform.

11. The microfluidic test platform according to claim 10, wherein each said reaction unit comprises:
a first said microfluidic valve configured for providing selective fluid communication between the respective said reaction unit and the first network;
a second said microfluidic valve configured for providing selective fluid communication between the respective said reaction chamber and the respective said active agent chamber.

12. The microfluidic test platform according to claim 10, wherein each said reaction chamber comprises a plurality of seeding ports configured for providing free fluid communication between the respective reaction chamber and a respective group of feeding channels of the second network, wherein said seeding ports are configured for preventing flow therethrough of cells of a cell sample.

13. The microfluidic test platform according to claim 2, wherein said control system comprises a plurality of microfluidic control lines, each said microfluidic control line configured for controlling operation of one or more said microfluidic valves associated with the respective said microfluidic control line.

14. A system, comprising:
a housing configured for accommodating therein a fluidic test platform as defined in claim 1;
an imaging system;
an environment control system;
a pressurization system; and
a supply system.

15. The system according to claim 14, wherein at least one of:
(a) said system including at least one of the following:
wherein said housing defines an internal microenvironment chamber configured for accommodating the platform therein;
wherein said imaging system comprises a suitable imaging camera, configured for enabling imaging of individual reaction units of the platform, at least during the active agent exposure operation in operation of the system;
wherein said environmental control system comprises a humidity control, a temperature control, and a carbon dioxide control, respectively configured for providing control of humidity, temperature and level of carbon dioxide, in the microenvironment chamber;
wherein said pressurization system is configured for selectively operating the control system of the platform in operation of the system;
wherein said supply system comprises a plurality of input lines, each said input line being coupled to the first network of the platform in operation of the system; and
(b) said system further comprising said platform accommodated in said housing.

16. A method for manufacturing a microfluidic test platform, comprising;
(a) providing a block member having a first block face and defining a plurality of reaction units, a first network of feeding channels, a second network of seeding channels, and a control system for enabling control of fluid flows with respect to the first network of feeding channels and with respect to the second network of seeding channels, wherein at least the reaction units are formed as recesses from the first block face;
(b) providing a base member having a first base face configured for being affixed in overlying relationship with respect to the first block face;
(c) depositing a plurality of desired active agents, corresponding to said plurality of reaction units, in at least one of block member or said base member in predefined alignment therewith such as to ensure that in step (d) each said active agent is accommodated in a respective said reaction chamber;
(d) following step (c), affixing said base member with respect to said block member such that first base face is affixed in overlying relationship with respect to the first block face.

17. The method according to claim 16, including one of the following:
wherein in step (c), the plurality of desired active agents, are deposited on said base member in said predefined alignment therewith;
wherein in step (c), the plurality of desired active agents, are deposited on said base member in said predefined alignment therewith, and, wherein said active agents are printed as respective deposits on said first base face of the base member in the form of an array corresponding to an array of said reaction units in said block member;
wherein in step (c), the plurality of desired active agents, are deposited on said base member in said predefined alignment therewith, and, wherein said active agents are printed as respective deposits on said first base face of the base member in the form of an array corresponding to an array of said reaction units in said block member, and, wherein each said deposit has a respective size and location on the first base face corresponding to a size and relative location of a respective active agent chambers of a respective said reaction unit on the block member.

18. The method according to claim 16, including one of the following:
wherein step (d) comprises first aligning the base member and the block member with respect to one another, such that each said reaction unit, in particular each active agent chamber thereof, accommodates a respective said active agent, and subsequently affixing the aligned said base member and said block member with respect to one another;
wherein step (d) comprises first aligning the base member and the block member with respect to one another, such that each said reaction unit, in particular each active agent chamber thereof, accommodates a respective said active agent, and subsequently affixing the aligned said base member and said block member with respect to one another, and, further comprising providing a layer of chemically active moieties to the first base face prior to step (c);
wherein in step (d) the base member and the block member affixed with respect to one another using a plasma bonding process;
wherein step (c) includes any one of a suitable piezo printing process and a suitable contact printing process for depositing said active agents;
wherein in step (c) said active agents are deposited directly to the respective reaction units.

19. The method according to claim 16, wherein in step (a) said block member is provided by first providing a first block layer and a second block layer, said first block layer comprising said plurality of reaction units, said first network of feeding channels, and said second network of seeding channels, said second block layer comprising said control system, aligning said first block layer and said second block with respect to one another, and affixing said aligned first block layer and said second block layer with respect to one another.

20. A method for operating a microfluidic test platform, comprising:
(A) providing a system as defined in claim 14;
(B) providing a microfluidic test platform as defined in claim 1, comprising a desired variety of said active agents in the respective said reaction units thereof;
(C) accommodating the microfluidic test platform in the housing of the system;
(D) operating the system to cause a cell sample to interact with each of said active agents in the respective said reaction units.

21. A screening method for an active agent that affects cell viability and/or at least one cell phenotype the method comprising the steps of:
(a) exposing cells grown in at least one cell chamber of at least one reaction unit of a microfluidic test platform according to claim I., to at least one candidate active agent accommodated in at least one respective active-agent chamber of said test platform;
(b) determining for the exposed cells of (a), cell viability and/or at least one cell phenotype, for at least one time interval; and
(c) determining that said candidate is an agent that affects cell viability and/or phenotype if at least one of, cell viability and/or at least one cell phenotype is modulated as compared with the cell viability and/or at least one cell phenotype in the absence of said candidate active agent, optionally, wherein said candidate active agent is placed prior to exposure to said cells, in a predetermined amount, within said respective active-agent chamber.

22. The screening method according to claim 21, wherein at least one of:
(a) said candidate active agent is at least one of: an inorganic or organic molecule, a small molecule, a nucleic acid-based molecule, an aptamer, a polypeptide, or any combinations thereof;
(b) said cells form aggregates and/or clusters in said cell chamber, prior to exposure to said candidate agent;
(c) said cells are cells of a subject suffering from a pathologic disorder;
(d) said pathologic disorder is any one of a malignant proliferative disorder, an inflammatory condition a metabolic condition, an infectious disease, an autoimmune disease, protein misfolding disorder or deposition disorder; (e) said pathologic disorder is a malignant proliferative disorder, and wherein said cells are primary cancer cells of said subject;
(f) said malignant proliferative disorder is any one of carcinoma, melanoma, lymphoma, leukemia, myeloma and sarcoma;
(g) wherein cell viability is determined by using at least one cell-impermeant DNA-binding dyes and nuclear staining;
(h) said candidate active agent is at least one of a chemotherapeutic agent, a biological therapy agent, an immuno therapeutic agent, an hormonal therapy gent or any combination thereof; and
(i) said candidate active agent is at least one of Alectinib, Crizotinib, doxorubicin, docetaxel, paclitaxel, methotrexate, and any combinations thereof.

23. The screening method according to claim 21, for screening for an anti-cancerous drug, the method comprising the steps of:
(a) exposing cancer cells grown in at least one cell chamber of at least one reaction unit of said a microfluidic test platform, to at least one candidate active compound accommodated in at least one respective drug chamber of at least one reaction unit of said test platform;
(b) determining for the exposed cells of (a), cell viability, for at least one time interval; and
(c) determining that said candidate drug is an ani-cancerous drug if cell viability is reduced as compared with the cell viability in the absence of said candidate active agent.

24. A prognostic method for predicting/determining and assessing responsiveness of a subject suffering from a pathologic disorder to a treatment regimen comprising at least one therapeutic active agent, and optionally for monitoring disease progression, the method comprising the steps of:
(a) exposing cells of said subject grown in at least one cell chamber of at least one reaction unit of a microfluidic test platform according to claim I. to said therapeutic active agent accommodated in at least one respective active-agent chamber of at least one reaction unit of said test platform;
(b) determining for the exposed cells of (a), cell viability and/or at least one cell phenotype, for at least one time interval; and
(c) classifying said subject as:
(i) a responsive subject to said treatment regimen, if at least one of, cell viability and/or at least one cell phenotype is modulated as compared with at least one of the cell viability and/or at least one cell phenotype in the absence of said therapeutic active agent; or
(ii) a drug-resistant subject if at least one of, cell viability and/or at least one cell phenotype is not modulated as compared with at least one of the cell viability and/or at least one cell phenotype, in the absence of said active agent;
thereby predicting, assessing and monitoring responsiveness of a mammalian subject to said treatment regimen, optionally, wherein said monitoring disease progression further comprises the steps of:
(d) repeating steps (a) and (b), to determine at least one of, cell viability and/or at least one cell phenotype for at least one cell of at least one more temporally-separated. sample of said subject; and
(e) predicting and/or determining drug-resistance and/or reduction in drug effectiveness in said subject, if at least one cell of said at least one temporally separated sample, displays loss of the modulatory effect of said therapeutic active compound on at least one of, cell viability and/or at least one cell phenotype.

25. The method according to claim 14, for predicting/determining and assessing responsiveness of a subject suffering from a malignant proliferative disorder to a treatment regimen comprising at least one anti-cancerous drug, and optionally for monitoring disease progression, the method comprising the steps of:
(a) exposing cancer cells of said subject grown in at least one cell chamber of at least one reaction unit of said microfluidic test platform, to said anti-cancerous drug accommodated in at least one respective active-agent chamber of at least one reaction unit of said test platform;
(b) determining for the exposed cells of (a), cell viability for at least one time interval; and
(c) classifying said subject as:
(i) a responsive subject to said treatment regimen, if cell viability is reduced as compared with the cell viability in the absence of said anti-cancerous drug; or
(ii) a drug-resistant subject if cell viability is not reduced as compared with the cell viability in the absence of said anti-cancerous drug;
thereby predicting, assessing and monitoring responsiveness of a mammalian subject, to said treatment regimen.

26. A method for determining a personalized treatment regimen for a subject suffering from a pathologic disorder, the method comprising the steps of:
(a) exposing cells of said subject grown in at least one cell chamber of at least one reaction unit of a microfluidic test platform according to claim 1, to at least one therapeutic active agent accommodated in at least one respective active-agent chamber of at least one reaction unit of said test platform;
(b) determining for the exposed cells of (a), cell viability and/or at least one cell phenotype, for at least one time interval;
(c) classifying said subject as:
(i) a responsive subject to said treatment regimen, if at least one of, cell viability and/or at least one cell phenotype is modulated as compared with at least one of the cell viability and/or at least one cell phenotype in the absence of said candidate active agent; or
(ii) a drug-resistant subject if at least one of, cell viability and/or at least one cell phenotype is not modulated as compared with at least one of the cell viability and/or at least one cell phenotype in the absence of said therapeutic active agent; and
(d)administering to a subject classified as a responder, an effective amount of said therapeutic active agent, or any compositions thereof, optionally, wherein said subject is and/or was subjected to a treatment regimen comprising said therapeutic active agent, and is monitored for disease progression, the method comprising the steps of:
(a) exposing cells of said subject grown in at least one cell chamber of a microfluidic test platform, to at least one therapeutic active agent accommodated in at least one respective active-agent chamber in said test platform, wherein said cell sample is obtained after the initiation of said treatment regimen;
(b) determining for the exposed cells of (a), cell viability and/or at least one cell phenotype, for at least one time interval;
(c) determining at least one of:
(i) loss of responsiveness, and/or drug-resistance of said subject, if at least one of, cell viability and/or at least one cell phenotype is not modulated as compared with the cell viability and/or at least one cell phenotype in the absence of said candidate active agent; or
(ii) responsiveness or maintained responsiveness of said subject, if at least one of, cell viability and/or at least one cell phenotype is modulated as compared with the cell viability and/or at least one cell phenotype in the absence of said candidate active agent; and
(c) ceasing a treatment regimen comprising said therapeutic active agent of a subject displaying disease relapse and/or loss of responsiveness, and/or drug-resistance; or maintaining said treatment regimen of a subject displaying responsiveness or maintained responsiveness.

27. A method for treating, preventing, inhibiting, reducing, eliminating, protecting or delaying the onset of at least one pathologic disorder in a subject in need thereof, the method comprising the steps of:
(a) exposing cells of said subject grown in at least one cell chamber of at least one reaction unit of a microfluidic test platform according to claim 1, to at least one therapeutic active agent accommodated in at least one respective active-agent chamber of at least one reaction unit of said test platform;
(b) determining for the exposed cells of (a), cell viability and/or at least one cell phenotype, for at least one time interval;
(c) classifying said subject as:
(i) a responsive subject to said treatment regimen, if at least one of, cell viability and/or at least one cell phenotype is modulated as compared with at least one of the cell viability and/or at least one cell phenotype in the absence of said therapeutic active agent; or
(ii) a drug-resistant subject if at least one of, cell viability and/or at least one cell phenotype is not modulated as compared with at least one of the cell viability and/or at least one cell phenotype in the absence of said therapeutic active agent; and
(d) selecting a treatment regimen based on said responsiveness, thereby treating said subject with the selected treatment regimen, optionally, wherein step (d) comprises at least one of:
(i) administering to a subject classified as a responder, an effective amount of said therapeutic active agent, or any compositions thereof;
(ii) maintaining said treatment regimen, of a subject displaying responsiveness or maintained responsiveness; or
(iii) ceasing said treatment regimen of a subject displaying loss of responsiveness.

28. The method according to claim 26, for treating, preventing, inhibiting, reducing, eliminating, protecting or delaying the onset of at least one malignant proliferative disorder in a subject in need thereof, the method comprising the steps of:
(a) exposing cancer cells of said subject grown in at least one cell chamber of at least one reaction unit of said microfluidic test platform, to at least one therapeutic active agent accommodated in at least one respective active-agent chamber of at least one reaction unit of said test platform;
(b) determining for the exposed cells of (a), cell viability for at least one time interval;
(c) classifying said subject as:
(i) a responsive subject to said treatment regimen, if cell viability is reduced as compared with the cell viability in the absence of said therapeutic active agent; or
(ii) a drug-resistant subject if cell viability is not reduced as compared with the cell viability in the absence of said therapeutic active agent; and
(d)selecting a treatment regimen based on said responsiveness, thereby treating said subject with the selected treatment regimen.
